(19) United States
(12) Patent Application Publication
(10) Pub. No.: US 2006/0017659 A1
(43) Pub. Date: Jan. 26, 2006

(54) Electronic paper display system

(75) Inventors: Toshiyuki Ogawa, Kasuya-gun (JP); Takashi Kitada, Ogoori-shi (JP); Hiroaki Sakai, Fukuoka-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/186,019

(22) Filed: Jul. 21, 2005

Related U.S. Application Data
(63) Continuation-in-part of application No. 11/116,263, filed on Apr. 28, 2005.

(30) Foreign Application Priority Data
Apr. 28, 2004 (JP) P2004-133129
Jul. 23, 2004 (JP) P2004-215260
Jul. 23, 2004 (JP) P2004-215261
Aug. 20, 2004 (JP) P2004-240483

(51) Int. Cl. G09G 3/00

(52) U.S. Cl. 345/30

(57) ABSTRACT

It is an object to provide an electronic paper display system capable of communicating in non-contact with an electronic paper by transfer apparatus and managing information by use of an electronic paper high in illegibility and portability as a medium of information display.

An electronic paper display system that communication is made with display apparatus 2 having an electronic paper and wireless tag from transfer apparatus 1 capable of accessing a PC or a network, to perform a personal identification, based on which display information is transferred. Meanwhile, by transfer apparatuses 1 arranged in plurality in a space, the electronic paper is detected to manage information.

### BACKGROUND OF THE INVENTION

1. Field of the Invention

The present invention relates to an electronic paper display system for generating and managing information by utilization of an electronic paper high in illegibility/portability and easy to manage information.

2. Description of the Related Art

Conventionally, there are those of a form for personal use that, when to look electronic information by the paper output high in illegibility and portability, the information is instructed for printing from a personal computer (hereinafter, abbreviated as PC) to a PC or to a printer connected to a network to thereby form an image on a paper or an electronic paper as a display device by means of the printer (see JP-A-2003-333001, for example).

Meanwhile, where to personally use the information existing in an image form on a paper, there are those of a form for copying by the copier or changing a scanner readout into electronic information so that it can be paper-outputted from a printer. Meanwhile, the data-display-functioning wireless tags include those representing the basic structure of an integral-form wireless tag having a display function for the purpose of use in a physical distribution management system (see JP-A-2002-236891, for example).

Meanwhile, there are those of a form utilizing information by connecting a portable notebook personal computer to a network system through a wireless LAN.

However, in the above example that is to output information on a paper from the conventional printer, it is thought that a 25% portion of the output results in garbage on the same day thus having a problem of resource listing.

Meanwhile, the security management, of a paper, electronic paper or an information medium used on a notebook personal computer, is relied upon the user of information handling the paper or personal computer. Thus, there is a problem that information is to be managed insufficient.

### SUMMARY OF THE INVENTION

The present invention is to solve the foregoing problem, and it is an object thereof to provide an electronic paper display system capable of managing information using an electronic paper as an information display medium.

An electronic paper display system in the present invention uses an electronic paper capable of holding a display state in a power-free state and displaying an image by application of magnetism or electric field. Furthermore, it has a display apparatus mounted with a wireless tag function, communication means for receiving an electromagnetic wave from a transfer apparatus, and means for producing an image based on received information and recording an image to the electronic paper, incorporating a control circuit for controlling the operation, and a transfer apparatus having an antenna and control circuit for wirelessly transmitting information with the display apparatus and incorporating an interface circuit for connection to a personal computer. Thus, information transmission is made possible in non-contact with the display apparatus.

In the electronic paper display system of the invention, the transfer apparatus communicates in non-contact with the display apparatus, to detect an electronic paper and a display apparatus. By recognizing display-side personal identification information according to an information program, various data processes and event operations are carried out based on the personal identification information according to a previously set/registered information and process procedure. By sending image information and operation instructions to an arbitrary transfer apparatus, control/management is possible for display on a desired display apparatus and electronic paper. Furthermore, by arranging transfer apparatuses in plurality in a space, the electronic paper and display apparatus can be detected to enable information management.

### BRIEF DESCRIPTION OF THE DRAWINGS

FIG. 1 is an arrangement diagram of an electronic paper display system in embodiment 1 of the present invention.

FIG. 2 is an arrangement diagram of an electronic paper display system in embodiment 2 of the invention.

FIG. 3 is an interior block diagram of a transfer apparatus in embodiment 1 of the invention.

FIG. 4 is an interior block diagram of a display apparatus in embodiment 1 of the invention.

FIG. 5 (a) is a sectional view of an electronic paper in embodiment 1 of the invention, and FIG. 5(b) is a plan view of the electronic paper in embodiment 1 of the invention.

FIG. 6 is a sectional view showing an image write operation to the electronic paper in embodiment 1 of the invention.

FIG. 7 (a) is a transition diagram of an information program in embodiment 1 of the invention, and FIG. 7(b) a flowchart showing an operation outline in embodiment 1 of the invention.

FIG. 8 is an interior block diagram of a transfer apparatus in embodiment 2 of the invention.

FIG. 9 is an interior block diagram of a display apparatus in embodiment 2 of the invention.

FIG. 10 (a) is a sectional view of an electronic paper in embodiment 3 of the invention, and FIG. 10(b) is a structural view of a recording surface in embodiment 3 of the invention.

FIG. 11 is an interior diagram of a display apparatus of an electronic paper display system in embodiment 4 of the invention.

FIG. 12 (a) is a sectional view of an electronic paper in embodiment 4 of the invention, and FIG. 12(b) is a structural view of a recording section in embodiment 4 of the invention, and FIG. 12(c) a schematic view of a pixel drive circuit in embodiment 4 of the invention.

FIG. 13(a) is a structural view of an electronic paper in embodiment 9 of the invention, and FIG. 13(b) is a sectional view of the electronic paper in embodiment 9 of the invention.

FIG. 14 is a figure of an information management table in embodiment 2 of the invention.

FIG. 15 is a figure of an information management table in embodiment 2 of the invention.

FIG. 16 is a figure of a display-apparatus management table in embodiment 10 of the invention.

FIG. 17 (a) is a structural view of a recording head in embodiment 1 of the invention, and FIG. 17(b) is a sectional view of the recording head in embodiment 1 of the invention.

FIG. 18 is an outline view of an antenna in embodiment 13 of the invention.

FIG. 19 is a block diagram which shows a basic configuration of an electronic paper system in an embodiment 15 of the invention.

FIG. 20 is a block diagram which shows a configuration of a transfer apparatus shown in FIG. 19.

FIG. 21 is a block diagram which shows a configuration of a display apparatus shown in FIG. 19.

FIG. 22 is a view which explains an electronic paper shown in FIG. 19.

FIG. 23 is a view which explains the electronic paper shown in FIG. 19.

FIG. 24 is a view which explains the electronic paper shown in FIG. 19.

FIG. 25 is a view which shows transition of statuses due to execution of an information program.

FIG. 26 is a flow chart which shows an processing operation of the electronic paper system shown in FIG. 19.

FIG. 27 is a view which shows one example of a format of information which is transmitted from a personal computer shown in FIG. 19.

FIG. 28 is a view which explains image data.

FIG. 29 is a flow chart which shows an image deterioration processing operation.

FIG. 30 is a conceptual diagram which shows a configuration of an electronic paper system of an embodiment 16 of the invention.

FIG. 31 is a block diagram which shows a configuration of a transfer apparatus shown in FIG. 30.

FIG. 32 is a block diagram which shows a configuration of a display apparatus in an electronic paper system in an embodiment 17 of the invention.

FIG. 33 is a view which explains a recording surface of the display apparatus shown in FIG. 32.

FIG. 34 is a view which explains a writing operation to an electronic paper which is used for the display apparatus shown in FIG. 32.

FIG. 35 is a view which explains the electronic paper.

FIG. 36 is a view which explains the electronic paper.

FIG. 37 is a block diagram which shows a configuration of a display apparatus of an electronic paper system in an embodiment 18 of the invention.

FIG. 38 is a view which explains an electronic paper.

FIG. 39 is a view which explains the electronic paper.

FIG. 40 is a view which explains writing to the electronic paper.

FIG. 41 is a block diagram which shows a configuration of a display apparatus 1002 of an electronic paper system in an embodiment 25 of the invention

FIG. 42 is a block diagram of an electronic paper system in an embodiment 28 of the invention.

FIG. 43 is an internal block diagram of a transfer apparatus in the embodiment 28 of the invention.

FIG. 44 is an internal block diagram of a display apparatus in the embodiment 28 of the invention.

FIG. 45 is (a) a cross sectional view of an electronic paper in the embodiment 28 of the invention, and (b) is a view which shows a cross section region of the electronic paper in the embodiment 28 of the invention, and (c) is a view which shows a pixel drive circuit of the electronic paper in the embodiment 28 of the invention.

FIG. 46 (a) is a transition diagram of an information program in the embodiment 28 of the invention, and (b) is a flow chart which shows an operation outline in the embodiment 28 of the invention.

FIG. 47 (a) is a block diagram of information D2004 in the embodiment 28 of the invention, and (b) is a flow chart which shows image quality deterioration processing in the embodiment 28 of the invention.

FIG. 48 (a) is a view which shows original image data in the embodiment 28 of the invention, and (b) is a view which shows image quality deterioration processed image data of original image data in the embodiment 28 of the invention, and (c) is a view which shows image data to which information of original image data is added in the embodiment 28 of the invention, and (d) a view which shows image data to which information of original image data is added in the embodiment 28 of the invention.

FIG. 49 is a block diagram of an electronic paper system in an embodiment 29 of the invention.

FIG. 50 is a block diagram of a transfer apparatus in the embodiment 30 of the invention.

FIG. 51 is a block diagram of a display apparatus in an embodiment 31 of the invention.

FIG. 52 (a) is a cross sectional view of an electronic paper in the embodiment 30 of the invention, and (b) is a view which shows a cross section region of the electronic paper of the invention.

FIG. 53 (a) is a block diagram of the electronic paper in the embodiment 30 of the invention, and (b) is a cross sectional view which explains a writing operation at the time of the electronic paper in the embodiment 30 of the invention.

FIG. 54 is a block diagram of a display apparatus in an embodiment 31 of the invention.

FIG. 55(a) is a cross sectional view of an electronic paper in the embodiment 31 of the invention, and (b) is a view which shows a cross section region of the electronic paper in the embodiment 31 of the invention.

FIG. 56 is a schematic view which shows a writing operation to the electronic paper in the embodiment 31 of the invention.

FIG. 57 is a block diagram of an electronic paper in an embodiment 11 of the invention.

FIG. 58 (a) is an internal block diagram of a transfer apparatus in an electronic paper system of an embodiment 41 of the invention, and (b) is a cross sectional view of the transfer apparatus in the electronic paper system of the embodiment 41 of the invention

FIG. 59 (a) is a block diagram of a display apparatus in the embodiment 41 of the invention, and (b) is a cross sectional view of the display apparatus in the embodiment 41 of the invention.

FIG. 60 is a perspective view which shows a configuration of a writing apparatus in an embodiment 44 of the invention.

FIG. 61 is a view which shows a line type head in the writing apparatus shown in FIG. 60.

FIG. 62 is a view which shows a control system of the writing apparatus shown in FIG. 60.

FIG. 63 a view which explains ion irradiation time to time per one line to various sheet media in the embodiment 44.

FIG. 64 is a view which shows an appearance of an electrostatic image which is formed on the each sheet medium when ion is irradiated to the each sheet medium, during a period of the ion irradiation time shown in FIG. 47.

FIG. 65 is a view which shows an application example of the writing apparatus in the embodiment 44,

FIG. 66 is a view which explains pixel irradiation time in a writing apparatus in an embodiment 45 of the invention.

FIG. 67 is a view which shows an appearance of elestrostatic latent images which are formed on various sheet media in case that writing speed of writing to various sheet media in the embodiment 45.

FIG. 68 is a view which shows an appearance of electrostatic images which are formed on various sheet media in case that a distance between a control electrode in a writing apparatus of an embodiment 46 of the invention and a sheet medium is changed.

FIG. 69 is a perspective view which shows a configuration of a writing apparatus in an embodiment 47 of the invention.

FIG. 70 is a view which shows a control system of the writing apparatus shown in FIG. 53.

FIG. 71 is a perspective view which shows a configuration of a writing system in an embodiment 48 of the invention.

FIG. 72 is a view which shows a configuration of a sheet medium in the writing system shown in FIG. 55.

FIG. 73 is a view which shows a control system of the writing system shown in FIG. 71.

FIG. 74 is a view which shows a configuration of a conventional apparatus.

### DESCRIPTION OF THE PREFERRED EMBODIMENTS

With reference to the drawings, explanations will be made on the best mode for carrying out a display system of an electronic paper according to the present invention which is given a function readable as a paper and excellent in information management. It is noted that the embodiments described below are to be combined in use.

### Embodiment 1

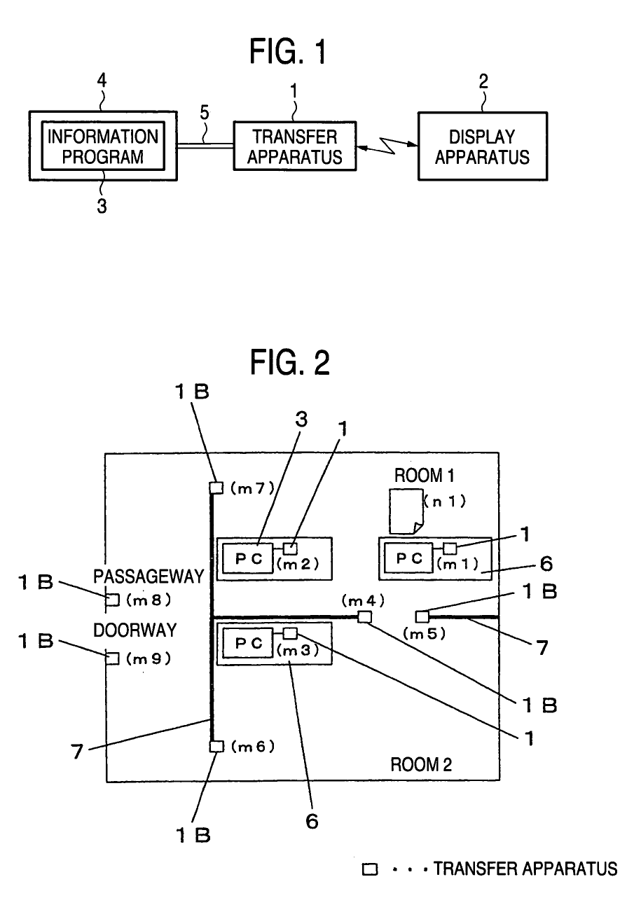

FIG. 1 is an arrangement diagram of an electronic paper display system in embodiment 1 of the invention. In FIG. 1, 1 is a transfer apparatus, 2 is display apparatus, 4 is PC for installing an information program 3 thereon, and 5 is a cable. Transfer apparatus 1 is connected to PC by cable 5. Meanwhile, transfer apparatus 1 and display apparatus 2 are wirelessly connected with each other. Incidentally, PC4 and transfer apparatus 1 in this embodiment are connected by the cable but can be connected wirelessly by such means as a wireless LAN.

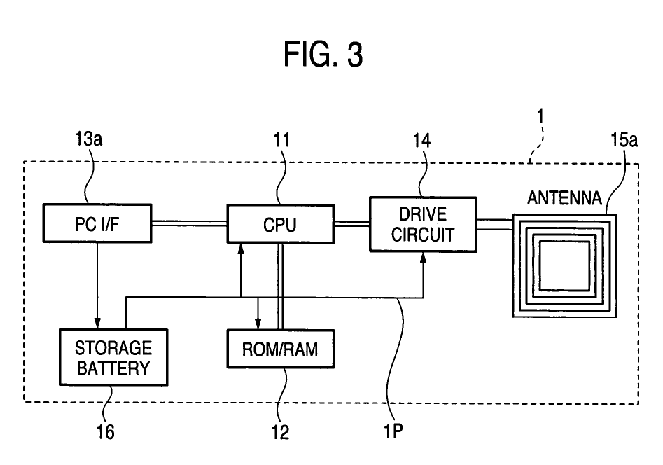

The present system basically enables to output the information prepared in PC to predetermined display apparatus 2 by way of transfer apparatus 1. With reference to FIGS. 3 to 7, explanation is now made in detail on the operation of the basic system shown in FIG. 1.

FIG. 3 is an interior block diagram of the transfer apparatus in embodiment 1 of the invention, wherein 11 is a CPU, 12 is a ROM/RAM as storage means, 13a is an PC IF to PC4, 14 is an antenna drive circuit, 15a is an antenna, and 16 is a storage battery.

CPU 11 is to control the operation of transfer apparatus 1 according to the program installed on ROM/RAM 12. Transfer apparatus 1 has PC IF 13a connected to PC 4 by a cable under the specification of USB2.0. Accordingly, transfer apparatus 1 does not require a power-source circuit. Power can be supplied through the cable connected to PC 4 and stored in the storage battery 16 so that driving can be effected on the power. 1P is a direct-current power outputted from the storage battery 16, which is to be supplied to various circuit blocks. Incidentally, although this embodiment omitted the use of a power-source circuit, power source means may be configured having an AC power-source circuit or a battery. Incidentally, although transfer apparatus 1 shown in FIG. 1 is described connected to PC 4 through a cable because of taking an example of PC 4 as a general-purpose information processing apparatus, it can be realized by an exclusive apparatus configured with transfer apparatus 1 and PC 4 integrally.

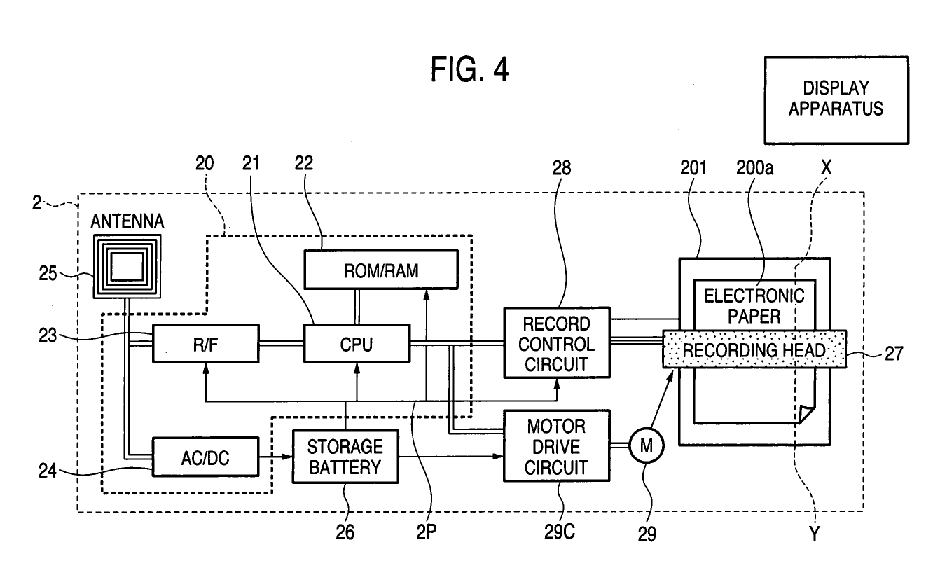

FIG. 4 is an interior block diagram of the display apparatus in embodiment 1 of the invention. 21 is a CPU for controlling the operation of display apparatus 2, 22 is a ROM/RAM for holding/recording a control program or data, 23 is an RF converter circuit for extracting a signal out of a radio frequency received, 24 is an AC/DC converter circuit for extracting an electric energy from an electromagnetic wave received at the antenna 25 and converting it into a direct-current power, 25 is a transmission/reception antenna for communication with transfer apparatus 1, 26 is a storage battery for storing a direct-current power generated by the AC/DC converter circuit 24, 27 is a line-type recording head having a plurality of pixel electrodes for applying an electric field to an electronic paper 200a in a state contacted with the electronic paper 200a and sandwiching same with a common electrode 201, 28 is a record control circuit for applying a voltage to the pixel electrode of the recording head 27, 29 is a drive motor for moving the recording head 27 relative to the electronic paper 200a in a transport mechanism, not shown, 29C is a motor drive circuit for controlling the operation of the drive motor 29.

Here, the electronic paper 200a is to be attached to and detached from the display device 2 by means of a mechanism, not shown. The control of attachment and detachment is under management according to the information program 3. Meanwhile, the power of the storage battery 26 is used in the operation of recording to the electronic paper 200a.

The section surrounded by broken line in FIG. 4 is a circuit configuration similar to that of the constituent elements in realizing a wireless tag, which can be made as an IC extremely small in size. However, this embodiment, because mounting a write circuit to the electronic paper 200a to consume power by far greater as compared to that of a wireless tag, is greatly different in basic specification as to the power-receiving antenna 25, the AC/DC converter circuit 24 for converting the energy and the storage battery 26. For example, the electromagnetic wave at a frequency of 1 MHz is efficiently received to extract at the antenna 25 a low AC voltage to be converted by boost into a DC voltage of 25V. The power is stored on a two-layered electric capacitor that is utilized as a storage battery 26. Incidentally, the storage battery 26 may incorporate therein a control circuit for extracting a stable voltage.

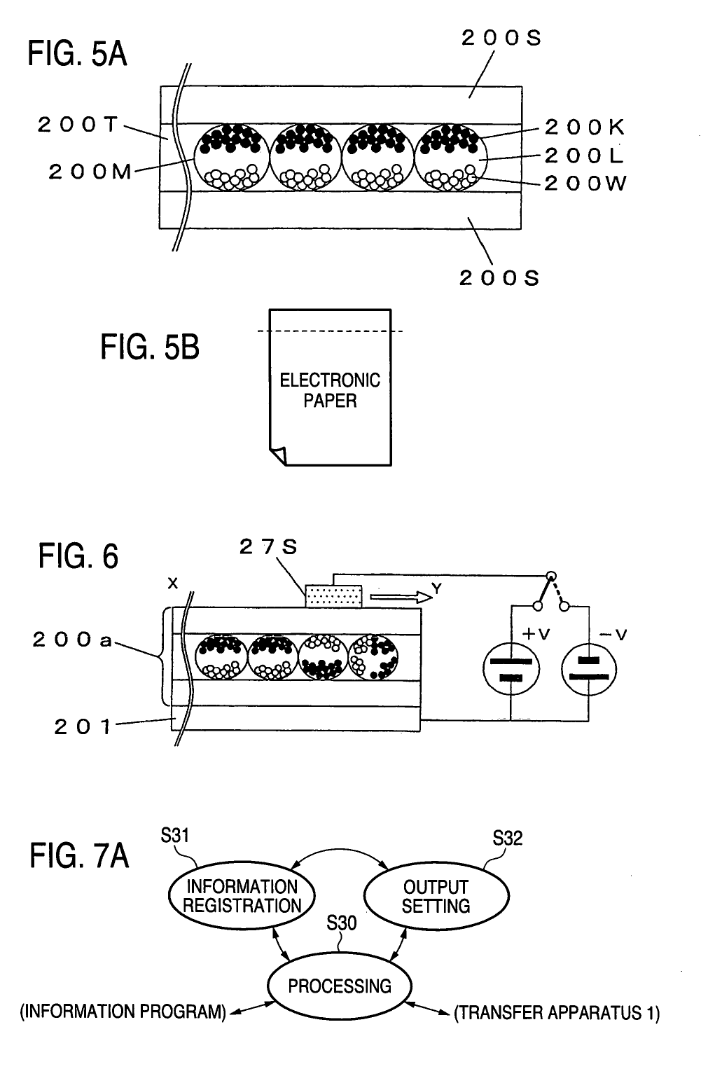

FIG. 5(a) is a sectional view of the electronic paper in embodiment 1 of the invention, showing a structure that the electronic paper 200a is made by an electrophoretic-schemed electronic paper in the prior art. FIG. 5(b) is a plan view of the electronic paper in embodiment 1 of the invention 200M is a microcapsule having the function of electronic ink. 200S are light-transmissive sheets sandwiching the microcapsules 200M. 200T is a non-conductive binder for bonding the microcapsules 200M on the sheet 200S.

Here, the microcapsule 200M is charged with a plurality of particles and a suspension fluid dyed. The particles have an optical reflective characteristics and contrasted electrophoretic natures. For example, 200K uses a black particle charged + (positive) while 200W a white particle charged − (negative). 200L can be comprised of a transparent suspension fluid. Incidentally, although the electronic paper in this embodiment had both surfaces made by transparent sheets 200S, one surface may be a non-transmissive sheet or a metal-deposited sheet.

FIG. 6 is a sectional view showing the operation of image write to the electronic paper in embodiment 1 of the invention. By switching the polarity of the voltage applied to between one of pixel electrodes 27S of the record head 27 arranging thereon pixel electrodes in a line form by means of the record control circuit 28, the charged particles 200K and 200W are placed in electrophresis at within the microcapsule 200M. This makes it possible to write a line-formed display image to the record head 27 at the underneath thereof. Furthermore, the record head 27 is moved in a Y-direction to thereby record the next line. Due to this, image write can be effected over the entire surface of the electronic paper 200a.

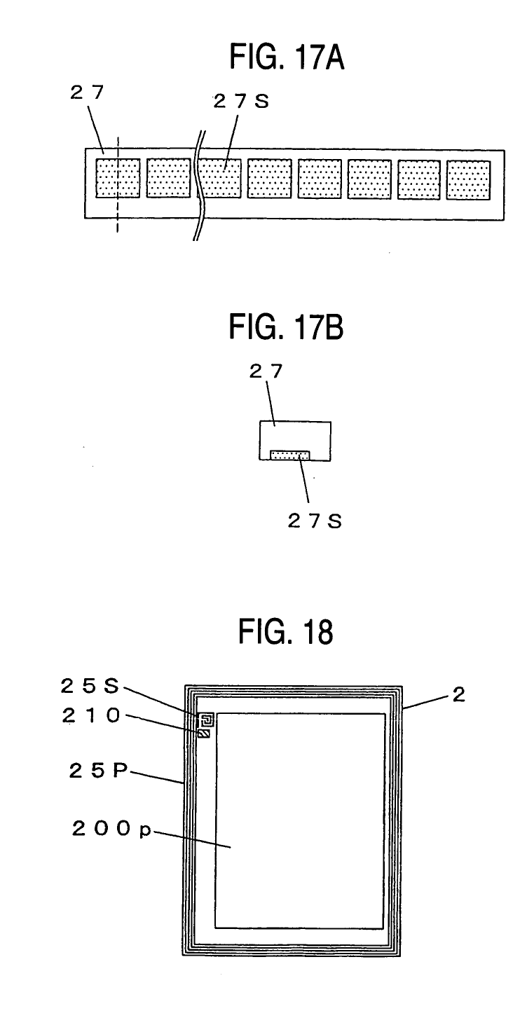

FIG. 17(a) is a structural view of the record head in embodiment 1 of the invention, wherein pixel electrodes 27S are arranged at an equal interval in a line. The pixel electrodes 27S are connected to the record control circuit 28 by way of lines, not shown. FIG. 17(b) is a sectional view of the record head in embodiment 1 of the invention, wherein the pixel electrode 27S is present in a surface on the side to be contacted with the electronic paper.

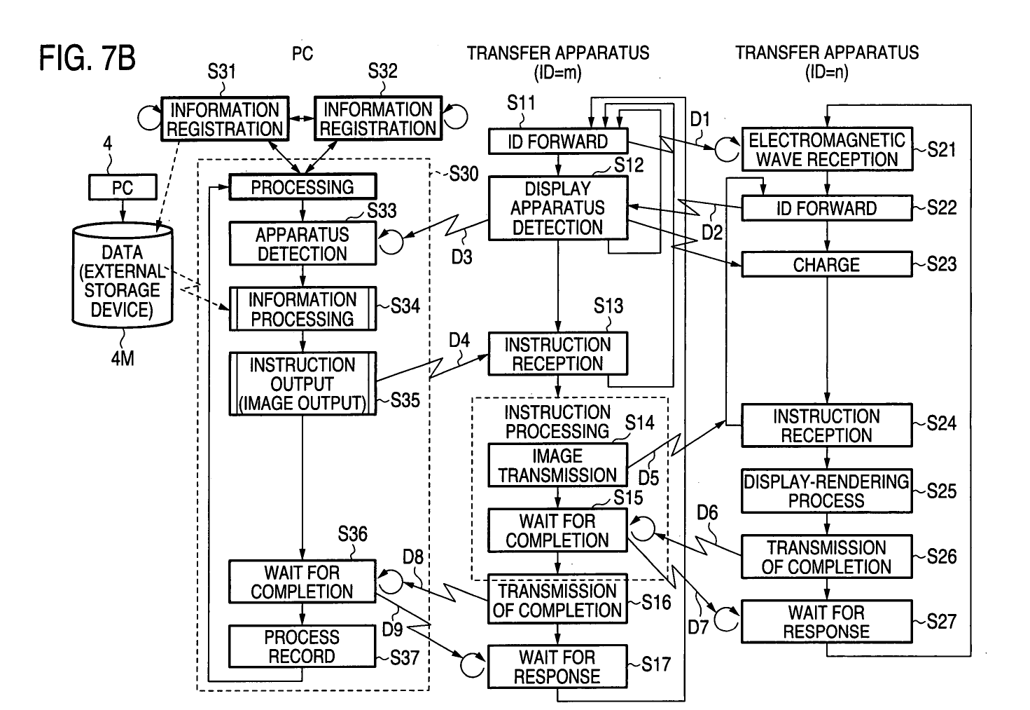

FIG. 7(a) is an information-program transition diagram in embodiment 1 of the invention, which is constituted by the blocks of image registration, output setting and process operation. Usually, the information program is in waiting for an event occurrence. Upon the occurrence of an event, the operation block is to be executed.

FIG. 7(b) is a flowchart showing an operation overview in embodiment 1 of the invention. Referring to this figure, the operation is explained in detail. The user, who entered an information register mode through a menu screen, not shown, of the information program, is allowed to proceed to step S31 where he/she registers, to PC 4, display information, such as of images and characters, user's individual attribute information, discrete information for managing display apparatus 2, etc. that are to be displayed on display apparatus 2. Here, display information includes those of image information made into data by a scanner, and document information constituted by a text, a figure, a graph or a photographic picture prepared by application software. Meanwhile, user includes a use form of a plurality of persons, such as those who are on the side to view information or those who are on the side to manage/provide information. For this reason, in order to identify and manage a plurality of users, it is possible to provide diversified conveniences by managing various pieces of personal information, such as names, in-company position and authority, age, passwords for security management, and so on.

Then, when an output setting mode is entered by the user on PC 4 through a menu screen, not shown, of the information program 3, the process proceeds to step S32. At the output setting step S32, the user is to make various output settings as to the information to be displayed. For example, desirable setting is made on the information to be displayed, user designation, display apparatus choice, transfer apparatus designation, display term and so on. Those pieces of output setting information are recorded and stored in PC 4 or in an external storage device 4M connected to PC 4.

Here, the information to be displayed can be prepared by processing the information registered by a previously prepared process procedure according to the personal information of the user possessing the display device or the user authenticated on PC 4. For example, various information processes and applications are available, e.g. displaying only a part of registered information, merging a plurality of pieces of information and delimiting a display time.

The operation is now explained on an example with an output setting for a case of viewing the registered information of material 1, not shown, at display apparatus ID=n by way of transfer apparatus ID=m.

When connected to PC 4 and supplied with power, transfer apparatus 1 at step S11 regularly outputs the information D1 including a discrete ID, as a predetermined signal of electromagnetic wave, through the antenna 15a. Repeated operation is continued for display apparatus detection at steps S11 and S12 that is also for ID forwarding and electromagnetic wave supply. Here, in case of a detection at step S21 by a reception power that the user carrying display apparatus 2 comes near transfer apparatus 1 and lies at a location within a distance the electromagnetic wave is to be received, display apparatus 2 receives an energy of the electromagnetic wave as a power and proceeds to step S22 where it forwards to transfer apparatus 1 the information D2 including a discrete ID possessed by display apparatus 2. Transfer apparatus 1 transmits, to PC 4, information D3 that ID(m) of transfer apparatus 1 is included in the discrete ID of display apparatus 2 detected at the step S12. Display apparatus 2, after forwarded the ID, proceeds to step S23 where it receives an electromagnetic wave from transfer apparatus 1 and charge energy to the storage battery 26. Subsequently, until receiving an instruction from transfer apparatus 1 at step S24, the process waits while repeating the ID forward at step S22 and the charge operation at step S23.

PC 4, at step S33, is sent a detection of display apparatus 2 and ID thereof from transfer apparatus 1 and detects it as an apparatus that output designation is made from the discrete information previously set for output at the step S32. Furthermore, when confirming that an output condition designated is satisfied, the process proceeds to step S34 where information processing is made according to the output setting information set at the step S32. Here, because the output setting records a setting for outputting material 1 to display apparatus ID=n, PC 4 processes the information of material 1 stored in PC4 or in the external storage apparatus 4M of PC4 into image information in a size to be displayed as an electronic paper, then proceeding to step S35. At step S35, an image output instruction is sent as information D4 to transfer apparatus 1 of ID=m detected as display apparatus 2 of ID=n. Incidentally, where the output setting recorded does not have any setting to instruct, the process moves to an event-wait state shown in FIG. 7(a).

Transfer apparatus 1 at step S13, when receiving instruction information D4 from PC 4, processes the instruction. Transfer apparatus 1 detected and grasped as to whether or not display-recording apparatus 2 of ID=n lies within a range receivable by transfer apparatus 1. When within the range, the process proceeds to step S14 in order for instruction processing. Meanwhile, when display apparatus 2 designated is not detected, the process waits until achieving a detection while repeating the steps of from S11 to S12. Because the instruction herein is to output the image of material 1 to display apparatus 2 of ID=n, the image information of material 1 is transmitted as information D5 together with the instruction information representative of an output to display apparatus 2 of ID=n through the antenna 15a.

Display apparatus 2 at step S24, when recognized a fact the image output instruction is for itself, stores the image information of material 1 sent together to the ROM/RAM 22. Display apparatus 2 at step S25 performs a display-rendering process of image depending upon the received image information, thus writing the image to the electronic paper 200a line by line. After completing the writing of all the information received, the process proceeds to step S26 where a signal D6 of instruction process completion is sent together with instruction information and ID information to transfer apparatus 1.

Transfer apparatus 1 at step S15, after receiving an instruction completion from display device 2, outputs a response signal through the antenna 15a, and then moves to step S16. Furthermore, at step S16, it transmits instruction complete information D8 at I/F 13a to PC 4, and the process moves to step S17 where to wait for a response from PC 4.

PC 4, after outputting an instruction at step S35, moves to step S36 where waiting for instruction complete information D8 from transfer apparatus. When confirming instruction complete information D8, a response signal D2009 is transmitted to transfer apparatus 1, and the process moves to step S37. At the step S37, PC4 records the fact of completing the processes in series as a history in a not-shown storage means of within PC 4 or in an external storage device 4M connected to PC 4.

Transfer apparatus 1, after receiving and confirming at the step S17 the response signal D9 from PC 4, returns to the former step S11.

According to this structure, in the electronic paper display system of the invention, transfer apparatus 1 communicates in non-contact with display apparatus 2, to detect a display apparatus 2. By recognizing the personal identification information on the display side by means of the information program 3, various data processes can be effected based on the personal identification information according to previously set/registered information and process procedure. By forwarding image information and an operation instruction to an arbitrary transfer apparatus 1, display can be controlled/managed onto a desired display device 2. Accordingly, after outputting setting, desired information can be displayed on arbitrary display information by merely placing display apparatus 2 close to transfer apparatus 2. This makes it possible to provide a printing solution environment nonexistent in the conventional.

Furthermore, the electronic paper 200a is in a simple structure merely sandwiching a microcapsule as an electronic ink between sheets without having write electrodes and circuits, thus being made inexpensive, flexible and light in weight. Besides, because it can be removed from display apparatus 2, display information can be viewed just like a paper without difficulty. Meanwhile, the electronic paper can be used for the purpose of diminishing the paper resource uselessly consumed in trial output of preparation documents because repeated writing and erasure are possible.

Incidentally, the present embodiment described, as information processing, the example of processing from information material 1 into image information in a size for display onto an electronic paper. However, by making diversified information processes e.g. a processing as image information to display only a part of material 1 from user's attribute, and a processing as image information by adding another piece of information to material 1, it is possible to realize various conveniences, such as calling attentions and reconfirmation to the user and increased efficiency and advertisement effect due to information summarization.

### Embodiment 2

FIG. 2 is an arrangement diagram of an electronic paper display system in embodiment 2 of the invention. In FIG. 2, the same constituent elements as those of FIGS. 1 and 3 to 7(b) are attached with the same references, to omit the explanations thereof.

FIG. 2 shows a complex system arrangement using an electronic paper display system arranging a plurality of transfer apparatuses 1 and PCs 4 within a room. In FIG. 2, 6 is a table for resting the PC and transfer apparatus 1 thereon, 7 is a wall partitioning the room, 1B is another form of transfer apparatus 1 which is a connection apparatus having a function of wireless connection to a network, thus constituting an electronic paper display system.

PC 4 connected with transfer apparatus 1 is installed thereon with an information program 3. Note that one information program 3 serves as a master administrating the overall whereas the others are to operate under the dominance thereof by taking an association with the information program 3 set up on the master. Those associative operations are to be executed in operation block S30 for the processing of FIG. 7(a).

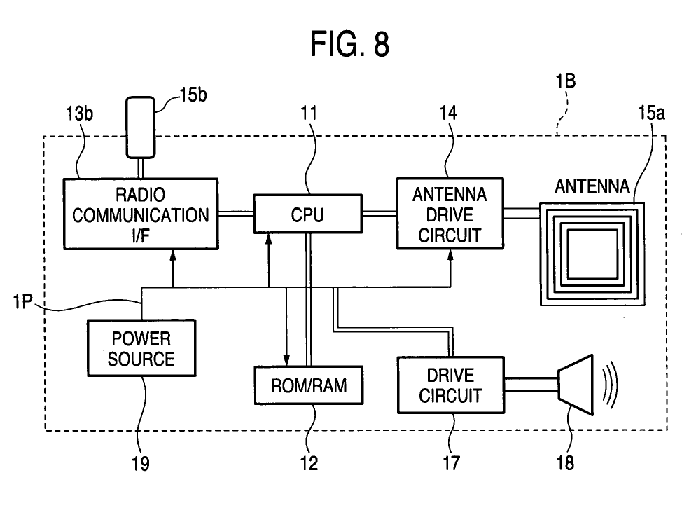

FIG. 8 is a block diagram of the transfer apparatus in embodiment 2 of the invention. In FIG. 8, the same constituent elements as those of FIG. 3 use the same references, to omit the explanations thereof. Transfer apparatus 1B are nearly in the same configuration as transfer apparatus 1. The difference lies in that the interface circuit to the PC is a wireless communication interface circuit 13b compatible with wireless communication, such as of Bluetooth or Wireless LAN, as known arts, wherein there is provided a communication antenna 15b for the purpose thereof and further a buzzer 18 and its drive circuit 17 for issuing alert sound.

Transfer apparatus 1B is in a state always connected to the network, which are under management of the information program 3 set up on the master for management of the system overall. For this reason, discrete ID information is set up in the ROM/RAM 12 as a storage device built in the transfer apparatus. This ID enables for the information program to identify the transfer apparatuses in plurality.

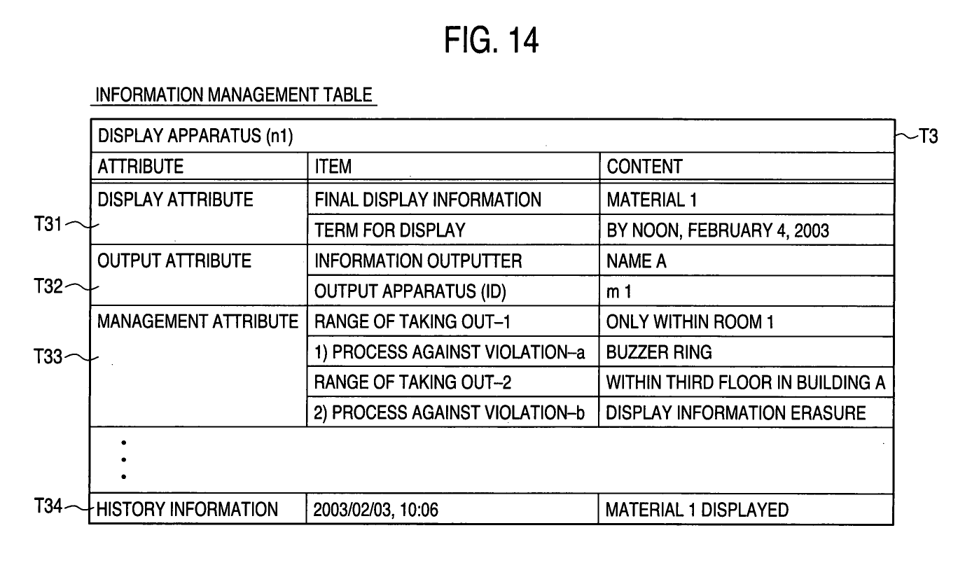

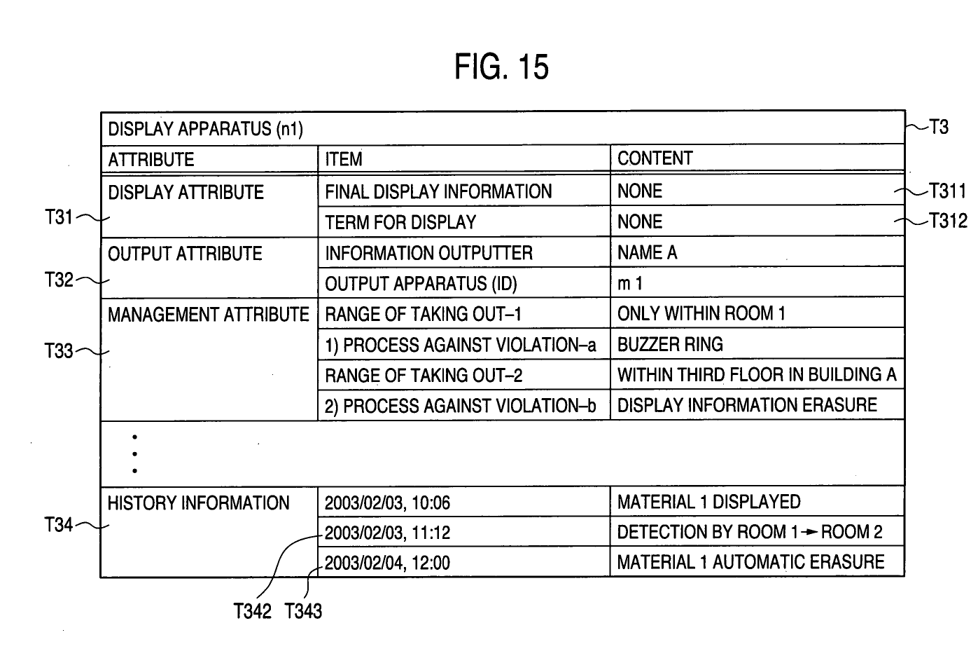

FIGS. 14 and 15 are figures of information management tables in embodiment 2 of the invention, which are tables representing an embodiment as to the information management table describing management information, in display apparatus 2 (ID=n1) where executing an information processing according to the information program 3. Information program 3 is provided with information management tables T3 respectively for display apparatuses, in order for information management. This embodiment comprises a plurality of attributes, i.e. display attribute T31, output attribute T32, management attribute T33 and history attribute T34.

Here, explanation is made on the content of information management table T3, as an example displaying in the last time the content of material 1 on display apparatus 2 (n1). Display attribute T31 is constituted with an item of final display information representative of the content currently displayed on display apparatus 2 (n1), and an item of displayable term for managing a term in which the information is to be displayed. Here, material 1 is being displayed wherein recorded is information that display is possible up to the noon, Feb. 4, 2003.

Output attribute T32 is constituted with an item representative of a person who output-processed the relevant information, and an item recording output apparatus ID information representative of which one of the transfer apparatus output is made from. This example records that a person of name A outputted the relevant information from transfer apparatus (ID=m1).

Management information T33 records a scope the display information can be taken out, and a measure against the violation thereof. For example, the scope of bringing out is established by an information manager in accordance with information content. Furthermore, this can be automatically decided by a combination of information management level setting and user's personal attribute, according to a program. History information T34 records a history of the event information occurring on display apparatus 2 (n2) in an amount of predetermined period of time (e.g. leaving the record limited up to 5 years ago). In FIG. 14, there is recorded the fact that material 1 has been displayed at 10:06, Feb. 3, 2003.

Referring to FIGS. 2, 7(b), 14 and 15, explanation is made in detail on the operation of the complex system arrangement shown in FIG. 2. In the case that display apparatus (n1) outputted material 1 is taken out at 11:12, Feb. 3, 2003 into room 2 by a person of name A, this fact is detected by transfer apparatus 1B (ID=m4) provided at a doorway connecting between room 1 and room 2 and transmitted to the information program 3 of the master. The information program confirms the content of an information management table registered, from the detected ID of display apparatus. Here, alert sound is issued according to the management information by instructing transfer apparatus 1B (ID=m4) to ring a buzzer as set up as a violation measure-a. Simultaneously, this event is additionally recorded as history information data to history information data T342.

Incidentally, a plurality of transfer apparatuses 1B are set up at the doorway so as to positively detect display apparatus 2 in accordance with the size thereof. Accordingly, the user of display apparatus 2 (n2) is aware of by alert sound with a result that he/she is prevented from taking the display apparatus 2 back to room 1 and bringing material 1 prohibited by information management to room 2.

Furthermore, after the user has viewed and utilized material 1, when it becomes 12:00, Feb. 4, 2003 an instruction for erasing display information is sent from the information program 3 recognized a displayable term to transfer apparatus 1B recognizing display apparatus (n1) by way of information program 3 of PC 4 connected with transfer apparatus 1B. After confirming a completion of erase operation at the display apparatus according to the response signal, cleared are final display information data T311 and displayable term data T312 of display attribute. Furthermore, the event automatically erased is additionally recorded as history information data to history information data T343 (information management table in FIG. 15, for the above)

According to this structure, in the electronic paper display system of the invention, transfer apparatus 1 communicates in non-contact with display apparatus 2, to detect display apparatus 2 and recognize it based on display-side personal identification information according to information program 3. By set/recorded information and process procedure, it is possible to manage the location of display apparatus 2, to issue an alert to the user against taking-out and control and manage the display information. Accordingly, a broad use environment can be architected that electronic paper and display information management can be systematically utilized by the electronic paper display system. Incidentally, in this embodiment, display attribute T31, output attribute T32, management attribute T33 and history information T34 were provided in the information management table. Instead, other attributes and data for management information may be provided therein.

### Embodiment 3

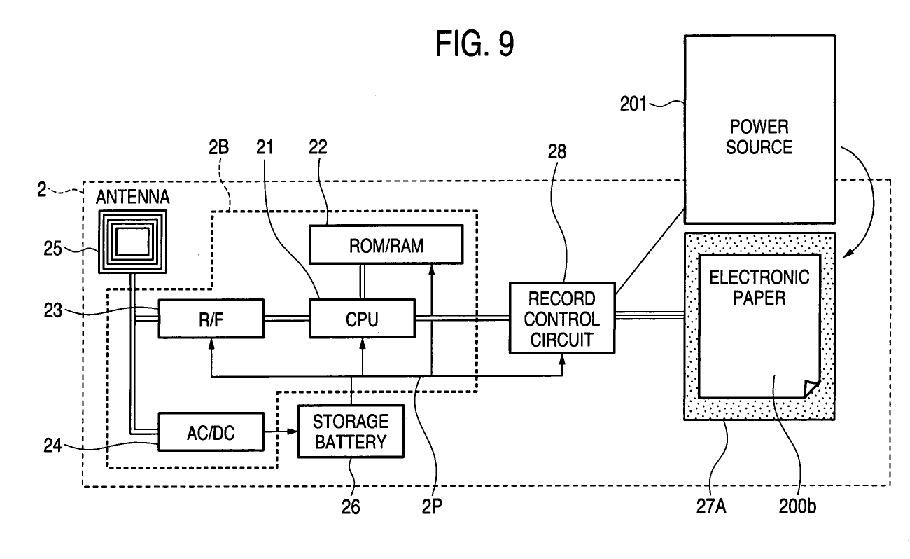

FIG. 9 is an interior block diagram of a display apparatus in embodiment 3 of the invention. In FIG. 9, the same constituent elements as those of FIG. 4 are attached with the same references, to omit the explanations thereof. In display device 2 in FIG. 9, write to the electronic paper is by being sandwiched between two surfaces thereby enabling a recording by surface-based writing. In FIG. 9, 27A connected to a record control circuit 28 is a recording surface while 201 is an electrode sheet. Those constitute a recording section to the electronic paper 200a. Incidentally, the section 2B surrounded by broken line is a circuit of other than the display section, which can be made as one-chip IC. Accordingly, utilization is by placing the electronic paper 200a on the recording surface 27A of display apparatus 2 in a state sandwiched by a light-transmissive electrode sheet 201 arranging a transparent electrode over the entire surface.

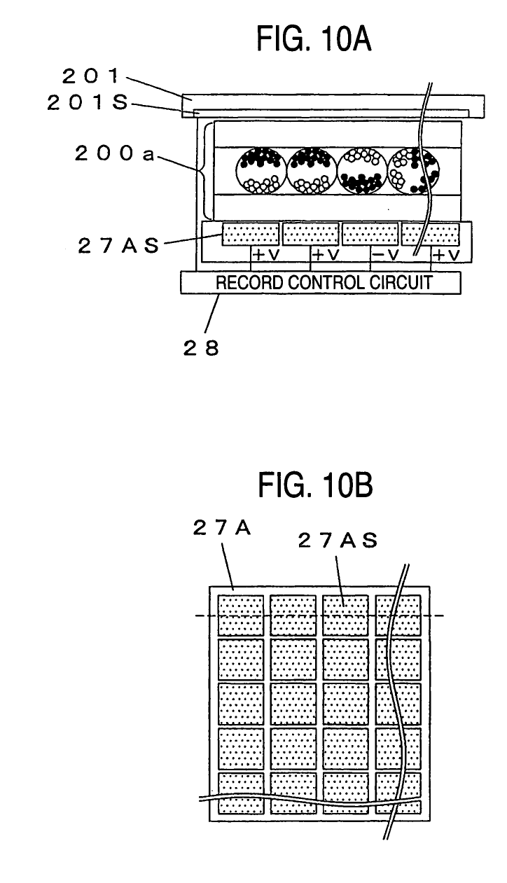

FIG. 10(a) is a sectional view of an electronic paper in embodiment 3 of the invention, which is a sectional view explaining the write operation in this time. FIG. 10(b) is a structural view of a recording surface in embodiment 3 of the invention. A plurality of pixel electrodes 27AS are arranged on the recording surface 27A, and connected to a recording control circuit 28 by a line, not shown. An electrode 201S exists on a side surface of the electronic sheet 201 to be contacted with an electronic paper. By applying an arbitrary voltage with the foregoing electrode 27AS, an electric field is caused to enable writing to the electronic paper 200a.

According to this structure, display apparatus 2 of the electronic paper display system of the invention eliminates the necessity of such a motor or drive mechanism as used in FIG. 4 in writing to the electronic paper. Furthermore, because information can be viewed and carried while sandwiching same by a transparent electrode sheet 201, improved is the convenience that the electronic paper is free from being stripped off. Similarly to this, it is a generally frequent practice to use a form of carrying a document by being sandwiched in a stationery clear-file. In addition to the conventional convenience, because rewrite is possible for electronic paper display, the paper to be carried can be reduced in amount.

### Embodiment 4

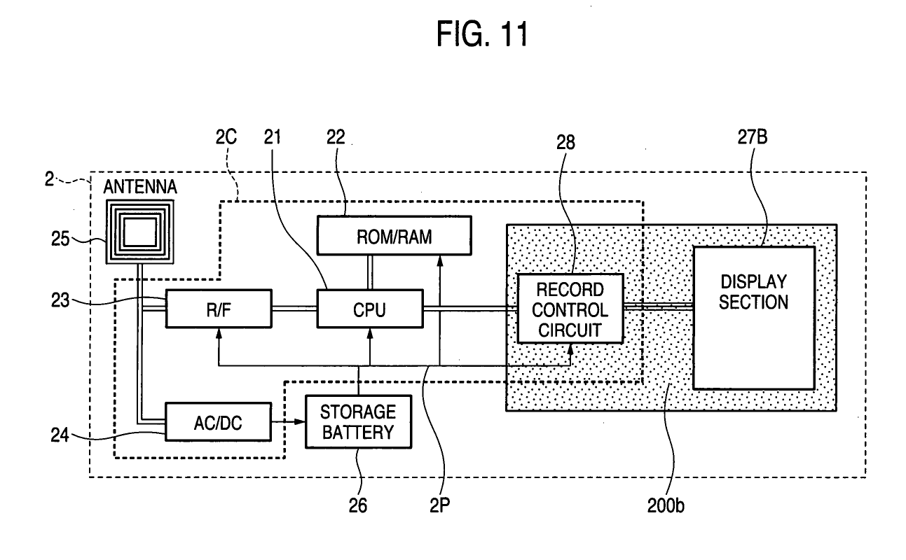

FIG. 11 is an interior block diagram of a display apparatus of an electronic paper display system in embodiment 4 of the invention. In FIG. 11, the same constituent elements as those of FIG. 4 are attached with the same references, to omit the explanations thereof. The display apparatus in FIG. 11 is arranged for writing, in a surface to the electronic paper 200b, constituting an electronic paper 200b by means of a recording control circuit 28 and a display section 27B. Incidentally, the section 2C surrounded by broken line is a circuit of other than the display section, which can be made as one-chip IC. However, a switch-element drive circuit in the display section can be configured separately. Here, the electronic paper 200b is in a structure that a microcapsule 200M is sandwiched between an electrode 201 surface and a surface arranging a pixel electrode 27BS, thus being in an integral form with the display apparatus 2.

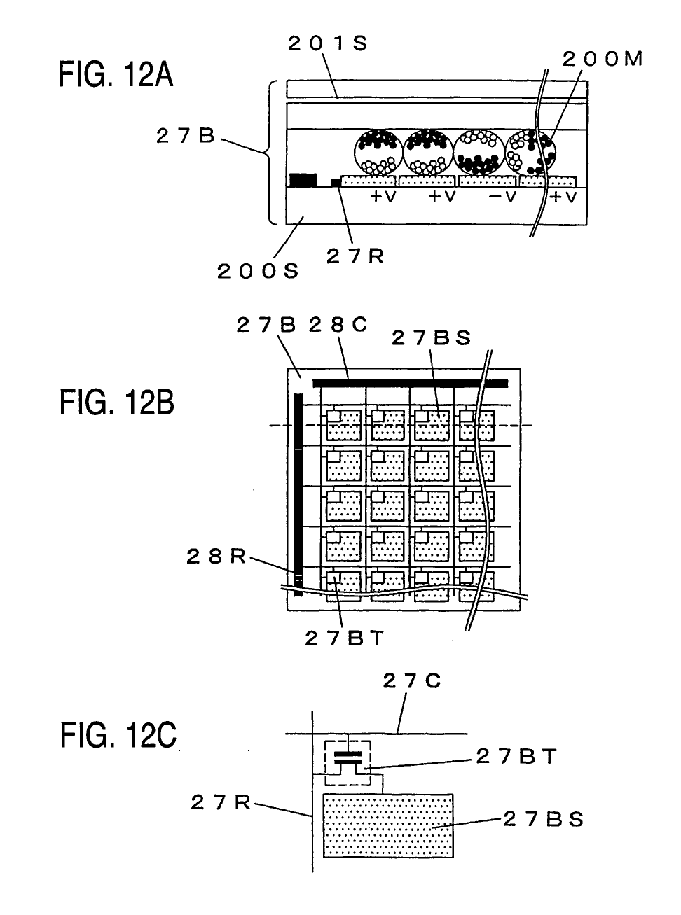

FIG. 12(a) is a sectional view of the electronic paper in embodiment 4 of the invention, which is a sectional view explaining a write operation at this time. FIG. 12(b) is a structural view of the recording section in embodiment 4 of the invention. FIG. 12(c) is a schematic view of a pixel drive circuit in embodiment 4 of the invention.

In the display section 27B, 27BS is a pixel electrode, 27BT is a switching element, 28R is a horizontal drive circuit and 28C is a vertical drive circuit. A plurality of pixel electrodes 27BS are arranged in the display section 27B. The pixel electrode 27BS has a switching element on each pixel thereof. As shown in FIG. 12(c), the switching element 27BT has gate and source electrodes respectively connected to a gate line 27C and a source line 27R as horizontal and vertical lines connected to the drive circuits 28R and 28C in this embodiment. This makes it possible to individually drive the pixel electrodes 27BS connected to the drain electrodes of the switching elements 27BT. Incidentally, although the drive circuits 28R and 28C are isolated from the recording control circuit 28, those may be incorporated in the section 2C in an integral form.

According to this structure, in the display apparatus 2 in the electronic paper display system of the invention, because the electrode for electric-field application to the microcapsule 200M can be put in close contact during writing to the electric paper, the application voltage for writing can be reduced. Furthermore, because the pixel electrode 27BS and the color-based microcapsule provided in multi-colors can be matched in a preparation stage of an electronic paper, color display can be coped with. Meanwhile, in case a plurality of display apparatuses are arranged in a section always communicatable with a transfer apparatus, it is possible to supply, in a particular time, information suited for a purpose to particular display apparatuses classified based on purposes. Namely, conveniences can be provided in many fields, e.g. of work order sheets, operation manuals and hospital medical chart. Incidentally, although this embodiment provided one switching element 27BT on one pixel electrode 27BS, an active-matrix drive structure may be provided by providing a power-source line and a plurality of switching elements.

### Embodiment 5

Although the electronic paper 200a as a display device of display apparatus 2 in FIG. 4 is structurally attachable/detachable to/from the display apparatus 2 and provided only one, a plurality of electronic papers 200a can be structurally removably attached on a individual basis. Furthermore, it is possible to provide a plurality of electronic papers 200a different in size to be removably attached on an individual basis. Meanwhile, the electronic paper 200a can be unremovably fixed on the display apparatus 2 or the information storage means can be incorporated in the display apparatus.

According to this structure, in the display apparatus 2 of the electronic paper display system of the invention, it is possible to display much more information at one time and to easily carry only the necessary information. Furthermore, where storage means is incorporated, display information can be received and stored together with management information. Because information writing, erasure and display management can be carried out only on display apparatus 2, much more information can be displayed singly.

### Embodiment 6

Although display apparatus 2 in FIG. 4 is for writing to the electronic paper 200a by moving the record head 27 relative thereto, the electronic paper 200a can be transported by fixing the record head 27 as in the thermal printer. This structure can make display apparatus 2 of the electronic paper display system of the invention smaller in size.

### Embodiment 7

Although not shown, display function means such as a liquid-crystal display can be provided though not provided in the transfer apparatus shown in FIG. 4 or 8. This structure can provide much more information and instructions for alert and cautions to the user in the transfer apparatus of the electronic paper display system of the invention, thus improving conveniences.

### Embodiment 8

Although the buzzer in FIG. 8 is provided on transfer apparatus 1B, it can be mounted on display apparatus 2. Meanwhile, besides the buzzer, it is possible to mount other means, e.g. vibrations or light flicker to be perceived by the user. Furthermore, alert can be provided by means of alert sound by the buzzer possessed by the PC or of display on a display screen. This structure can further improve user's perception as to alert.

### Embodiment 9

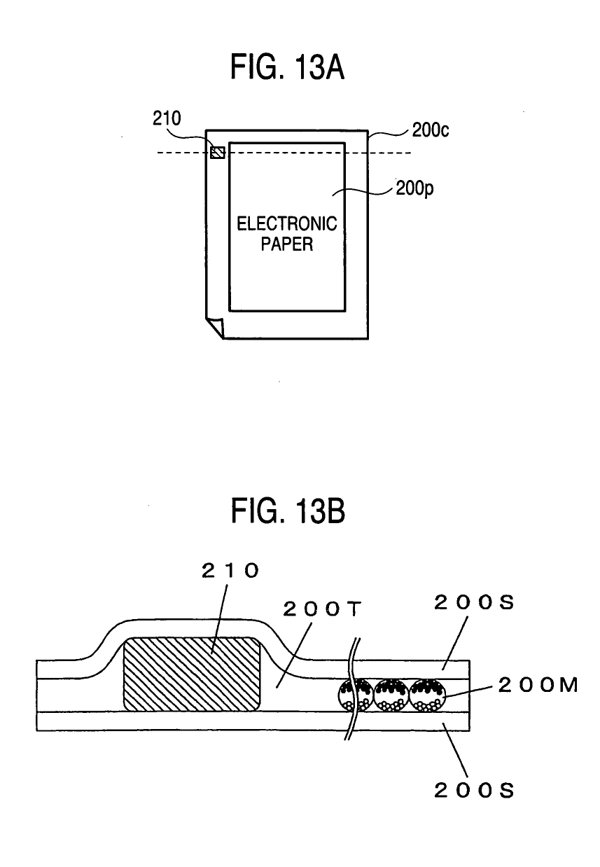

FIG. 13(a) is a structural view of an electronic paper in embodiment 9 of the invention. FIG. 13(b) is a sectional view of the electronic paper in embodiment 9 of the invention. In the electronic paper 200c, a wireless tag 210 is sandwiched between the outer side of a display section 200p including a microcapsule 200M and the sheet 200S, and bonded by a binder 200T similarly to the microcapsule 200M.

The wireless tag 210, known as an RF ID, is configured with similar circuit blocks to those of CPU 21, ROM/RAM 21, RF converter circuit 23, AC/DC converter circuit 24, antenna 25, storage battery 26, etc. shown in display apparatus 2. This is in a practical application in a size of nearly a sesame grain. The wireless tag 210 can be arranged to have direct wireless communication with transfer apparatus 1 or wireless communication with display apparatus 2.

According to this structure, even where the electronic paper is in a specification it can be removably attached on display apparatus 2, the electronic paper removed and its information can be managed without the attachment/detachment mechanism mounted on display apparatus 2 for the purpose of monitoring.

Incidentally, although this embodiment mounted one wireless tag, a plurality of wireless tags may be mounted correspondingly to different radio frequencies. Furthermore, although the wireless tag made by a semiconductor chip is incorporated herein, a circuit pattern of an organic semiconductor may be patterned over the sheet 200S. This structure can improve the simultaneous detection performance of a plurality of electronic papers, making it possible to provide an electronic paper even in thickness.

### Embodiment 10

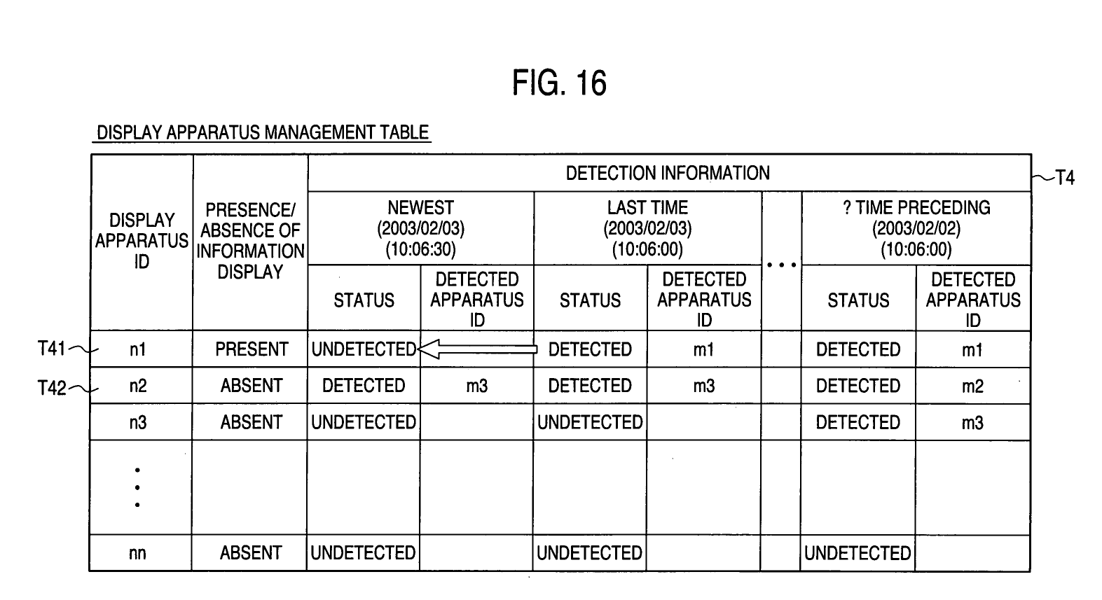

In the information program 3, the operation block S30 is allowed to have a display-apparatus management process of after performing an information display. FIG. 16 is a figure of a display-apparatus management table in embodiment 10 of the invention.

Display-apparatus management table T4 stores and manages, over a particular term, the presence or absence of information display, the state as to whether detected at a constant or non-constant time interval and the ID information of a detected transfer apparatus, for each ID of display apparatus.

Because the operation of information output setting is described in FIG. 7(b) in embodiment 1, explanation is now made on the operation of the information program 3 provided with a post-information-display process with reference to FIG. 7(b). In a state that the distance between the transfer apparatus and display apparatus 2 becomes longer than a wireless communicatable section or display apparatus 2 is put in a metal case or so and shielded of the radio waves, display apparatus 2 can no longer be detected from transfer apparatus 1. Transfer apparatus 1, at step S12 in display apparatus detection, transmits the fact of impossibility of detection, as information D3, to PC 4. PC 4, at step S33 in apparatus detection, updates at a constant time interval the information of display-apparatus management table as shown in FIG. 16, and proceeds to the next step.

At step S34 in information processing, display-apparatus management process is performed. Here, because there is a status change in display device (ID=n1) having display information from detectable status into non-detectable status, information program 3 prepares a buzzer-ring instruction output to the PC connected to transfer apparatus 1 (ID=m1) detected display apparatus (ID=n1) up to the last time. Subsequently, at step S35, a buzzer-ring instruction is outputted via a network to the PC connected to transfer apparatus 1 (ID=m1). The PC connected with transfer apparatus 1 (ID=m1), received the instruction, issues a buzzer sound.

This structure enables information management by notifying, by issuing an alert sound, the user on display apparatus 2 displaying the information requiring management to make the display apparatus stay within a perceivable section. Incidentally, although this embodiment issued a buzzer sound from the PC, a buzzer sound may be issued directly from transfer apparatus 1B instead from the PC where the apparatus detected is transfer apparatus 1b having a buzzer.

### Embodiment 11

Display apparatus 2 shown in FIGS. 4, 9 and 11 has a recording section to electronic paper whose circuit can be configured by an organic semiconductor. Particularly, the switching element 27BT shown in FIG. 12(b) desirably uses an organic field-effect transistor. For example, rendering is performed with conductive-polymer PEDOT (poly-ethylenedioxythiophene) by an inkjet scheme, to form a source, a drain and a gate. A conjugate-polymer semiconductor layer is formed to a film thickness of 30 nm or smaller on the source and drain by a spin-coat technique, on which a polymer insulator layer is formed to a film thickness of 50 nm by a spin-coat technique, to thereby form a gate thereon. Due to this, a top-gate structured TFT can be realized. This structure can reduce the thickness and weight of display apparatus 2 or electronic paper.

### Embodiment 12

The antenna mounted on transfer apparatus 1 or display apparatus 2 can be structured of an organic material. For example, the antenna is structured of a metal plate, a magnetic material or a conductor pattern. In order to prevent the unwanted radiation of electromagnetic field from the surface on which transfer apparatus 1 is placed on a table, a metal sheet such as of aluminum is used on one surface of the antenna, on which a magnetic material or a hybrid material an inorganic material of a magnetic or dielectric material is mixed with a polymeric organic material is layered by pressing or so, on which an antenna pattern is further formed of an organic material extremely low in resistance value and high in conductivity by an inkjet scheme, thereby forming a sheet-formed antenna. On the sheet-formed antenna, an IC chip incorporating a peripheral circuit is mounted in a manner contacted with an end of the antenna pattern, thus making up an apparatus. Incidentally, the foregoing metal plate for shield may be omitted on the antenna of display apparatus 2.

Where power transmission is implemented between the transfer apparatus and the display apparatus, electromagnetic induction can be utilized. However, the antenna, made by a coil for use on the PHS terminal and electronic shaver, generally has a power transmission efficiency of as lois nearly 20-30 percent. This is large in size because of using a coil increased in the number of turns wound over its ferrite core in order to increase its output voltage.

In this embodiment, organic material can be employed owing to power transmission and reception at a high frequency of 100 kHz or higher. Accordingly, this structure makes it possible to make transfer apparatus 1 and display apparatus 2 smaller in size, thickness and weight.

### Embodiment 13

Although the antenna mounted on the foregoing transfer apparatus 1 and display apparatus 2 is structured one in kind, it can be structured by a plurality of different kinds of antennas. FIG. 18 is a schematic view of an antenna in embodiment 13 of the invention, structured with two kinds of antennas on display apparatus 2. In FIG. 18, 2C is an IC having the circuit blocks shown in FIG. 11, 25S is an antenna for performing communication with transfer apparatus 1, and 25P is an antenna for supplying power from transfer apparatus 1. A power antenna 25P can be arranged around the display section in order to increase the screen area.

Here, those antennas can be structured by patterning a metal or organic material over a sheet and evaporating or applying it on the same layer as the display medium such as a microcapsule for use in the display section. Furthermore, in the storage battery, a sheer-formed capacitor can be arranged on the backside of the sheet. This structure can improve the power transmission efficiency on transfer apparatus 1 and display apparatus 2 and reduce the thickness of the apparatus.

### Embodiment 14

Display apparatus 2 can incorporate storage-battery remaining capacity detecting means. Furthermore, a remaining capacity detection result and status information as to connection status with the transfer apparatus can be displayed in a part of the display section of the electronic paper or in an exclusive display section provided separately.

This structure makes it possible to foresee the number of pages and speed of display rewrite and to grasp the communication status with the transfer apparatus, thus enabling to confirm the use position of the display apparatus and the usability thereof during carriage.

In the electronic paper, the operation is explained on the electrophoretic scheme to make a display under electric field. However, the display medium of display paper can be controlled in display under the electric field of a liquid crystal or the like. It naturally possible to use another scheme that display can be held without relying upon power.

The electronic paper display system of the invention can display information on a highly-portable display apparatus and, further, can manage display information, display apparatus and electronic paper. Therefore, this can realize to reduce the useless output of paper and to manage the security of output information.

### Embodiment 15

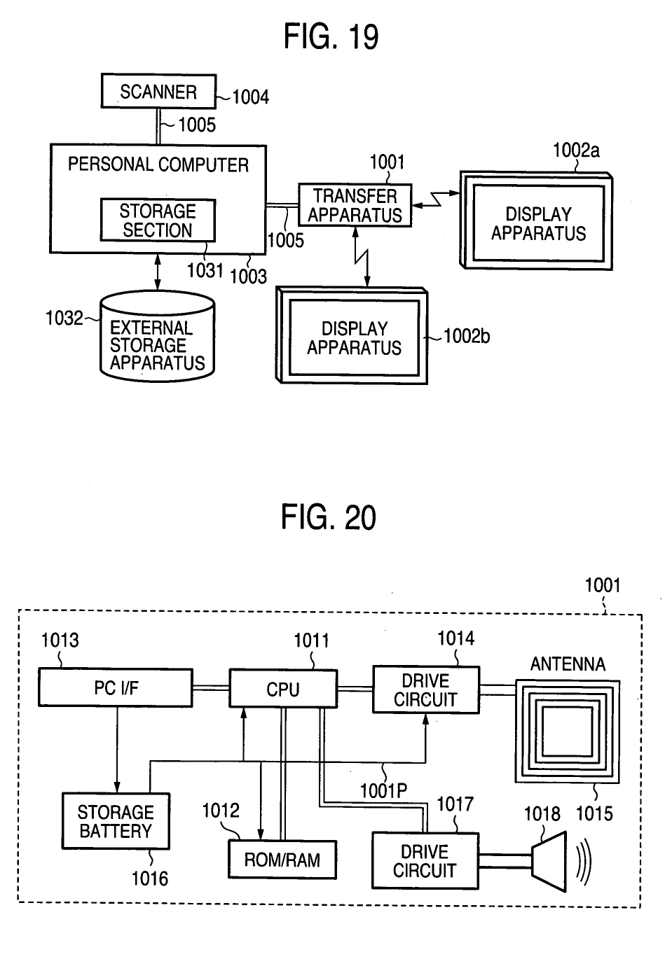

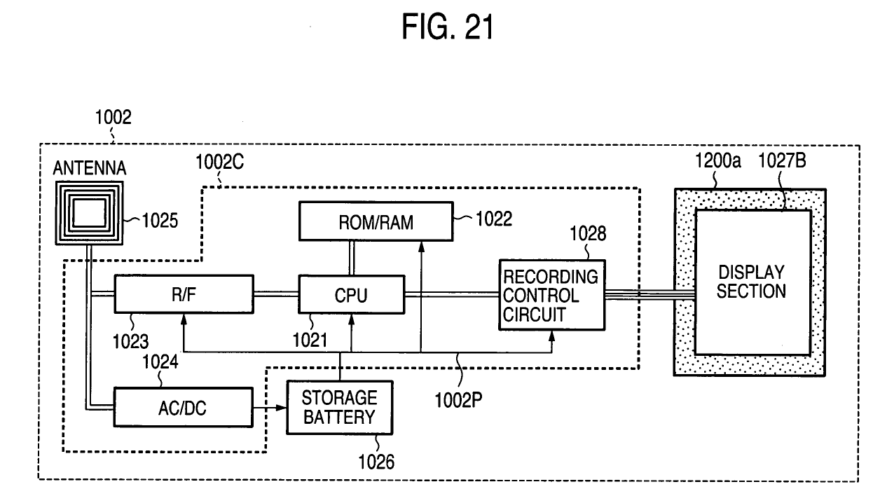

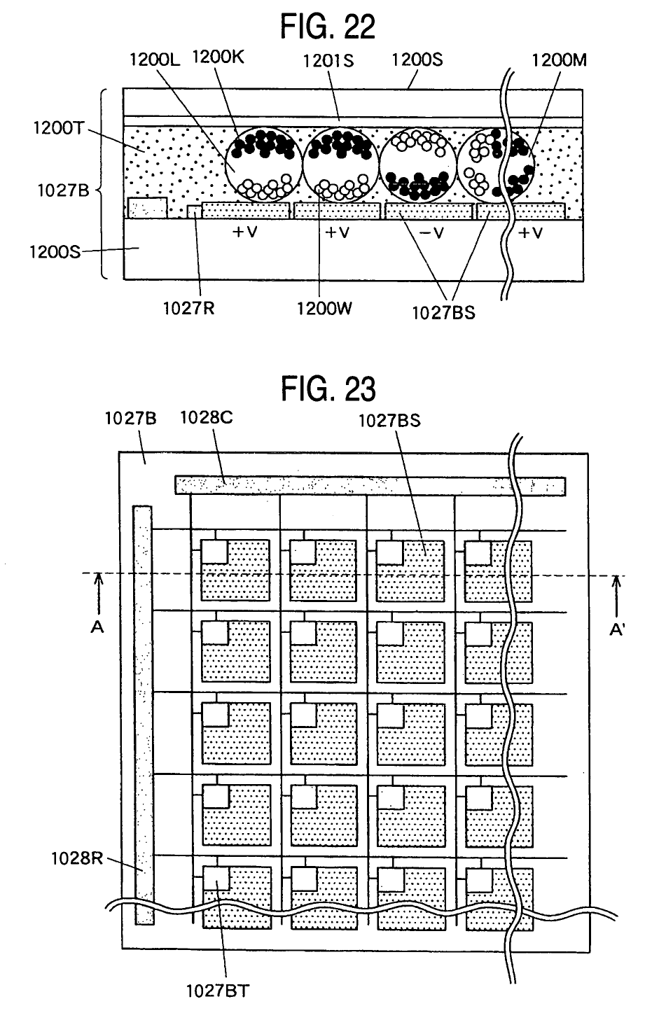

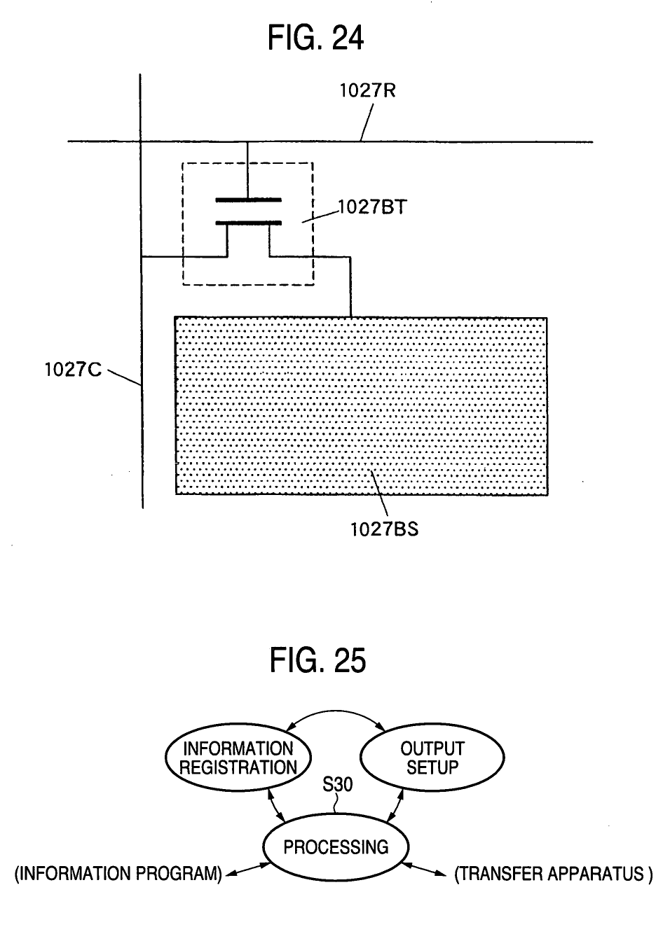

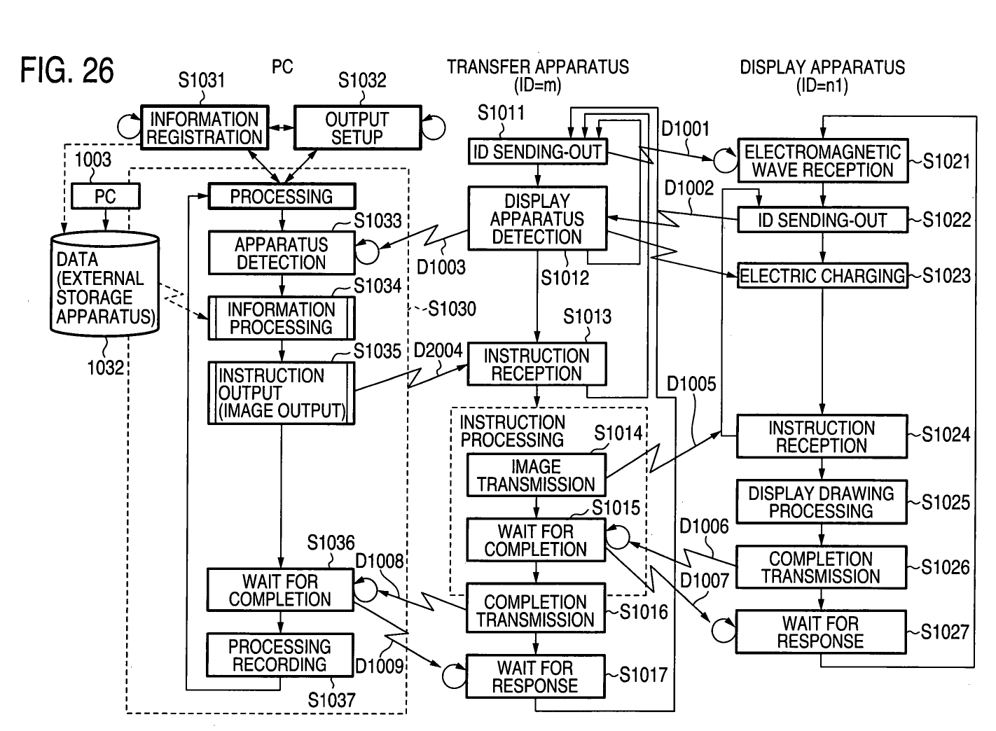

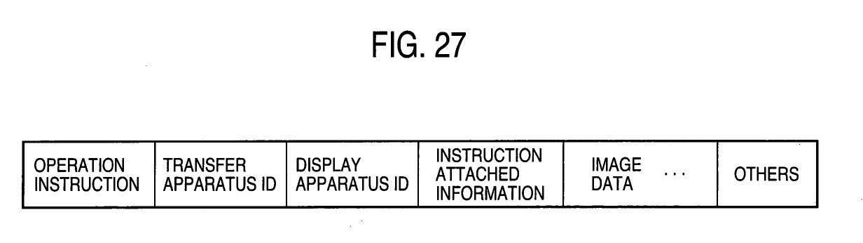

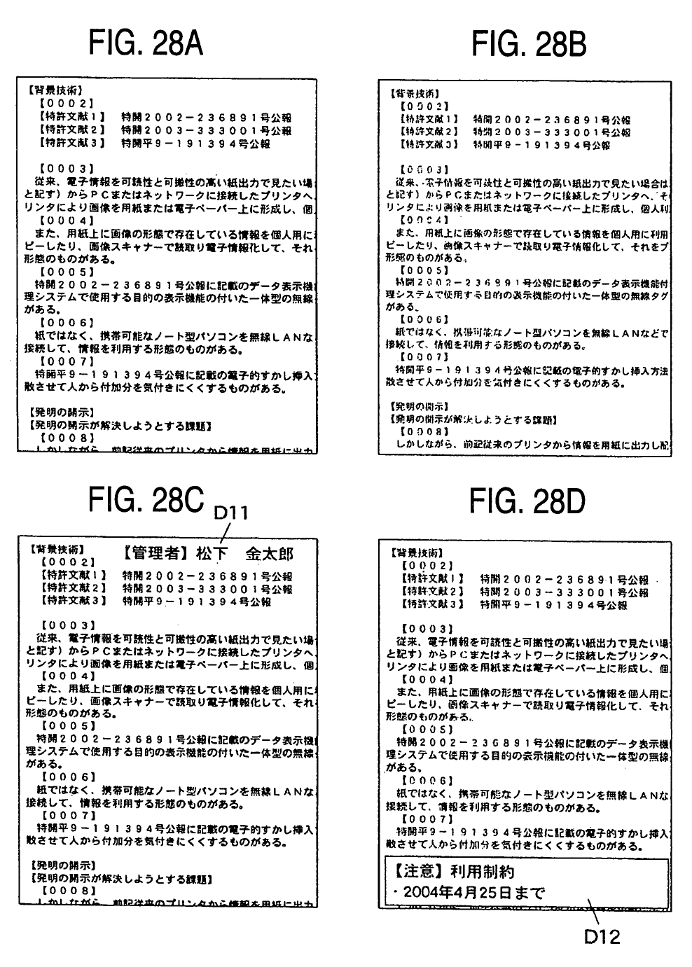

FIG. 19 is a block diagram which shows a basic configuration of an electronic paper system in an embodiment 15 of the invention, and FIG. 20 is a block diagram which shows a configuration of a transfer apparatus shown in FIG. 19, and FIG. 21 is a block diagram which shows a configuration of a display apparatus shown in FIG. 19, and FIG. 22 is a view which explains an electronic paper shown in FIG. 19, and FIG. 23 is a view which explains the electronic paper shown in FIG. 19, and FIG. 24 is a view which explains the electronic paper shown in FIG. 19, and FIG. 25 is a view which shows transition of statuses due to execution of an information program, and FIG. 26 is a flow chart which shows an processing operation of the electronic paper system shown in FIG. 19, and FIG. 27 is a view which shows one example of a format of information which is transmitted from a personal computer shown in FIG. 19, and FIG. 28 is a flow chart which shows an image deterioration processing operation.

In FIG. 19, an electronic paper system is equipped with a transfer apparatus 1001, a plurality of (two) display apparatuses 1002a, 1002b, a personal computer (hereinafter, referred to as PC) 1003 and a scanner (image reading apparatus) 1004.

Details of the transfer apparatus 1001 and the two display apparatuses 1002a, 1002b (these are collectively referred to as display apparatus 1002) will be described later.

PC (processing apparatus) 1003 is connected to the transfer apparatus 1001 and the scanner 1004 through a connection cable 1005. In addition, the transfer apparatus 1001, the display apparatus 1002a and the display apparatus 1002b are communication-connected wirelessly.

PC 1003 is equipped with a storage section 1031 which has a first storage area for storing an information program 1030 which is installed, and a second storage area for storing display information (e.g., document information) which will be described later, contents of information registration and an output setup which were set up by a user, which will be described later. In addition, to PC 1003, an external storage apparatus 1032, which stores all or a part of information stored in the second storage area of the storage section 1031 according to need, is locally connected.

The information program 1030 is of such a content that it carries out a huge variety of data processing and event operations, on the basis of information and processing procedures which were set up and registered in advance, and sends out image information and an operation instruction to an arbitrary transfer apparatus to have display to the display apparatus controlled and managed.

The scanner 1004 is equipped with image reading means which is realized by a publicly known technology, and wireless tag communication means which carries out communication with a wireless tag, and when an display image of an electronic paper with a wireless tag is read in, image data is read out by the image reading means, and tag information of the wireless tag is read out by the wireless tag communication means.

The suchlike electronic paper system is a thing which basically enabled to output information, which is prepared by PC 1003, to one or more display apparatuses, through the transfer apparatus 1001.

Meanwhile, in this embodiment 15, it is configured in such a manner that PC 1003, the scanner 1004 and the transfer apparatus 1001 are connected by the connection cable 1005, but it is also possible to connect them wirelessly, by use of means such as wireless LAN. In addition, it is configured in such a manner that the external storage apparatus 1032 is locally connected to PC 1003, but it is all right even if the external storage apparatus 1032 is not connected.

Next, a configuration of the above-described transfer apparatus 1001 will be described with reference to FIG. 20.

In FIG. 20, the transfer apparatus 1001 is equipped with CPU (Central Processing Unit) 1011, ROM or RAM as storage means (hereinafter, referred to as ROM/RAM) 1012, a personal computer interface circuit which plays a role of an interface with PC 1003 (hereinafter, referred to PC interface circuit) 1013, an antenna drive circuit 1014, an antenna 1015, a storage battery 1016, a buzzer drive circuit 1017, and a buzzer (warning means) which outputs a warning sound and an operation sound in accordance with driving of the buzzer drive circuit 1017. To the suchlike transfer apparatus 1001, specific identification information is given.

The transfer apparatus 1001 is connected to PC 1003 through the connection cable 1005 and the PC interface circuit 1013, for example, on the basis of the USB2.0 specification.

Therefore, since electric power is supplied to the transfer apparatus 1001 from the connection cable 1005 which is connected between it and PC 1003, this supplied electric power is stored in the storage battery 1016, and it is possible to drive each constituent element (each circuit block) on the basis of this electric power. Direct-current electric source power 1001P, which is outputted from the storage battery 1016, is supplied to each constituent element. On this account, a power supply circuit becomes unnecessary for the transfer apparatus 1001.

CPU 1011 controls an operation of the transfer apparatus 1001, by executing a program which is stored in ROM/RAM 1012.

For example, the antenna drive circuit 1014 is controlled in such a manner that individual data, which is sent from PC 1003, is received and obtained, and this obtained information and electric power are converted into electromagnetic waves, and these electromagnetic waves are transmitted to the display apparatus, and the display apparatus is detected on the basis of electromagnetic waves which are received through the antenna 1015.

The antenna (transmission means) 1015 transmits and receives signals wirelessly between it and the display apparatus 1002a or the display apparatus 1002b.

Meanwhile, in this embodiment 15, it is configured in such a manner that, in the transfer apparatus 1001, a power supply circuit is eliminated, but it is all right even if it is a configuration having an AC power supply circuit and a battery as power source means. In addition, it is all right even if the buzzer drive circuit 1017 and the buzzer 1018 are not mounted. Further, it is desirable that RAM 1012 is a thing which has such capacity that it is possible to store display data of one or a plurality of display screens, and further, it is desirable that it is a thing in which there occurs almost no electric power consumption and which can additionally keep up a data content for a long stretch of time.

Further, it is all right even if it is configured in such a manner that the transfer apparatus 1001 is connected to PC 1003 through a communication line, i.e., a wireless communication line or a wired communication line (network). In this case, there is need to be equipped with interface means (communication means) which enables wireless communication, or interface means (communication means) which enables wired communication.

Next, a configuration of the display apparatus 1002 will be described with reference to FIG. 21.

In FIG. 21, the display apparatus 1002 is a thing which is configured in such a manner that writing to an electronic paper 1200a is enabled by a surface, and is equipped with CPU 1021 for controlling an operation of the display apparatus 1002, ROM and RAM (hereinafter, referred to as ROM/RAM) 1022 which are a storage apparatus for holding/recording a control program and data, a RF conversion circuit 1023 for extracting signals from electromagnetic waves with wireless frequency which were received by an antenna 1025, an AC/DC conversion circuit (conversion means) 1024 for extracting electric energy from electromagnetic waves received by the antenna 1025 to convert it into direct-current power source power, an transmission/reception antenna (reception means) 1025 for communicating with the transfer apparatus 1001 by electromagnetic waves, a storage batter (storage means) 1026 for storing direct-current power source power which is generated in the AC/DC conversion circuit 1024, an electronic paper section 1200a, a display section 1027B, and a recording control circuit 1028.

Electric power 1002P, which is supplied from the storage battery 1026, is used for a recording operation to the electronic paper 1200a. Meanwhile, it is all right even if a control circuit for taking out a stable voltage is incorporated in the storage battery 1026.

It is all right even if this display apparatus is configured so as to be equipped with warning means such as a buzzer, which provides warning to a user. This warning means may be a thing which provides warning by displaying a warning message on the electronic paper 1200a.

In the meantime, a portion, which is surrounded by a broken line shown by a reference sign 1002C of FIG. 21, is of the same circuit configuration as a constituent element in case of realizing a wireless tag, and can be realized by an extremely small-size IC. ROM/RAM 1022 can have individual identification information (ID) as identification information.

Meanwhile, in this embodiment 15, a circuit in the portion shown by the reference sign 1002C (portion surrounded by the broken line) is of a configuration (circuit) for writing to an electronic paper, which consumes much larger electric power, as compared to a chip of a general wireless tag, and therefore, respective basis specifications of the antenna 1025, the AC/DC conversion circuit 1024 and the storage battery 1026 are significantly different from those in case of a general wireless tag. For example, the antenna 1025 receives effectively electromagnetic waves with frequency of 1 MHz. The AC/DC conversion circuit 1024 converts so as to increase a low AC voltage, which is obtained by converting electromagnetic waves received by the antenna 1025 into electric energy, to a DC voltage of 25V, That electric power is stored in a capacitor which is composed of an electric double layer capacitor, to utilize it as the storage battery 1026.

Next, a configuration of the electronic paper 1200a will be described with reference to FIGS. 22 through 24.

In this embodiment 15, as an electronic display apparatus, utilized is an electrophoresis or magnetophoresis type electronic paper in which two sheets, which face to each other through a predetermined gap and at least one of which transmits light, are disposed and an developer, in which one or plural kinds of electrified fine particles, which are different in optical reflection density and color, are contained, is filled up between these sheets, and by applying an electric field or a magnetic field to this developer, the electrified fine particles are moved in the sheet and optical reflection density and color are changed.

FIG. 22 is, if it is explained in more detail, a thing which showed a configuration of an electronic paper of an electrophoresis type which is a publicly known technology, as the electronic paper 1200a shown in FIG. 21, and shows a cross sectional view which shows an A-A′ cross section shown in FIG. 23.

In FIG. 22, a micro capsule 1200M has an electronic ink function, and a plurality of particles and stained suspension fluid are filled therein. The particles have different optical reflection characteristics and have contrastive electrophoretic polarities.

For example, in the micro capsule 1200M, suspension fluid 1200L, which is transparent suspension fluid, is filled, and in this suspension fluid 1200L, there exist particles 1200K which are of a black color and are electrically charged to + (plus) and particles 1200W which are of a white color and are electrically charged to − (minus).

Sheets 1200S have optical transparency for sandwiching the micro capsule 1200M. A binder 1200T is a non-conductive binder for bonding the micro capsule 1200M to the sheet 1200S. On an inner whole surface of the sheet 1200S on the side of a display surface, a transparent electrode 1201S is formed, and on an inside of the sheet 1200S on the side of a rear surface which is opposite to this, a plurality of pixel electrodes 1027BS are formed.

Meanwhile, in this embodiment 15, both surfaces of the electronic paper 1200a were configured by the transparent sheets 1200S, but a rear surface side may be configured by a non-transparent sheet, a metal sheet and an insulating film.

FIG. 23 is a view which shows a configuration of the display section 1027B. In FIG. 23, the display section 1027B is equipped with a pixel electrode 1027BS, a switching device 1027BT, a drive circuit 1028R for a lateral direction, and a drive circuit 1028C for a vertical direction. In the display section 1027B, a plurality of pixel electrodes 1027BS are disposed, depending on a plurality of pixels, and in each of these pixel electrodes 1027BS, the switching device 1027BT is disposed with respect to each pixel.

Here, a circuit, which drives an image, is shown in FIG. 24. As shown in FIG. 24, in the switching device 1027BT, its gate electrode is connected to a gate line 1027R which is a lateral direction wiring connected to the drive circuit 1028R, and in addition, its source electrode is connected to a source line 1027C which is a vertical direction wiring connected to the drive circuit 28C. In addition, the switching device 1027BT is configured so as to enable matrix-driving of the pixel electrode 1027BS which is connected to its drain electrode, individually.

Since an electric field is generated between the driven pixel electrode 1027BS and the transparent electrode 1201S which is opposite to this, movement of electrified particles (particles 1200K, particles 1200W) is carried out in the micro capsule 1200M which is located between these electrodes.

Meanwhile, in this embodiment 15, it is configured in such a manner that the drive circuit 1028R and the drive circuit 1028C were separated from the recording control circuit 1028, but it is also possible to realize such an integral type that the drive circuit 1028R and the drive circuit 1028C are incorporated in the circuit in the portion shown by the reference sign 1002C (portion surrounded by the broken line).

Further, in this embodiment 15, it is configured in such a manner that one switching device 1027BT is disposed on one pixel electrode 1027BS, but it is also all right even if it is realized by a configuration of active-matrix-driving by disposing a power supply line and a plurality of switching devices.

Further, in this embodiment 15, as the electronic display apparatus, the electrophoresis type electronic paper is used, but besides this, it is possible to utilize a display apparatus by use of publicly known technical means, e.g., a type of twisting ball, phase-stable liquid crystal, CN liquid crystal, toner display, electronic powder and granular material etc.

FIG. 25 shows, if it is described in more detail, a transition status of a basic operation of the information program 1030 which is installed in PC 1003. The information program 1030 is composed of operation blocks of “information registration”, “output setup”, and “processing”. Normally, the information program 1030 monitors occurrence of each event, and in case that an event occurred, its operation block is executed.

Meanwhile, “information registration” is comparable to a processing content of a step S1031 as a processing procedure which will be described later, and “output setup” is comparable to a processing content of a step S1032 as a processing procedure which will be described later, and “processing” is comparable to a processing content of a step S1030 as a processing procedure which will be described later.

Next, a processing operation of the electronic paper system will be described with reference to FIG. 26.

PC 1003 activates the information program 1030 on the basis of an activation instruction from a user, and executes this. As a result of this, a menu screen is displayed on a display apparatus (not shown in the figure) which is disposed on PC 1003, and therefore, a user sets down an information registration mode selectively from that menu screen. Then, since a screen for registering predetermined information is displayed, a user operates an input apparatus (not shown in the figure) of PC 1003 to that screen, to input and register predetermined information.

That is, to PC 1003, registered are display information such as images and characters which are desired to be displayed on the display apparatus 1002 and individual attribute information as to users, e.g., attribute information such as name and age, position in a company and authority, further, individual information for managing the display apparatus, e.g., password for security management, etc. (step S1031).

Here, the display information means information such as texts, figures, graphs and pictures prepared by application software, document information which is composed of these elements, or image information changed to data, which is a result of image reading by the scanner 1004. In addition, the user includes persons on the side of taking a look at information and persons on the side of managing/providing information.

There is such a form of use that one PC 1003 is utilized by a plurality of users. Then, in order to identify the plurality of users, by managing various personal information such as name and age, position in a company and authority, password for security management, it becomes possible to provide diversified conveniences.

Next, when a user completes registration of predetermined information and selects an output setup mode from the menu screen, a screen for registering predetermined information is displayed on a display apparatus (not shown in the figure) of PC 1003, and therefore, a user operates an input apparatus (not shown in the figure) of PC 1003 to that screen, and carries out various output setups as to information to be displayed (step S1032).

For example, information which is desired to be displayed, specification of a user, selection of a display apparatus specification of a transfer apparatus, image deterioration parameter at the time of copying, specification of the number of generations (the number of copies) of copying, a period during which display is carried out, etc. are set up arbitrarily. Information of these output setups is recorded and stored in the storage section 1031 in PC 1003 or in the external storage apparatus 1032 which is connected to PC 1003.

Here, it is possible to prepare the information which is desired to be displayed, by processing registered information, on the basis of personal information of a user who possesses the display apparatus 1002 and a user which is validated by PC 1003, in accordance with a processing procedure which is prepared in advance. For example, various information processing and applications such as to display only a part of registration information, to combine a plurality of information, and to restrict a period during which display is possible, are possible.

In case that the above-described step S1031 and step S1032 were completed, PC 1003 is to execute an operation block of “processing” which is a basic operation of the above-described information program 1030 (step S1030).

In this step S1030, an operation of such a case that information of a material 1001 (not shown in the figure) which is registered as information is outputted to the display apparatus 1002a and the display apparatus 1002b through the transfer apparatus 1001 will be described.

Here, in this embodiment 1001, specific identification information of the transfer apparatus is set up to ID=m, and specific identification information of the display apparatus 1002a is set up to ID=n1, and specific identification information of the display apparatus 1002b is set up to ID=n2.

In addition, in the step S1032, it is assumed that a content of an output setup, which is set up by a user, is that “information of the material 1001, which is registered as information, is outputted to the display apparatus 1002a with identification information ID=n1 and the display apparatus 1002b with identification ID=n2, through the transfer apparatus 1001, after copy attribute of image quality deterioration rate 5% is given thereto”.

Now, when the transfer apparatus 1001 is connected to PC 1003 through the connection cable 1005 and power supply from PC 1003 is started, the transfer apparatus 1001 outputs information D1001 which includes its own identification information ID (ID=m), as electromagnetic waves of predetermined signals, from the antenna 1015 (step S1011), at regular intervals, and by receiving a response from the display apparatus which received this information D1, the display apparatus is detected (step S1012).

Meanwhile, the step S1011 which is combined processing of sending-out of the identification information ID and supply of electromagnetic waves, and the step S1012 which is processing of detection of the display apparatus are carried out successively and repeatedly.

Here, in case that a user approaches to the transfer apparatus 1001 over bringing the display apparatuses 1002a, 1002b with one, and the display apparatuses 1002a, 1002b are located within a distance wherein it is possible to receive electromagnetic waves which were transmitted from the transfer apparatus 1001, the display apparatuses 1002a, 1002b can receive the electromagnetic waves.

Then, when the display apparatuses 1002a, 1002b receive the electromagnetic waves through the antenna 1025 (step S1021), the display apparatus 2a transmits information D1002 which includes its own identification information ID (ID=n1) to the transfer apparatus 1001, and on one hand, the display apparatus 1002b transmits information D1002 which includes its own identification information ID (ID=n2) to the transfer apparatus 1001, respectively (step S1022).

The information D1002, which is transmitted respectively from the display apparatuses 1002a, 1002b in this manner, is inputted to the transfer apparatus 1001, and used for detection of the display apparatus by the transfer apparatus 1001 (step S1012).

Meanwhile, on the occasion of sending out the identification information ID from the display apparatuses 1002a, 1002b, in order to avoid collision of the identification information ID by sending-out at simultaneous timing, it is all right even if it is configured in such a manner that setup of sending-out timing of the identification information ID is carried out by use of random numbers in the display apparatuses 1002a, 1002b, at the time of reception of electromagnetic waves in the step S1021 as a trigger, and means for lowering probability of simultaneous outputting is provided.

Now, in the display apparatuses 1002a, 1002b which completed the step S1022, the AC/DC conversion circuit 1024 converts electromagnetic waves which is now being received through the antenna 1025 into direct-current power source power, and this is stored in the storage battery 1026 (step S1023). Next, in the display apparatuses 1002a, 1002b, they stand ready over executing the step S1022 and the step S1023 repeatedly, until they receive an instruction from the transfer apparatus 1001.

That is, the display apparatuses 1002a, 1002b stand ready over repeating operations of sending-out of their own identification information ID, and electric charging of electric power (energy charging) which is converted on the basis of electromagnetic waves which are now being received, until they receive an instruction from the transfer apparatus 1001.

In the meantime, in the transfer apparatus 1001, it transmits such information D1003 that its own identification information ID (ID=m) is included in any one identification information ID of the display apparatus 1002a and the display apparatus 1002b which is detected on the basis of the identification information ID in the step S1012, to PC 1003.

In PC 1003, it receives the information D1003 from the transfer apparatus 1001, and it detects that it is an apparatuses which is output-specified by a user (display apparatus) on the basis of identification information ID of the display apparatus 1002a or the display apparatus 1002b which is included in this received information D3 and individual information for which output setup is carried out in the above-described step S1032 (Step S1033). Here, it is assumed that, as the apparatus which is output-specified, the display apparatus 1002a is firstly detected, and the display apparatus 1002b is next detected.

Next, when PC 1003 recognized that a specified output condition is satisfied, it carries out information processing, on the basis of information of an output setup which is set up in the step S1032 (step S1034).

Here, a content of a thing, which is registered as an output setup and stored in the storage section 1031 of PC 1003, is of such meaning that a material 1001 is outputted to the display apparatus with identification information ID=n1 and the display apparatus 1002b with identification ID=n2, after copy attribute (image quality deterioration rate 5%) is given thereto.

On that account, PC 1003, which receives identification information ID of the display apparatus 1002a which is detected firstly, is to process so as to obtain image information with such a size that it can be displayed on the electronic paper 1200a of the display apparatus 1002a, on the basis of information of the material 1001 which is held in the storage section 1031 in PC1003 or in the external storage apparatus 1032 which is connected to PC 1003, in the step S1034.

PC 1003, which completed the suchlike processing, transmits an instruction of an image output as information D1004 to the transfer apparatus 1001 with identification information ID=m which detected the display apparatus 1002a with identification information ID=n1 (transfer apparatus 1001 with identification information ID=m which is included in the above-described information D1003) (step S1035), and after that, stands ready until it receives a matter showing instruction completion to the instruction of the image output from the transfer apparatus 1001 (step S1036).

This information D1004 is outputted as instruction information, and is configured by a format shown in FIG. 27. That is, the information D1004 (instruction information D1004) is composed of an operation instruction which is information for instructing an apparatuses operation (in this embodiment, image display), the transfer apparatus ID which shows an instruction destination (identification information which shows the transfer apparatus), the display apparatus ID which shows an output destination (identification information which shows the display apparatus), information with an attached instruction for setting up details regarding an operation instruction, and image data to be transferred (in this embodiment, an image of the material 1).

Meanwhile, in this embodiment, the instruction attached information includes, as an attached operation setup in an image display operation, instruction attached information such as image quality deterioration rate 5% and copy generation number limiting value as copy condition information, and executed display image quality deterioration rate.

Meanwhile, in case that a content of an output setup, which is stored in the step S1032, does not have any setup to be instructed, it goes to an event waiting state shown in FIG. 25.

When the transfer apparatus 1001 receives instruction information D1004 from PC 1003 (step S1013), it processes the instruction. That is, the transfer apparatus monitors (detects) and gets an understanding of whether the display apparatus 1002a with identification information ID=n1 is located within such a scope that the transfer apparatus 1001 can receive, and therefore, in case that it is within the scope, it carries out instruction processing.

Since the instruction here is an image output of the material 1 to the display apparatus 1002a with ID=n1, the transfer apparatus 1001 transmits image information of the material 1 and instruction attached information, as information D1005 from the antenna 1015, together with instruction information showing that it is an output to the display apparatus 1002a with ID=n1, which is included in the instruction information D received in the step S1013 (step S1014).

Then, the transfer apparatus 1001, which completed the step S1014, stands ready until it receives notification of instruction completion from the display apparatus 1002a which received the information D (step S1015).

Meanwhile, the transfer apparatus 1001, after it completed the step S1013 (after it received the instruction information D1004 from PC 1003), stands ready over repeating the steps S1011 through S1012, until it can detect this display apparatus 1002a, in case that it is not possible to detect the display apparatus 1002a which corresponds to display apparatus ID included in this instruction information D1004.

In the display apparatus 1002a which received the information D1005 from the transfer apparatus 1001 through the antenna 1025, when it recognizes that it is an image output instruction to itself, with reference to instruction information which shows that it is an output to the display apparatus 1002a with ID=n1, which is included in this information D1005, it stores image information of the material 1 which is included in this information D1005, in RAM 1022 (step S1024).

In the display apparatus 1002a, CPU 1021 executes display drawing processing of an image on the basis of received original image data (see, FIG. 28(a)) and instruction attached information of image quality deterioration rate 5% (step S1025), and writes an image after this processing is completed (after image deterioration processing) (see, FIG. 28(b)), on the electronic paper 1200a through the recording control circuit 1028.

Next, the display apparatus 1002a, in case that writing to the electronic paper 1200a as to received all information (in this embodiment, image information of the material 1) is completed in the step S1026, transmits a signal which shows instructed processing completion (instructed processing completion signal) D1006, to the transfer apparatus 1001, together with the instruction information (instruction information D1004) and identification information ID (ID=n1) of its own display apparatus (step S1026).

Then, in the display apparatus 1002a which transmitted the instructed processing completion signal D1006 to the transfer apparatus, it stands ready until it receives a signal which shows a response to instruction processing completion from the transfer apparatus 1001 which received this signal D1006 (step s1027), and in case that it receives the signal showing its response, it goes back to the above-described step S1021, and steps after this will be carried out.

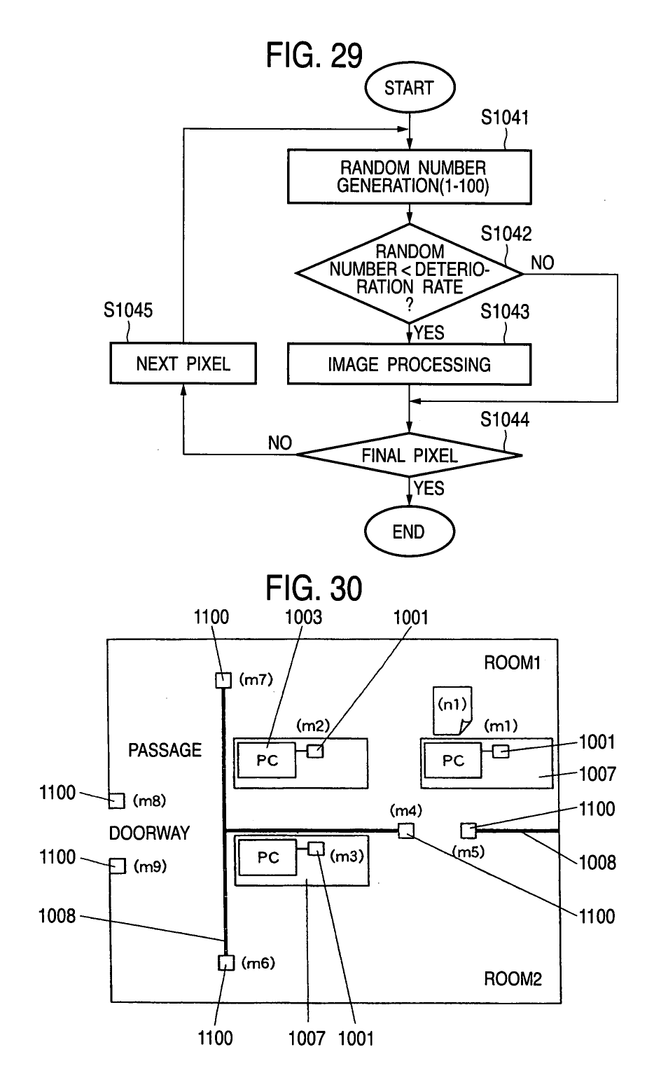

Here, image deterioration processing, which is included in display drawing processing of the step S1025 by the display apparatus 1002a, will be described with reference to FIG. 29.

In the display apparatus 1002a, CPU 1021 generates random numbers of 1 through 100 every time one pixel is obtained from original image data (see, FIG. 28(a)) as a display drawing processing object (step S1041), and after that, judges whether or not a value of the random number is a value of a deterioration ratio value or less (step S1042). In this embodiment, since an image quality deterioration rate is 5%, a value of a deterioration rate becomes 5.

CPU 1021, in case that it judged that a value of the random number is a deterioration rate value or less, as a result of comparing a value of the generated random number and a value of a deterioration rate=5, executes image processing as to the pixel (step S1043).

In this image processing, a pixel as an object is replaced with original image data as a pixel which shows black or a pixel which shows white, and thereby, noise is overlapped therewith, so that image deterioration processing is carried out. Meanwhile, overlapped noise is not decided on the basis of the random number, but may be decided on the basis of a fixed non-periodic pattern which corresponds to a deterioration rate.

In addition, as a noise overlapping method, as substitute for blackening or whitening of a pixel, processing called as information inversion of a pixel selected with specific probability (from a pixel showing white to a pixel showing black, or from a pixel showing black to a pixel showing white), or arithmetic processing of a pixel as an object and its peripheral pixels may be used. Meanwhile, it is desirable that information inversion processing of a pixel and arithmetic processing are carried out by a processing method which can be realized even by means of simple hardware.

In the meantime, in case that the step S1043 is finished, and in case that it is judged that a value of the random number is larger than a value of a deterioration rate in the step S1042, CPU 1021 judges whether or not a pixel, which became an object for processing in the step S1042 is a final pixel in the above-described original image data (step S1044), and in case that it judged that it is not the final pixel, it goes back to the above-described step S1041 in order to apply image deterioration processing as to a next pixel (step S1045), and carries out steps after this.

Meanwhile, in case that it is judged that it is the final pixel in the step S1044, this processing is finished.

Then, in the display apparatus 1002a, the recording control circuit 1028 image-draws image data after image deterioration processing is applied thereto by CPU 1021 (see, FIG. 28(b)), on the electronic paper 1200a. CPU 1021, which completed this image drawing (display drawing processing), rewrites an executed display image quality deterioration rate of instruction attached information which is stored in RAM 1022 in the display apparatus 1002a, from 0 to 5%.

This is to be the end of image quality deterioration processing. An explanation will be carried out with reference to FIG. 28 again. In the display apparatus 1002a which completed display drawing processing in this manner, it is to transmit the signal D1006 which shows instructed processing completion, to the transfer apparatus 1001 in the above-described step S1026, and therefore, in the transfer apparatus 1001, when it receives the instructed processing completion signal D1006 from the display apparatus 1002a through the antenna 1015 (step S1015), CPU 1011 transmits a response signal D1007 which shows a response to this instructed processing completion, from the antenna 1015 toward the display apparatus 1002a, through the antenna drive circuit 1014 (step S1015).

Next, in the transfer apparatus 1001, CPU 1011 sends out instruction completion information D1008 which shows instruction completion to an instruction based on instruction information D1004 received in the step S1013, through the PC interface circuit 1013, to PC 1003 (step S1016), and stands ready until it receives a response to this instruction completion (instruction completion information D1008) from PC 1003 (step S1017).

Then, the transfer apparatus 1001, in case that it receives the response to the instruction completion (instruction completion information D1008) from PC 1003, goes back to the step S1011, and is to carry out the same operation as a processing operation to the display apparatus 1002a.

In the meantime, PC 1003, which completed an image output (instruction output) in the step S1035, stands ready until it receives the instruction completion information D1008 from the transfer apparatus 1001, and therefore, in case that it received this instruction completion information D1008, transmits a response signal D1009 which shows a response to this instruction completion, to the transfer apparatus 1001 (step S1036), and after that, records such a matter that a part of specified processing is completed as a history, in the storage section in PC 1003 or in the external storage apparatus 1032 (step S1037). For example, log information such as a count number value of the number of copies, identification information which shows a display apparatus at a copy destination, and copying time is recorded.

PC 1003, which completed processing recording of a history in this manner, carries out remaining processing as unprocessed, of an image output of the material 1 to the display apparatus 1002b, through the transfer apparatus 1001, in the same manner as the above-described output operation to the display apparatus 1002a.

Next, in case that the display apparatus 1002a, which displayed (wrote) image information of the material 1 on the electronic paper 1200a, is moved from a current position (place) so as to copy display image of the display apparatus 1002a to a display apparatus 1002c, the following operation will be carried out.

That is, attached information of 5% deteriorated image data, an executed display image quality deterioration rate (5%), and an image quality deterioration rate (5%) which is set up when it is firstly outputted from an information source (information provider) is transferred from the display apparatus 1002a to PC 1003 through another transfer apparatus 1001 which is capable of wireless communication with the display apparatus 1002a. Further, the above-described each information is transmitted from PC 1003 to the display apparatus 1002c (not shown in the figure) through another transfer apparatus 1001 (regardless of whether or not it is a transfer apparatus which communicated wirelessly with the display apparatus 1002a).

In the display apparatus 1002c (not shown in the figure), image quality deterioration processing of 5% (see, FIG. 29) is applied to 5% image quality deteriorated image data which is received, and this image data, to which the image quality deterioration processing is applied, is displayed on the electronic paper 1200a. Here, an executed display image quality deterioration rate of instruction attached information in the display apparatus 1002c is rewritten from 5% to 10%. Meanwhile, an image quality deterioration rate remains as a value of 5% and is not changed.

In case of copying a display image of a predetermined display apparatus to another display apparatus in this manner, for example if it is copied, say, up to 20 generations, an image after image quality deterioration processing is applied becomes all black or all white, or one with a white-to-black ratio 50%, so that it is turned in a completely illegible state. By this means, it is possible to give the same advantage as that of analog copying.

Meanwhile, in this embodiment 15, if the transfer apparatus 1001 is changed to a sophisticated one by enlarging its CPU and memory capacity and mounting a processing program thereon, it is possible to carry out distribution of information from the display apparatus 1002a to the display apparatus 1002b through the transfer apparatus 1001, without interposition of PC 1003.

In addition, in this embodiment 15, instruction completion is notified after processing to an instruction is completed, in such a manner that, in the step S1026, the instruction completion information D1006 is transmitted to the transfer apparatus 1001 after processing of the step S1025 is completed, and also, in the step S1016, the instruction completion information D1008 is transmitted to PC 1003 after the instruction completion information D1006 is received from the display apparatus 1002a, but, in an intermediate step of processing to an instruction, it is also possible to transmit processing information in its process stage, from the display apparatus 1002a to the transfer apparatus 1001, further from the transfer apparatus 1001 to PC 1003, several times until processing to the instruction is completed.

Further, in this embodiment 15, as information processing, explained is an example of a case of processing from information of the material 1 to image information of such a size that it can be displayed on the electronic paper 1200a, but the invention is not limited to this, and it is possible to realize various conveniences such as efficiency/advertising effect due to calling for attention to a user/reconfirmation/summary of information, by having a display apparatus executed various information processing, such as by having a display apparatus processed only a part of the material 1001 from an attribute of a user as image information to be displayed, and by having it added another information to the material 1 to process as image information.

For example, in the display apparatus 1002, as shown in FIG. 28(c), copy user name information D1011 is added to original image data (see, FIG. 28(a)), and this image data can be displayed, and also, as shown in FIG. 28(d), image display restriction information D1012 as to a period and a place is added to the original image data (see, FIG. 28(a)), and this image can be displayed.

Further, in this embodiment 15, as an attached attribute regarding copying, an image quality deterioration rate is explained as an example, but the invention is not limited to this, and by giving an attribute of a simultaneous copying number and a total copying number to original information with no deterioration, it is possible to restrict a total copying number as to information with perfect image quality, and it becomes possible to carry out a restriction setup such as allowing only specific group members to make a copy.

Further, in this embodiment 15, as a display information copying restriction measure, it is configured in such a manner that display information (display image) is image-deteriorated every time the number of copying increases, by processing display information at a copy source on the basis of image quality information (image deterioration rate information) which is included in copy condition information, and finally, even if copying is carried out, a meaningless display image is obtained, so that copying is restricted, but the invention is not limited to this, and it is all right even if it is carried out as follow.

That is, in case of displaying display information at a copy source which is displayed on the display apparatus 1002a at the copy source, on the display apparatus 1002c at a copy destination, the display apparatus 1002a transmits display information at the copy source to PC 1003 through the transfer apparatus 1001. Next, PC 1003 transmits the display information at the copy source from the display apparatus 1002a, and instruction information including copy condition information which shows a condition regarding copying, to the display apparatus 1002c through the transfer apparatus 1001.

The display apparatus 1002c, in case that it received information from PC 1003, carries out addition or subtraction of a value which is set up in advance to a value which shows a copying number included in the copy condition information.

Then, the display apparatus 1002c, when a value of a copying number after this calculation is carried out is smaller than a threshold value which is set up in advance, displays the received display information on the electronic display apparatus 1200a, and on one hand, when the value of the copying number after this calculation is carried out reached to the threshold value which is set up in advance, does not display the received display information on the electronic display apparatus 1200a.

In case of carrying out copying restriction of display information by a copying number in this manner, image quality of a display image is not deteriorated, but in case that it reached to a predetermined copying number, display information is not displayed.

Further, in this embodiment 15, it is also possible to realize such a configuration that PC 1003 and the transfer apparatus 1001 are integrated. For example, it is all right if it is configured in such a manner that PC 1003 has a configuration and a function of the transfer apparatus 1001.

In this case, an electronic paper system can process in the same manner as in the above-described processing case. Here, explaining basis processing again, the display apparatus 1002 and PC 1003 carry out transmission/reception of information by wireless communication. PC 1003 outputs electromagnetic waves periodically toward the display apparatus 1002. This display apparatus 1002 transmits specific identification information which is given to itself in advance, to PC 1003.

PC 1003 decides display information and instruction information on the basis of specific identification information from the display apparatus 1002 and processing procedures which were set up in advance, and transmits these decided display information and instruction information to the display apparatus 1002.

Then, the display apparatus 1002 writes information on the electronic paper 1200a, on the basis of display information and instruction information from the processing apparatus.

Further, in this embodiment 15, it is also possible to realize such a configuration that PC 1003 and the scanner 1004 are integrated. For example, it is all right if it is configured in such a manner that PC 1003 has a configuration and a function of the scanner 1004.

Further, in this embodiment 15, it is configured in such a manner that the scanner 1004 is connected to PC 1003 by the connection cable 1005, but it is also possible to configure in such a manner that it is connected to PC 1003 through a network (communication line).

As described above, according to the embodiment 15, the transfer apparatus 1001 obtains solid object identification information of the display apparatuses 1002a,1002b by non-contact communication with the display apparatus 1002a and the display apparatus 1002b, and notifies this solid object identification information (specific identification information) to an information processing apparatus (computer), and on one hand, the information processing apparatus executes the information program 1030, and thereby, it is possible to carry out a huge variety of data processing on the basis of the above-described solid object identification information, and information which is setup/registered in advance and information which shows processing procedures, and it is possible to carry out control/management regarding display to a desired display apparatus, by transmitting image information and an operation instruction to an arbitrary transfer apparatus.

Therefore, by approximating the display apparatus to the transfer apparatus after an output setup is done, it is possible to display desired information on an arbitrary display apparatus, and therefore, it is possible to provide a printing solution environment which is impossible by a conventional technology.

In addition, according to the embodiment 15, since an electronic paper enables repetitive writing and erasing, it is possible to substantially reduce a paper resource which is wasted in the past, by a trial output of a prepared material etc.

Further, according to the embodiment 15, by giving attached information regarding copying to instruction information to a display apparatus from an information processing apparatus (computer), it is possible to deteriorate image quality by lowering contrast of image information gradually every time copying is carried out, by means of a simple method (image deterioration processing) on the side of a display apparatus, and it is possible to restrict a copying number, and therefore, it becomes possible to give a huge variety of restrictions, for the purpose of securing information security and copyright protection to a conduct of copying etc.

Further, according to the embodiment 15, even in case that a display apparatus is moved before copying is completed and it is turned into such a state that communication is impossible and processing is interrupted, it is possible to transfer only remaining copy information which has not yet been transmitted because of interruption of the above-described processing, when a display apparatus is again approximated to a transfer apparatus and it is turned into such a state that communication is possible, by managing progress information in midstream of processing, and it is possible to improve stability of an operation of a display apparatus (display operation).

### Embodiment 16

FIG. 30 is a conceptual diagram which shows a configuration of an electronic paper system of an embodiment 16 of the invention, and FIG. 31 is a block diagram which shows a configuration of a transfer apparatus shown in FIG. 30.

In FIG. 30, the electronic paper system is equipped with 3 units of transfer apparatuses 1001, 1006 units of transfer apparatuses 1100, and 3 units of PCs 1003.

As shown in FIG. 30, one room is partitioned by a wall 1008, and a passage, a room 1001 and room 1002 are formed. In the room 1001, two tables 1007 are placed, and in the room 1002, one table 1007 is placed. On each of these tables 1007, one PC 1003 and one transfer apparatus 1001 are mounted in such a state that they were connected by a connection cable 1005. In addition, on the wall 1008, four transfer apparatuses 1100 are placed, and at a doorway of the room, two transfer apparatuses 1100 are placed.

The transfer apparatus 1100 is a transfer apparatus which is of a different configuration from the transfer apparatus 1001 and has a function by which it can be connected to a network wirelessly.

The transfer apparatus 1001 and PC 1003 has the same configurations and functions as those of the transfer apparatus 1001 and PC 1003 of the embodiment 16. As a matter of course, in a plurality (3 units) of PCs 1003, an information program 1030 is installed. In this regard, however, one information program 1003 becomes a master which manages and controls an entirety, and other information programs 1030 are operated under its control, in cooperation with the information program 1030 which is specified (set up) as the master. These cooperation operations are carried out by an operation block S1030 for the purpose of “processing” shown in FIG. 25.

FIG. 31 shows a configuration of the transfer apparatus 1100, and this transfer apparatus 1100 is of such a configuration that, in the configuration of the transfer apparatus 1001 in the embodiment 15 shown in FIG. 30, the PC interface circuit 1013 and the storage battery 1016 are deleted, and a wireless communication interface circuit 1110, a communication antenna 1120 and a power supply circuit 1130 are added. Meanwhile, in FIG. 31, identical reference numerals and signs are given to portions which perform the same functions as those of constituent elements shown in FIG. 20.

The wireless communication interface circuit 1110 is an interface which corresponds to wireless communication such as Bluetooth and wireless LAN which are known technologies.

A plurality (6 units) of transfer apparatuses 1100 are in such a state that they are always connected to a network. Management of these transfer apparatuses 1100 is carried out by the information program 1030 which is specified (set up) as the master which can manage an entirety of an information processing system. In reality, it is carried out by control means such as CPU of the processing apparatus 1003 which executes this information program 1030.

On that account, in ROM/RAM 1012 which is a storage apparatus incorporated in each of the plurality of transfer apparatuses 1100, individual identification information ID is set up. On the basis of this identification information ID, the information program 1030 can identify the plurality of transfer apparatuses.

Meanwhile, it is also possible to configure the power supply circuit 1130 by means which does not utilize an AC power source, such as a dry battery and a solar battery.

In addition, users and apparatuses (transfer apparatuses, display apparatuses) and information for control and management of display information are processed by the plurality of PCs 1003 in a cooperated manner and managed uniformly.

In the above-described electronic paper system, communication with the display apparatus 1002 is carried out by the transfer apparatus 1001 in a non-contact manner, and the display apparatus 1002 is detected, and the information program 1030 is recognized on the basis of solid object identification information (specific identification information) of a display side, and thereby, the transfer apparatus 1001 obtains solid object identification information of the display apparatus 1002 by non-contact communication with the display apparatus 1002, and notifies this solid object identification information to PC 1003, and on one hand, PC 1003 executes the information program 1030, and thereby, it is possible to carry out location management of the display apparatus 1002 and warning to taking-out to a user and control and management of its display information, on the basis of the above-described solid object identification information, and information which is set up/registered in advance and information which shows processing procedures.

For example, it is possible to display copy information, through a transfer apparatus which is placed at another place, on a display apparatus which is placed in the vicinity of the same. In addition, a copy instruction is given in advance to a transfer apparatus which is placed at a conference room, and at such a time point that a display apparatus, which is brought in with an attendant, is held up on the transfer apparatus, it is possible to draw information on that display apparatus.

Further, in case that a display apparatus, which should be used in a specified area, is taken out to an outside of that area, an instruction for erasing information is sent to this display apparatus, and thereby, it is possible to erase an image. In addition, it becomes possible to emit a warning sound from the transfer apparatus 1001 and PC 1003 on site, to warning proceeding which is set up in advance such as taking-out from a specified area and a case wherein a display apparatus is moved from a detection available area, and to automatically erase display information after time, which is specified in the display apparatus 1002, passed over, and to update information.

Therefore, it is possible to establish a wide utilization environment in which it is possible to use an electronic paper and management of its display information by an electronic paper system in an organized way.

### Embodiment 17

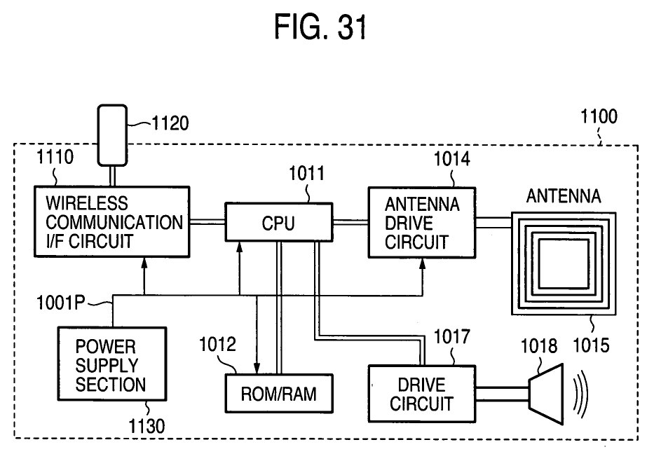

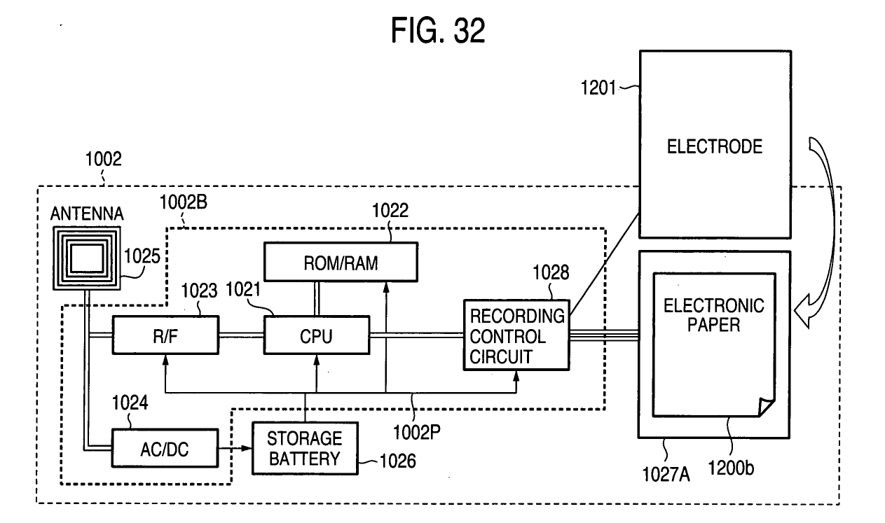

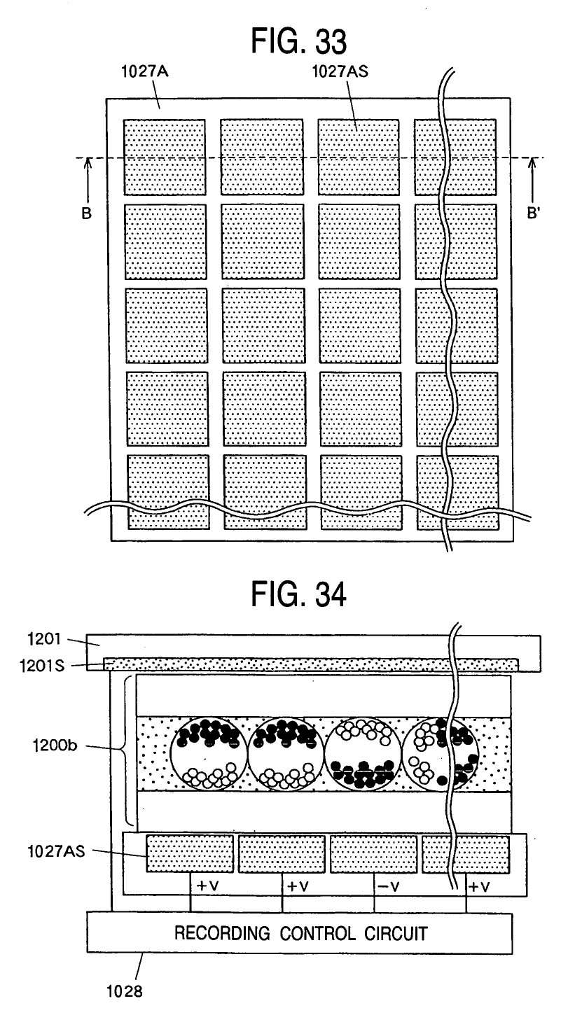

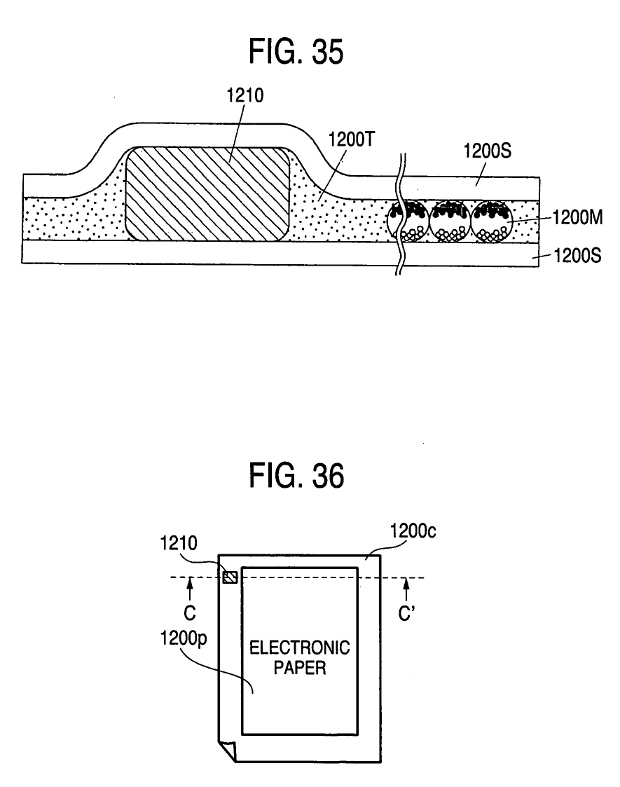

FIG. 32 is a block diagram which shows a configuration of a display apparatus in an electronic paper system in an embodiment 17 of the invention, and FIG. 33 is a view which explains a recording surface of the display apparatus shown in FIG. 32, and FIG. 34 is a view which explains a writing operation to an electronic paper which is used for the display apparatus shown in FIG. 32, and FIG. 35 is a view which explains the electronic paper, and FIG. 36 is a view which explains the electronic paper.

A display apparatus 1002 shown in FIG. 32 is of such a configuration that, in the configuration of the display apparatus 1002 of the embodiment 15 shown in FIG. 21, the display section 1027B and the electronic paper 1200a were deleted, and a recording surface 1027A, an electronic paper 1200b and an electrode sheet 1201 were added. In FIG. 32, identical reference numerals and signs are given to portions which perform the same functions as those of constituent elements shown in FIG. 31.

Meanwhile, a portion, which is surrounded by a broken line shown by a reference sign 1002B of FIG. 32, is a circuit other than a display section, and can be realized as IC by use of one chip.

In this embodiment 16, the display apparatus 1002 is configured in such a manner that surface recording is available by sandwiching two surfaces of the electronic paper 1200b. In other words, the electronic paper 1200b is not one which is fixed to the display apparatus 1002, but an independent one which is detachable from the display apparatus 1002.

Meanwhile, the display apparatus 1002 is configured by the detachable electronic paper 1200b and constituent elements other than this, i.e., an antenna 1025, a storage battery 10026, and a apparatus main body which is configured by a portion which is surrounded by a broken line shown by reference sign 1002B.

In FIG. 32, as to the recording surface 1027A, on its top surface (a surface which is in contact with the electronic paper 1200b), as shown in FIG. 33, a plurality of pixel electrodes 1027AS are placed, and the plurality of these electrodes 1027AS are connected to a recording control circuit (control means) 1028 by wiring (not shown in the figure).

An electrode 1201S is placed on a surface of the electrode sheet 1201 on the side which is in contact with the electronic paper 1200b. This electrode sheet 1201 is a sheet on a whole surface of which a transparent electrode is placed and which has optical transparency, and can be rotated around one side thereof as a supporting point (center).

In the suchlike display apparatus 1002, it is to be utilized in such a state that the electronic paper 1200b is placed on the recording surface 1027A and sandwiched by the electrode sheet 1201. That is, as shown in FIG. 34, in such a state that the electronic paper 1200b is placed on the recording surface 1027A and sandwiched by the electrode sheets 1201, an arbitrary voltage is applied between this electrode 1201S and the plurality of pixel electrodes 1027AS, and thereby, an electric field is generated, so that writing to the electronic paper 1200b is carried out. Meanwhile, FIG. 34 shows a cross sectional view of a B-B′ cross section.

Next, as an application example of the electronic paper 1200b, an electronic paper 1200c will be described with reference to FIG. 35 and FIG. 36.

As to the electronic paper 1200c, as shown in FIG. 35, on an outside of a display area 1200p which includes micro capsules 1200M (see, FIG. 36), a wireless tag 1210 is bonded by a binder 1200T and sandwiched by the sheet 1200S, in the same manner as the micro capsule 1200M. Meanwhile, FIG. 35, if it is described in more detail, shows a cross sectional view of a C-C′ cross section of FIG. 36.

The wireless tag 1210, which is known as RFID, is configured by a circuit block having the same functions as those of CPU 1021, ROM/RAM 1022, RF conversion circuit 1023, AC/DC conversion circuit 1024, antenna 1025, storage battery 1026 shown in the display apparatus 1002 of FIG. 32, and a small-size one with a size of a sesame grain level is put to practical use.

This wireless tag 1210 can be configured so as to carry out wireless communication directly with the transfer apparatus 1001, or carry out wireless communication with the display apparatus 1002, or carry out wireless communication with a tag reader (not shown in the figure) which is incorporated in the scanner.

Writing to the electronic paper 1200c is carried out in the same manner as in case of writing to the electronic paper 1200b shown in FIG. 34.

Meanwhile, in this embodiment 17, it is configured in such a manner that one wireless tag is mounted on the electronic paper 1200c, but the invention is not limited to this, it is all right even if a plurality of wireless tags and wireless tags with a plurality of types which correspond to different wireless frequencies are mounted thereon. In this case, it is possible to improve simultaneous detection ability of plural electronic papers.

In addition, in this embodiment 17, it is configured in such a manner that the wireless tag 1210, which is configured by a semiconductor chip, is incorporated in the electronic paper 1200c, but the invention is not limited to this, and it is all right even if a circuit pattern by use of an organic semiconductor (circuit pattern which has a function of the wireless tag 1210) is formed as a pattern on the sheet 1200S. In this case, an electronic paper with a uniform thickness becomes possible.

Further, it is all right even if a plurality of wireless tags and wireless tags with a plurality of types which correspond to different wireless frequencies are formed by forming a circuit pattern by use of an organic semiconductor on the sheet 1200S as a pattern. In this case, it is possible to improve simultaneous detection ability of plural electronic papers, and an electronic paper with a uniform thickness becomes possible.

According to the above-described electronic paper system, it is possible to take a look at information on the display apparatus 1002 in such a state that the electronic paper 1200c is sandwiched by the recording surface 1027A and the transparent electrode sheet 1201 and to carry on the display apparatus 1002, and therefore, it is possible to realize improvement of convenience in such a manner that it is possible to use it in such a state that the electronic paper 1200c is not curled up.

Similarly to this, such a form that a material is sandwiched in a clear file as a stationary to be carried on is generally utilized well, but in addition to this conventional convenience, it is possible to rewrite display on the electronic paper 1200c, and therefore, it is possible to reduce an amount of papers to be carried on. Further, it is possible to take out and take a look at the recorded electronic paper 1200c, and therefore, it is possible to mitigate feeling of fatigue of a user, as compared to a case of holding up the display apparatus 1002 and taking a look at it, since it is of lighter weight when a user holds up it.

Further, even in such a specification that the electronic paper 1200c is detachable from the display apparatus 1002, information management of the detached electronic paper 1200c becomes possible without a attaching/detaching mechanism which is mounted on the display apparatus 1002 for the purpose of monitoring.

Further, in case of reading the electronic paper 1200c by use of the scanner 1004, it is possible to simultaneously read tag information attached to the electronic paper 1200c, together with image data, and therefore, it is possible to carry out uniform management and copy restriction of information on the basis of this tag information, and continuity of the uniform management and copy restriction of information is maintained.

For example, by setting up an image quality deterioration rate to the wireless tag 1210 as tag information, image quality deterioration processing is applied to image data on the basis of the image quality deterioration rate, before the scanner 1004 scans the electronic paper 1200c and outputs the read image data to PC 1003, on the basis of the tag information (image quality deterioration rate) which is read out from the wireless tag 1210, and thereby, image quality is deteriorated as a copy number increases, so that it is possible to apply restriction to copy limitation.

In addition, for example, by setting up copy inhibition to the wireless tag 1210 as tag information, it becomes possible to realize such a matter that the scanner scans the electronic paper 1200c and reads out the tag information of the wireless tag 1210, and inhibits image reading on the basis of this tag information, and warning of copyright violation is outputted.

### Embodiment 18

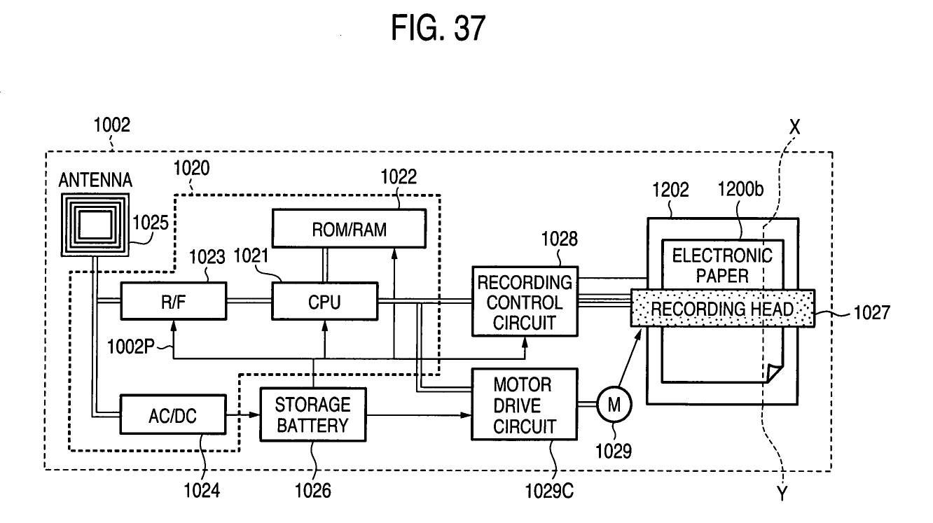

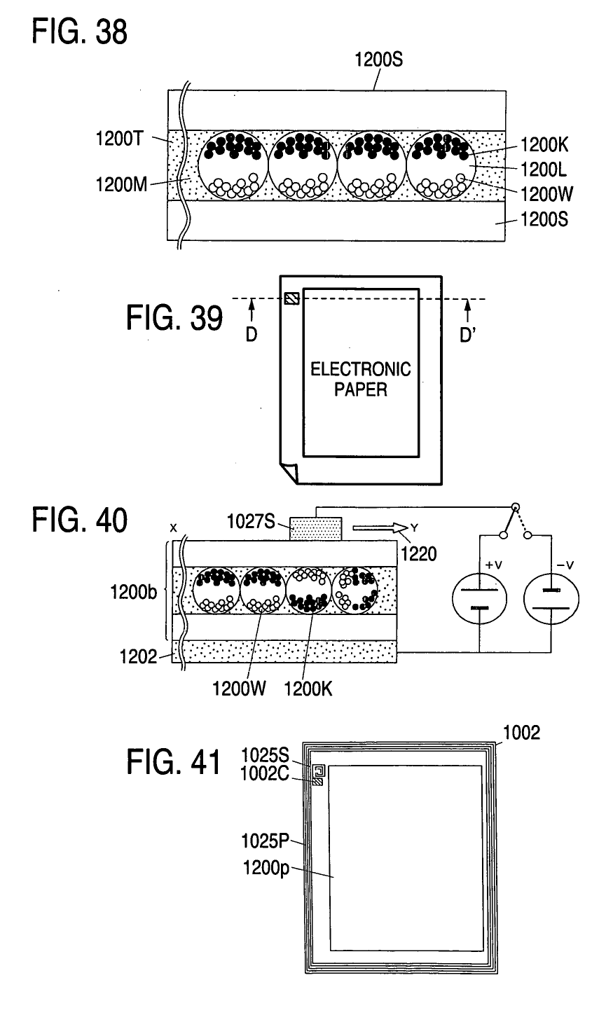

FIG. 37 is a block diagram which shows a configuration of a display apparatus of an electronic paper system in an embodiment 18 of the invention, and FIG. 38 is a view which explains an electronic paper, and FIG. 39 is a view which explains the electronic paper, and FIG. 40 is a view which explains writing to the electronic paper.

A display apparatus shown in FIG. 37 is of such a configuration that, in the configuration of the display apparatus 1002 of the embodiment 18 shown in FIG. 21, the display section 1027B and the electronic paper 1200a were deleted and a recording head 1027, a drive motor 1029, a motor drive circuit 1029C, an electronic paper 1200b and a common electrode 1202 were added. In FIG. 37, identical reference numerals and signs are given to portions which perform the same functions as constituent elements shown in FIG. 21.

In the above-described display apparatus 1002 of the embodiments 15 through 17, writing to the electronic paper 1200b is carried out by a surface, whereas the display apparatus 1002 of this embodiment 17 is configured so as to write to the electronic paper 1200b by a line (line unit).

Meanwhile, the display apparatus 1002 is configured by the detachable electronic paper 1200b and constituent elements other than this, i.e., an antenna 1025, a storage battery 1026, a recording control circuit (control means) 1028, a drive motor 1029, a motor drive circuit 1029C and a apparatus main body which is configured by a portion which is surrounded by a broken line shown by reference sign 1020.

In FIG. 37, the recording head 1027 is a line type recording head having a plurality of pixel electrodes for applying an electric field to the electronic paper 1200b in such a state that it is in contact with the electronic paper 1200b and sandwiched by it and the common electrode 1202.

The recording control circuit 1029 is a thing for applying a voltage to the pixel electrodes of the recording head 1027. The drive motor 1029 is a thing for moving the recording head 1027 by use of a conveying mechanism (not shown in the figure). The motor drive circuit 1029C is a thing for controlling an operation of the drive motor 1029.

The electronic paper 1200b is, as shown in FIG. 38, configured by micro capsules 1200M having electronic ink function, sheets 1200S with optical transparency for sandwiching them, and a non-conductive binder 1200T for bonding the micro capsules 1200M and the sheets 1200S. Meanwhile, FIG. 38, if it is described in more detail, shows a cross sectional view of a D-D′ cross section shown in FIG. 39.

An image writing operation to the electronic paper 1200b will be described with reference to FIG. 40.

As shown in FIG. 40, the recording control circuit 1029 switches a positive voltage (+V) and a negative voltage (−V), as a voltage which is applied between the pixel electrode 1027S and the common electrode 1202, and thereby, it is possible to carry out writing and erasing of information to and from the electronic paper 1200b. Here, it is assumed that the positive voltage (+V) is applied at the time of writing of information.

Now, when the positive voltage (+V), which is switched by the recording control circuit 1028, is applied to one pixel electrode 1027S of the recording head 1027 which is configured by laying out pixel electrodes in the shape of a line, electrified particles 1200K and electrified particles 1200W in the micro capsule 1200M are electrophoresed.

By this means, a display image is written on a portion which is opposite to a writing surface (lower side) of the recording head 1027 in the electronic paper 1200b, in the shape of a line.

When writing is completed in this manner, the recording head 1027 is moved in a direction of an arrow shown by a reference numeral 1220 in FIG. 40, to record a display image to a next line, and thereby, it is possible to write a display image on an entire surface of the electronic paper 1200b.

That is, by moving the recording head 1027 in a direction from a position of a reference sign X to a position of a reference sign Y, in FIG. 37 and FIG. 40, it is possible to write a display image on an entire surface of the electronic paper 1200b.

Meanwhile, in this embodiment 18, both surfaces of the electronic paper 1200b are formed by the transparent sheets 1200S, but the invention is not limited to this, and it is all right even if one side is a non-transmission sheet or a sheet on which metal is deposited. In addition, as the electronic paper, it is possible to utilize the electronic paper 1200b in which a wireless tag is incorporated (see, FIG. 35, FIG. 36).

In addition, in this embodiment 18, it is configured in such a manner that the recording head is moved by a conveying mechanism (not shown in the figure), but the invention is not limited to this, and it is also possible to move the electronic paper 1200b by a conveying mechanism (not shown in the figure), by fixing a position of the recording head 1027.

According to the above-described electronic paper system, in the display apparatus 1002, it is possible to manufacture a writing portion of an electronic paper inexpensively.

### Embodiment 19

In the display apparatus of the above-described embodiment 17 (see, FIG. 32) and the display apparatus 1002 of the embodiment 18 (see, FIG. 37), it is configured in such a manner that the electronic paper 1200b, which is an electronic display apparatus, is of a detachable structure from the display apparatus 1002 and only one piece (one sheet) is set, but it is possible to configure as follows.

That is, it is possible to realize such a configuration that it is possible to attach and detach a plurality of electronic papers individually. In addition, it is possible to configure in such a manner that it is possible to attach and detach a plurality of electronic papers with different sizes, individually. Further, it is possible to realize such a configuration that an electronic paper is fixed to the display apparatus 1002 so that it is not possible to attach and detach it, and to configure in such a manner that storage means, which stores predetermined information, is incorporated in the display apparatus 1002.

According to the suchlike electronic paper system, it is possible to display much more information (display information) on the display apparatus 1002 at one time, and it is possible to readily take along only necessary information. In addition, by configuring in such a manner that received display information and management information are stored in the storage means which is incorporated in the display apparatus 1002, it is possible to carry out writing and erasing of information and display management, only by use of the display apparatus 1002, and therefore, it becomes possible to independently display much more information.

### Embodiment 20

In the display apparatus 1002 of the above-described embodiment 18 (see, FIG. 38), it is configured in such a manner that the recording head 1027 is moved to the electric paper 1200b to carry out writing, but it is also possible to configure in such a manner that the recording head 1027 is fixed like a thermal printer, and the electronic paper 1200b is conveyed (moved).

According to the suchlike electronic paper system, it is possible to miniaturize the display apparatus 1002 more.

### Embodiment 21

It is also all right even if display means such as a liquid crystal display is disposed on the transfer apparatus of the above-described embodiment 15 (see, FIG. 20) and the transfer apparatus 1001 of the embodiment 16 (see, FIG. 31).

According to the suchlike electronic paper system, much more information provision and instructions become possible to warning, attention, etc. to users, by means of the transfer apparatus so that it is possible to substantially improve convenience.

### Embodiment 22

It is also possible to configure in such a manner that announcing means such as vibration and blinking of light which are acknowledged by users is disposed, in addition to the buzzer 1019, on the transfer apparatus of the above-described embodiment 15 (see, FIG. 20) and the transfer apparatus 1001 of the embodiment 16 (see, FIG. 31). In addition, it is also possible to provide warning by means of a warning sound through the use of a buzzer that PC 1003 has and warning display to a display screen, in a personal computer (PC 1003). Further, it is also possible to provide warning by writing to an electronic paper section through the use of a display apparatus.

According to the suchlike electronic paper system, it is possible to more improve recognition of a user with regard to information such as warning.

### Embodiment 23

In the display apparatus of the above-described embodiment 15 (see, FIG. 22), the display apparatus of the embodiment 17 (see, FIG. 32) and the display apparatus of the embodiment 18 (see, FIG. 37), a recording section, which carries out writing of information to an electronic paper, can be circuit-configured by an organic semiconductor.

In particular, it is desirable to use an organic series field effect transistor as the switching device 1027BT shown in FIG. 23.

For example, PEDOT (poly-ethylene dioxythiophene), which is conductive polymer, is drawn by means of an ink jet method, to form a source, a drain and a gate, and next, on the source and the drain, a semiconductor layer of conjugated type polymer, a film thickness of which is set to 30 nm or less, is formed by means of a spin coat method, and a high polymer insulating layer with film thickness 500 nm is formed thereon by means of a spin coat method, and further, a gate is formed thereon, and thereby, it is possible to realize TFT (thing film transistor) with a top gate structure.

According to the suchlike electronic paper system, it becomes possible to make the display apparatus 1002 or an electric paper thinner to save weight.

### Embodiment 24

It is possible to configure the antenna, which is mounted on the above-described transfer apparatus 1001, display apparatus 1002 and scanner 1004, by an organic material.

For example, the antenna is configured by a metal plate, a magnetic material and a conductor pattern. In order to prevent radiation of a unnecessary electromagnetic field from a surface which is opposite to a table in the transfer apparatus 1001 (surface on the side which is placed on the table), a metal sheet such as aluminum is used for one surface of an antenna section. On it, a magnetic material, or a hybrid material made by mixing an inorganic material such as a magnetic material and a dielectric material and a high polymer organic material, is laminated by press etc. Further on it, an antenna pattern is formed by an organic material with an extremely low resistance value and high conductivity is formed by an ink jet method, to manufacture a sheet-shaped antenna.

In this sheet-shaped antenna, an IC chip, in which a peripheral circuit is incorporated, is mounted thereon, so as to be in contact with an end portion of an antenna pattern, so that an apparatuses is configured.

Meanwhile, in the antenna of the display apparatus 1002, the above-described metal sheet for shield (metal plate) may be eliminated.

In case of carrying out electric power transmission between the transfer apparatus and the display apparatus in a non-contact manner, use of an organic material becomes possible by carrying out electric power transmission/reception through the use of high frequency of 100 kHz or more, so that it is possible to improve electric power transmission efficiency.

Meanwhile, in case of carrying out electric power transmission between the transfer apparatus and the display apparatus in a non-contact manner, it is possible to utilize electromagnetic induction, but generally, in an antenna by use of a coil which is used in a PHS terminal and an electric razor, its electric power transmission efficiency is as lois approximately 20 through 30%, and coils, the number of turns of which is increased for the purpose of heightening a voltage to be taken out, are wound around a ferrite core, and therefore, an antenna itself is enlarged.

According to the suchlike electronic paper system, it is possible to realize higher miniaturization/thin-shape of the transfer apparatus 1001 and the display apparatus 1002, so that it becomes possible to realize much more weight saving.

### Embodiment 25

FIG. 41 is a block diagram which shows a configuration of a display apparatus 1002 of an electronic paper system in an embodiment 25 of the invention.

The above-described antenna and wireless tag, which are mounted on the transfer apparatus 1001 and the display apparatus 1002, are configured by one type, but it is all right even if it is configured by a plurality of different antennas and wireless tags, in order to utilize different wireless systems.

FIG. 41 shows a conceptual diagram of such a configuration that two type antennas are formed on the display apparatus 1002. In FIG. 41, IC 1002C is IC which is comparable to the circuit block shown in FIG. 21 (portion which is surrounded by a broken line shown by the reference sign 1002C). An antenna 1025S is a thing for carrying out communication with the transfer apparatus 1001. An antenna 1025P is a thing for receiving electric power supply from the transfer apparatus 1001. The electric power antenna 1025P is placed at a periphery of a display section in order to enable realization of a large area.

Here, these antennas 1025S, 1025P can be configured in such a manner that a metal material or an organic material is formed on a sheet as a pattern and it is formed on the same layer as a display medium such as micro capsules etc. to be used in a display section, by deposition or painting. In addition, as to the storage battery, it is possible to dispose a sheet-shaped capacitor on a lower surface of a sheet.

Meanwhile, in the embodiment shown in FIG. 41, it is configured in such a manner that an antenna is placed at a peripheral portion of a display section, but in particular, in case that an electronic paper is of a system for thermally recording like a leuko paper, it is also possible to dispose an antenna on an entire rear surface of a sheet.

According to the suchlike electronic paper system, it becomes possible to improve electric power transmission efficiency of the transfer apparatus 1001 and the display apparatus 1002 and to make them thinner. In addition, it becomes possible to realize shortening of communication time.

### Embodiment 26

As to the above-described display apparatus 1002, it is all right even if remaining quantity detection means of a storage battery is mounted thereon. In addition, it is all right even if status information, such as a result of remaining quantity detection by the remaining quantity detection means, a communication connection state with the transfer apparatus and electric power receiving sensitivity, is displayed on a part of a display section of an electronic paper, or on a dedicated display section which is disposed separately.

According to the suchlike electronic paper system, it is possible to get hold of the number of pages for display rewriting and speed estimation, further a communication status with a transfer apparatus, in utilization of the display apparatus 1002, and it becomes possible to realize confirmation of a use position of a display apparatus and improvement of convenience at the time of taking along.

### Embodiment 27

As to the above-described scanner 1004, it is all right even if a function which is equivalent to the transfer apparatus, or a reader function of a wireless tag is mounted thereon, and further, such a function by which it is possible to process an image which is read out, and a function by which it is possible to connect to a network is provided thereon.

According to the suchlike electronic paper system, it is possible to process image information directly, by taking over restriction such as copy limitation from a tag, even if it is tried to optically read and copy an image which is recorded on a paper to which a wireless tag, in which restriction information such as copy limitation is stored as tag information, and a detachable electronic paper having the above-described wireless tag.

In addition, by such a matter that the scanner sends the read tag information to (an information program of) a personal computer, it becomes possible to realize cooperation of tag information and database information which is incorporated in the personal computer, and it becomes possible to significantly expand a scope of copyright preservation and security management. By this means, it is possible to establish a scheme which can correspond to various solutions.

Meanwhile, in the above-described electronic paper, an operation as to an electrophoresis method in which display is carried out by use of an electric field is described, but as a matter of course, as to a display medium of an electronic paper, it is possible to use another type which can control display by an electric field and can hold display without electric power, like a liquid crystal etc.

The invention can display information on a display apparatus of high portability, and can carry out management of an image input, management of images and information to be displayed, and management of a display apparatus or an electronic paper, and therefore, it is applicable to an apparatus or an information processing system which can easily carry out copying and distribution of information, and realize reduction of useless paper output and security management of output information which is impossible by papers.

### Embodiment 28

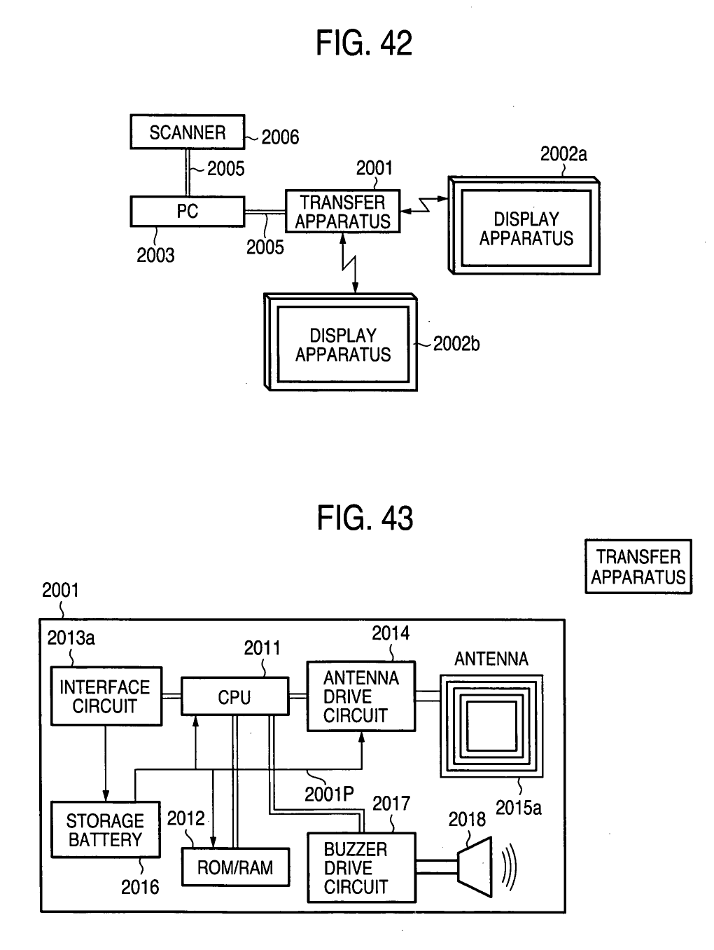

FIG. 42 is a block diagram of an electronic paper system in an embodiment 28 of the invention. In FIG. 42, an electronic paper system, which relates to this embodiment, is equipped with a transfer apparatus 2001, display apparatuses 2002a, 2002b, PC 2004 in which an information program 2003 is installed, a cable 2005, and an image reading apparatus (hereinafter, described as scanner.) 2006.

The transfer apparatus 2001 is connected to PC 2004 by the cable 2005 and the scanner 2006 is also connected to PC 2004 by the cable 2005. In addition, the transfer apparatus 2001 and the display apparatuses 2002a and 2002b are communication-connected wirelessly.

Meanwhile, in FIG. 42, PC 2004 and the scanner 2006, the transfer apparatus 2001 are connected by the cable 2005, but it is possible to connect they wirelessly, by means of means like wireless LAN.

This system is a thing which basically enables to have information, which is prepared in PC 2004, outputted to predetermined one or plural display apparatuses 2002 (2002a, 2002b) through the transfer apparatus 2001.

In the transfer apparatus 2001, disposed is means which can receive/extract individual data which is sent from PC 2004, and convert the obtained information and electric power into electromagnetic waves, and can output it through an antenna, and further, disposed is means which receives the electromagnetic waves from an antenna and detects the display apparatus. In addition, it is all right even if means, which can set up individual identification mark (hereinafter, described as ID), is incorporated therein.

The information program 2003 is a program for controlling and managing information on PC 2004, and in this information program 2003, a huge variety of data processing and event operation are carried out, by use of information of the display apparatuses 2002a, 2002b which is sent from the transfer apparatus 2001, and by preliminary set/registered information and processing procedures, and image information and an operation instruction are sent to an arbitrary transfer apparatus to control/manage display to the display apparatuses 2002a, 2002b.

In the display apparatuses 2002a,2002b, an electronic paper which is a rewritable electronic display apparatus which can keep display without power supply, an antenna which receives electromagnetic waves as seen in a configuration of a wireless tag, means for taking out and converting electric power from this electromagnetic wave, means for taking out information, and means for storing the generated electric power are disposed. Further, means for recording a display image on the electronic paper from the received information, and means for controlling these are incorporated therein.

As the electronic paper which is used for the display apparatus, utilized is such an electrophoresis or magnetophoresis type electronic paper in which two sheets, which face to each other through a predetermined gap and at least one of which transmits light, are disposed and an developer, in which one or plural kinds of electrified fine particles, which are different in optical reflection density and color, are contained, is filled up between these sheets, and by applying an electric field or a magnetic field to this developer, fine particles are moved in the sheet and optical reflection density and color are changed.

Besides this, it is possible to utilize a display apparatus by use of publicly known technical means, e.g., a type of twisting ball, phase-stable liquid crystal, CN liquid crystal, toner display, electronic powder and granular material etc.

The scanner 2006 is such a thing that communication means with a wireless tag is disposed in publicly known image reading means, and at the time of reading a display image of an electronic paper with a tag, tag information is read out together with image data.

Firstly, details of a basis system configuration shown in FIG. 42 will be described by FIG. 43 through FIG. 48.

FIG. 43 is an internal block diagram of the transfer apparatus in the embodiment 2001 of the invention, and it is equipped with CPU 2011, ROM(Read Only Memory)/RAM(Random Access Memory) 2012 which is storage means, an interface circuit 2013a with PC 2004, an antenna drive circuit 2014, an antenna 2015a, a storage battery 2016, a buzzer drive circuit 2017, and a buzzer 2018.

CPU 2011 controls an operation of the transfer apparatus 2001, by a program which is mounted on ROM and RAM 2012. The transfer apparatus 2001 is connected to PC 2004 by a PC interface circuit 2013a, through the use of, for example, USB2.0 specification cable. Therefore, the transfer apparatus 2001 doe not need a power supply circuit, and receives supply of electric power from the USB cable which is connected to PC, and stores this in the storage battery 2016, and can be driven by this electric power. 2001P is a direct-current power source power which is supplied to each circuit block and outputted from the storage battery 2016. It is possible to output a warning sound and an operation sound, by the buzzer drive circuit 2017 and the buzzer 2018.

Meanwhile, as this embodiment, it is configured in such a manner that the transfer apparatus 2001 does not need a power supply circuit, but it is all right even if it is a configuration having an AC power supply circuit and a battery as power source means. In addition, it is all right even if the buzzer drive circuit 2017 and the buzzer 2018 are not mounted. It is desirable that RAM of ROM/RAM 2012 is a non-volatile type one which has such capacity that it is possible to store display data of one or a plurality of display screens, and further, in which there occurs almost no electric power consumption and which can keep up a content for a long stretch of time.

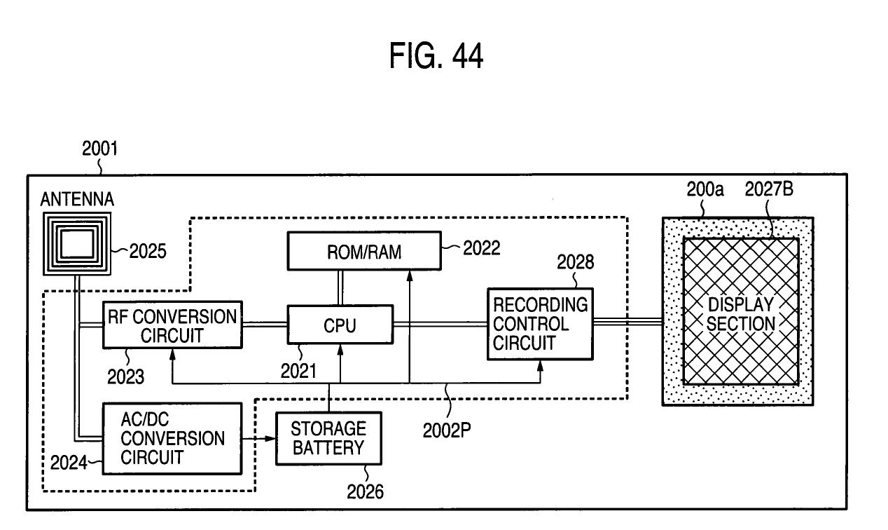

FIG. 44 is an internal block diagram of the display apparatus in the embodiment 28 of the invention, and it is a thing which is configured in such a manner that writing of an electronic paper section 2200a can be carried out by a surface.

In FIG. 44, the display apparatus 2002 is equipped with CPU 2021 for controlling an operation of the display apparatus 2002, ROM/RAM 2022 which are a storage apparatus for holding/recording a control program and data, a RF conversion circuit 2023 for extracting signals from electromagnetic waves with wireless frequency which were received by a transmission/reception antenna (hereinafter, simply referred to as antenna) 2025, an AC/DC conversion circuit 2024 for extracting electric energy from electromagnetic waves received by the antenna 2025 to convert it into direct-current power source power, an antenna 2025 for communicating with the transfer apparatus 2001 by electromagnetic waves, a storage batter 2026 for storing direct-current power source power which is generated in the AC/DC conversion circuit 2024, an electronic paper section 2200a, a display section 2027B, and a recording control circuit 2028.

Here, electric power of the storage battery 2026 is used for an recording operation to the electronic paper section 2200a.

A portion SCM, which is surrounded by a broken line in FIG. 44, is of the same configuration as constituent elements in case of realizing a wireless tag, and it can have an individual ID as an identification mark, and this circuit section can be realized by an extremely small size IC. In this regard, however, in this embodiment, since a circuit for writing to the electronic paper section 2200a which consumes far larger electric power as compared to a chip of a general wireless tag is mounted, basic specifications of the antenna 2025 which receives electric power, the AC/DC conversion circuit 2024 which converts its energy and the storage 2026 are different significantly. For example, even if electromagnetic waves with frequency of 1 MHz are effectively received to convert a low AC voltage which is taken out from the antenna 2025 into a DC voltage of 25V, its electric power may be stored in a capacitor which is composed of an electric double layer capacitor so as to be utilized as the storage battery 2026.

Meanwhile, it is all right even if a control circuit for taking out a stable voltage is incorporated in the storage battery 2026.

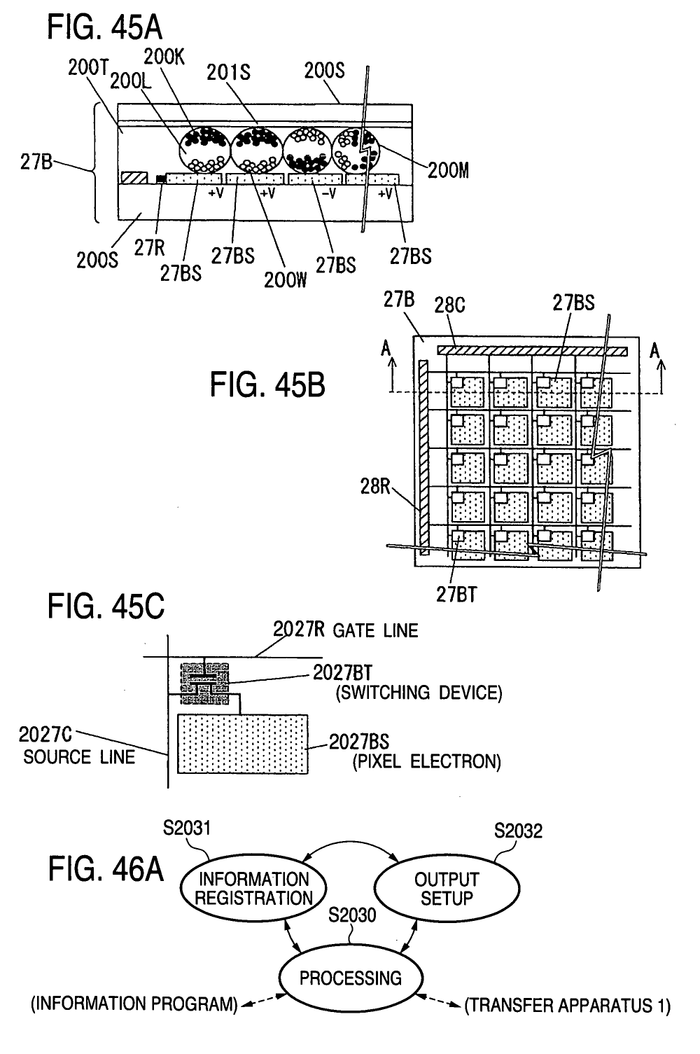

FIG. 45(a) is a cross sectional view of the electronic paper in the embodiment 28 of the invention, and (b) is a view which shows a cross section region of the electronic paper in the embodiment 28 of the invention, and (c) is a view which shows a pixel drive circuit of the electronic paper in the embodiment 28 of the invention, and FIG. 45(a) shows a cross section region A-A of FIG. 45(b).

In FIG. 45(a), 1200M designates a micro capsule having an electronic ink function, and 2200S designates an optically transparent sheet for sandwiching the micro capsule 2200M, and 2200T designates a non-conductive binder for bonding the micro capsule 2200M to the sheet 2200S. On an inner whole surface of the sheet 2200S on the side of a display surface, there is a transparent electrode 2201S, and on an inside of the sheet 2200S on the side of a rear surface which is opposite to this, a plurality of pixel electrodes 2127BS are formed.

Here, it is possible to configure in such a manner that the micro capsule 2200M is filled with a plurality of particles and dyed suspension fluid, and the particles have different optical reflection characteristics and further, have contrasting electrophoresis polarities, and for example, by utilizing particles 2200K which are of a black color and are electrically charged to + (plus) and particles 2200W which are of a white color and are electrically charged to − (minus), 2200L is filled with transparent suspension fluid.

Meanwhile, as this embodiment, both surfaces of the electronic paper 2200a were configured as the transparent sheets 2200S, but a rear surface side may be configured by a non-transparent sheet, a metal sheet and an insulating film.

In the display section 2027B of FIG. 45(b), 2027BS designates a pixel electrode, and 2027BT designates a switching device, and 2028R designates a lateral direction drive circuit, and 2028C designates a vertical direction drive circuit.

On the display section 2027B, a plurality of the pixel electrodes 2027BS are placed, and on each pixel electrode 2027BS, the switching device 2027BT is disposed with respect to each pixel. As shown in FIG. 45(c), a gate electrode and a source electrode of the switching device 2027BT are connected to a source line 2027C and a gate line 2027R which are connected to the drive circuits 2028R and 2028C and are lateral direction and vertical direction wirings, and can matrix-drive the pixel electrode 2027BS connected to a drain electrode of the switching device 2027BT, individually. Since an electric field is generated between the driven pixel electrode 2027BS and its transparent electrode 2201S, movement of electrified particles is carried out in the micro capsule 2200M which is located between them.

Meanwhile, in this embodiment, the drive circuits 2028R and 2028C are separated from the recording control circuit 2028, but it is possible to configure an integral type by incorporating them into the 2CM portion surrounded by a broken line.

Further, in this embodiment, one switching device 2027B is disposed on one pixel electrode 2027BS, but it is all right even if an active matrix drive configuration by disposing a power line and a plurality of switching devices thereon.

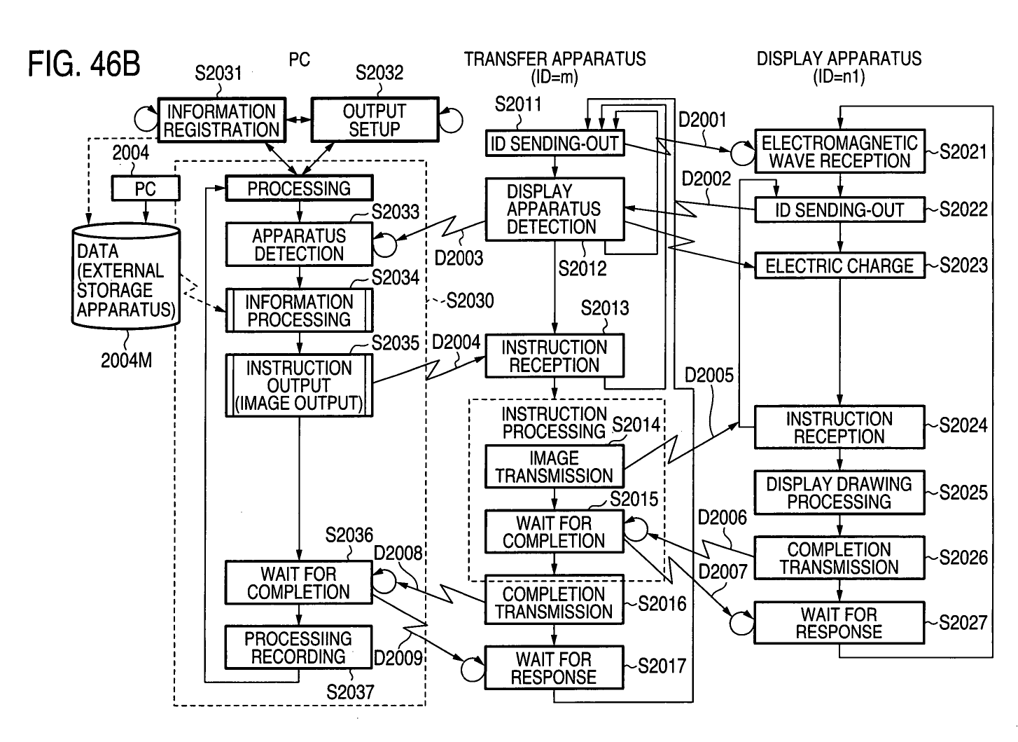

FIG. 46(a) is a transition diagram of the information program in the embodiment 28 of the invention, and is composed of operation blocks of information registration, output setup, and processing. Normally, the information program waits for occurrence of each event, and in case that an event occurred, its operation block is executed.

FIG. 46(b) is a flow chart which shows an operation outline in the embodiment 28 of the invention, and by this figure, hereinafter, an operation will be described in detail.

When a user enters into an information registration mode from a menu screen, which is not shown in the figure, of the information program 2003, it goes to an information registration step S2031, to register display information to be displayed on the display apparatus 2002 such as images and characters and individual attribute information as to users, and further, individual information for managing the display apparatus 2002, in PC 2004. Here, the display information means document information which is configured by image information formed as data by the scanner and texts, figures, graphs and pictures etc. prepared by application software. In addition, as to the user, there is also a form of use by a plurality of person such as persons on the side of taking a look at information and persons on the side of managing/providing information. Then, in order to identify and manage a plurality of users, various personal information such as name and position and authority in a company, age and password for security management is managed, and thereby, it becomes possible to provide diversified conveniences.

Next, in PC 2004, when a user enters into a mode of output setup from the menu screen, which is not shown in the figure, of the information program 2003, it goes to an output setup step S2032. In the output setup step S2032, as to information to be displayed, a user carries out various output setups. For example, information which is desired to be displayed, specification of a user, selection of a display apparatus, specification of a transfer apparatus, image deterioration parameter at the time of copying, specification of the number of generations of copying, a period during which display is carried out, etc. are set up arbitrarily. Information of these output setups is recorded and stored in PC 2004 or an external storage apparatus 2004M which is connected to PC 2004.

Here, it is possible to prepare the information which is desired to be displayed, by processing registered information, in accordance with personal information of a user who possesses the display apparatus 2002 and a user which is validated by PC 2003, by a processing procedure which is prepared in advance.

For example, various information processing and applications such as to display only a part of registration information, to combine a plurality of information, and to restrict a period during which display is possible, are possible.

Hereinafter, as to such an example that information of a material 1, which is registered as information and is not shown in the figure, is outputted to the two display apparatuses 2002a and 2002b of ID=n1 and ID=n2, through the transfer apparatus 2001 which is connected to PC 2004, after copy attribute of an image quality deterioration rate 5% is added thereto, its operation will be described.

The transfer apparatus 2001 is connected to PC 2004, and when a power supply is started, it outputs, in a step S11, information D2001 including individual ID as electromagnetic waves of predetermined signals, periodically, from the antenna 2015a. The step S2011 doubling as ID sending-out and electromagnetic wave supply, and display apparatus detection of the step S2012 are carried out successively and continuously. Here, in case that it is detected by received electric power in a step S2021 that a user approaches to the transfer apparatus 2001 over bringing the display apparatuses 2002a, 2002b with one, and is located within such a distance that it is possible to receive electromagnetic waves, the display apparatuses 2002a,2002b goes to a step S2022 by using energy of the electronic waves as electric power, and send out information D2002 including individual IDs that the display apparatus 2002a and 2002b have, to the transfer apparatus 2001. The transfer apparatus 2001 sends out such information D2003 that ID(m) of the transfer apparatus 2001 is included in individual ID of any one of the display apparatuses 2002a and 2002b, which is detected in the step S2012, to PC2004. The display apparatuses 2002a and 2002b, when they carry out ID sending-out, go to a step S2023, and receive electronic waves from the transfer apparatus 2001 and carry out energy charging to the storage battery 2026. Subsequently, they are waiting until they receive instruction from the transfer apparatus 2001 in a step S2024, over repeating the ID sending-out of the step S2022 and the charging operation of the step S2023.

Meanwhile, on the occasion of sending out the ID sending-out from the display apparatuses 2002a or 2002b, in order to avoid collision by sending-out at simultaneous timing, it is all right even if setup of ID sending-out timing by random numbers is carried out by using the reception of electromagnetic waves in the step S2021 as a trigger, and means for lowering probability of simultaneous outputting is provided.

When PC 2004 detects that, in a step S2033, detection of the display apparatus 2002a or 2002b and its ID information are sent from the transfer apparatus 2001, and it is an output specified apparatus, judging from individual information which is output set up in advance in the step S2032, and further, confirms that a specified output condition is satisfied, it goes to a step S2034, and carries out information processing in accordance with output setup information which is set u in the step S2032. Here, since such a setup that the material 1 is outputted to the display apparatus 2002a of ID=n1 and the display apparatus 2002b of ID=n2 after copy attribute (image quality deterioration rate 5%) is attached thereto is recorded in the output setup, PC 2004, which received firstly detected ID information of the display apparatus 2002a, processes it to image information with such a size that it can be displayed on the electronic paper, from information of the material 1 stored in PC 2004 or in the external storage apparatus 2004M of PC 2004, and goes to a step S2035. In the step S2035, an instruction of an image output is transmitted to the transfer apparatus 2001 of ID=m which detects the display apparatus 2002 of ID=n1, as information D2004.

The information D2004 is configured by an operation instruction (in this embodiment, image display) which is information for specifying an apparatus operation as instruction information, transfer apparatus ID and display apparatus ID for showing an instruction destination, image data to be transferred (in this embodiment, images of the material 1) and instruction attached information for setting up details regarding the operation instruction, etc., as shown in a block diagram of the information D2004 in the embodiment 28 of the invention. Meanwhile, the instruction attached information in this embodiment includes instruction attached information such as an image quality deterioration rate 5% and copy generation number limiting value, as an attached operation setup in an image display operation.

Meanwhile, in case that there is not any setup to be instructed in output setups which are recorded in the step S32, it is moved to an event waiting state shown in FIG. 46(a).

When the transfer apparatus 2001 receives instruction information D2004 from PC 2004 in the step S2013, it processes its instruction. Since the transfer apparatus 2001 detects and comprehends whether or not the display apparatus 2002a of ID=n1 is located within such a range that the transfer apparatus 2001 can receive it, in case that it is within the range, it goes to the step S2014 for instruction processing. In addition, in case that the specified display apparatus 2002a can not be detected, it stands ready over repeating the step S2011 through the step S2012, until it can be detected. Since an instruction here is an image output of the material 1 to the display apparatus 2002a of ID=n1, in the step S2014, image information of the material 1 and instruction attached information are transmitted from the antenna 2015a as information D1005, together with instruction information showing that it is an output to the display apparatus 2002a of ID=n1 in the step S2013.

In the display apparatus 2002a, when it is recognized that it is an image output instruction to itself in the step S2024, stores image information of the material 2001, which is being sent at the same time, in built-in ROM/RAM 2022.

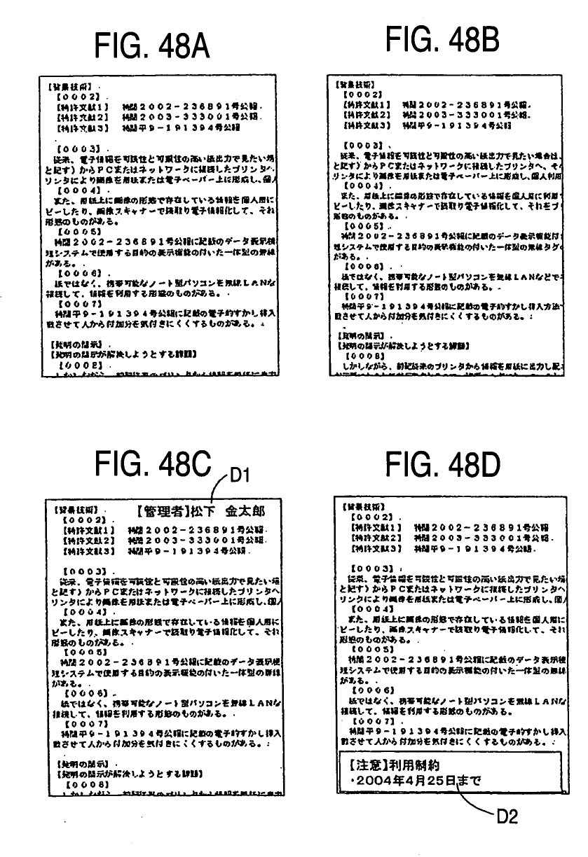

The display apparatus 2002a carries out display drawing processing of images on the basis of received image data (FIG. 48 (a) a view which shows original image data in the embodiment 28 of the invention) and instruction attached information of an image quality deterioration rate 5%, in the step S2025 (FIG. 48(b) a view which shows image data after image deterioration processing of original data in the embodiment of the invention), and writes the processed image in the electronic paper section 2200a. When writing of received all information is completed in the display drawing processing step, it goes to a step S2026, to transmit a signal D2006 of instruction processing completion together with instruction information and ID information, to the transfer apparatus 2001.

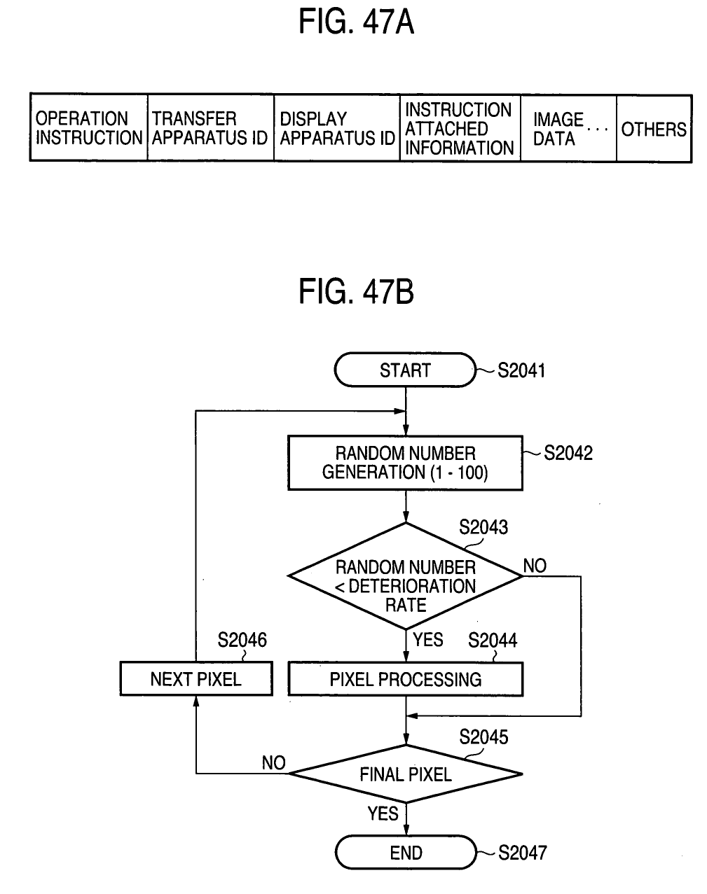

Here, FIG. 47(b) is a flow chart which shows image quality deterioration processing in the embodiment 28 of the invention, and image quality deterioration processing in this embodiment will be described by use of this figure.

In the display drawing processing, random numbers of 1 through 100 are generated every time one pixel is obtained from image data. Since an image quality deterioration rate is 5%, the random number, which is generated in the step S2043, is compared with “5”, and in case that the random number is the same or smaller, pixel processing is carried out in a step S2044. In case that it is larger, it is confirmed whether or not image data is a final pixel in a step S2045, and in case that it is not a final one, the same processing is repeated as to a next pixel in a step S2046. If it is the final pixel, processing is finished in a step S2047.

In the pixel processing of the step S2044. By being replaced with original image data as black or white, noise is overlapped therewith, so that image deterioration processing is carried out. Meanwhile, overlapped noise is not the random number, but may be a fixed non-periodic pattern which corresponds to a image quality deterioration rate.

In addition, as a noise overlapping method, as substitute for blackening or whitening of a pixel, processing called as information inversion of a pixel selected with specific probability (white→black, black→white), or arithmetic processing of a pixel as an object and its peripheral pixels may be used. Meanwhile, it is desirable that these processing are carried out by a processing method which can be realized even by means of simple hardware.

When image quality processed data is image-drawn on the electronic paper and completed, an executed display image quality deterioration rate of instruction attached information in the display apparatus 2002a is rewritten from 0 to 5%.

Returning to FIG. 5(b), the transfer apparatus 1, when it receives instruction completion from the display apparatus 2002a in the step S15, outputs a response signal D2007 from the antenna 15a, and goes to a step S2016. Further, it outputs instruction completion information D2008 to PC 2004 from the PC interface 2013a in a step S2016, and goes to a step S2017 for waiting for a response from PC 2004.

PC 2004, after it outputted an instruction in the step S2035, goes to a step S2036, and waits for instruction completion information D2008 from the transfer apparatus 2001, and when it confirms the instruction completion information D2008, transmits a response signal D2009 to the transfer apparatus 2001, and goes to a step S2037. In the step S2037, PC 2004 records such a matter that a part of specified processing is completed, as a history, in storage means in PC 2004, which is not shown in the figure, or in the external storage apparatus 2004M which is connected to PC 2004. For example, log information such as a count numerical value of the number of copies, ID of a display apparatus at a copy destination, and copying time is recorded.

Next, processing, which is called as an image output of the material 1 to the display apparatus 2002b and remained as not-executed, is carried out through the transfer apparatus 2001 in the same manner as the above-described output operation to the display apparatus 2002a.

The transfer apparatus 2001, when it receives and confirms the response signal D2009 from PC 2004 in the step S2017, goes back to the first step S2011, and repeats the same operation to the display apparatus 2002b.

Further, in case that the display apparatus 2002a is moved to make a copy of a display image of the display apparatus 2002a to the display apparatus 2002c this time, in a separate similar environment which is not shown in the figure, 5% deteriorated image data and attribute information of an executed display image quality deterioration rate (5%) and an image quality deterioration rate (5%) which is set up when it is firstly outputted from an information source (information provider) are transferred from the display apparatus 2002a to PC 2004 through another transfer apparatus 2001, and the above-described information is sent from PC 2004 to the display apparatus 2002c through another transfer apparatus 2001.

Meanwhile, in the transfer apparatus 2001, by enlarging CPU 2011 and memory capacity and mounting a processing program to change it to a high-performance one, it is also possible to carry out distribution of information to the display apparatus 2002b directly from the display 2002a through the transfer apparatus 2001, without interposition of PC 2004.

Further, in the above-described step S2026, step S2015 and step S2016, instruction completion information D2006 and D2008 were outputted, but it is also possible to transmit intermediate step processing information of an instruction, several times, until processing to PC 2004 is completed.

In the display apparatus 2002c, image quality deterioration processing of 5% is further applied on 5% deteriorated image data which is received, to be displayed. Here, an executed display image quality deterioration rate of instruction attached information in the display apparatus 2002c is rewritten from 5% to 10%. Meanwhile, an image quality deterioration rate is stored as 5% without change.

In this case, if it is copied, say, up to 20 generations, it becomes all black or all white, or one with a white-to-black ratio 50%, so that it is turned in a completely illegible state, and it is possible to give the same advantage as that of analog copying.

According to the electronic paper system by use of the suchlike configuration, by communicating with display apparatuses 2002a and 2002b through the use of the transfer apparatus 2001 in a non-contact manner, and detecting the display apparatus 2002a and 2002b, and having the information program 2003 recognized solid object identification information on the display side, it is possible to carry out a huge variety of data processing from preliminary set/registered information and processing procedures, on the basis of solid object identification information, and to send image information and an operation instruction to an arbitrary transfer apparatus, and to control/manage display on a desired display apparatus.

Therefore, after an output setup is completed, simply by approximating the display apparatus to the transfer apparatus, it is possible to display desired information on an arbitrary display apparatus, so that it is possible to provide a printing solution environment which does not exist in the past.

In addition, since an electronic paper enables repetitive writing and erasing, dit can be utilized for the purpose of reduction of a paper resource which is isted in the past, by a trial output of a prepared material etc.

Further, by giving attached information regarding copying, it is possible to deteriorate image quality by lowering contrast of image information gradually every time copying is carried out, by means of a simple method, and it is possible to restrict a copying number, and therefore, it becomes possible to give a huge variety of restrictions, as maintenance of information security and copyrights, even to a conduct of copying etc.

In addition, even in case that a display apparatus is moved before copying is completed and it is turned into such a state that communication is impossible and processing is interrupted, it is possible to transfer only remaining copy information, when a display apparatus is again approximated to a transfer apparatus and it is turned into such a state that communication is possible, by managing intermediate step information of processing, and stability improvement of an operation becomes possible.

Meanwhile, in an explanation of this embodiment, the case of processing from information of the material 1 to image information with such a size that it can be displayed on the electronic paper is described as information processing, but it is possible to realize various conveniences such as efficiency/advertising effect due to calling for attention to a user/reconfirmation/summary of information, by having a display apparatus executed a huge variety of information processing, such as by having it processed only a part of the material 1 from an attribute of a user, and by having it added another information to the material 1.

For example, as shown in FIG. 48(c) as a view which shows image data to which information of original image data is added in the embodiment 28 of the invention, it is possible to add name information D1 of a user of copying to an image.

In addition, as shown in FIG. 48(d) as a view which shows image data to which information of original image data is added in the embodiment 28 of the invention, it is also possible to add information D2002 of an image display restriction as to a period and a place to an image.

Further, as an attached attribute of copying, the example of an image quality deterioration rate is explained, but by giving an attribute such as a simultaneous copy number and a total copy number to original information in which there is no deterioration, as to information with perfect image quality, it is possible to restrict its total copy number, and it becomes possible to set up a restriction such as to allow only a specific group member to make a copy.

### Embodiment 29

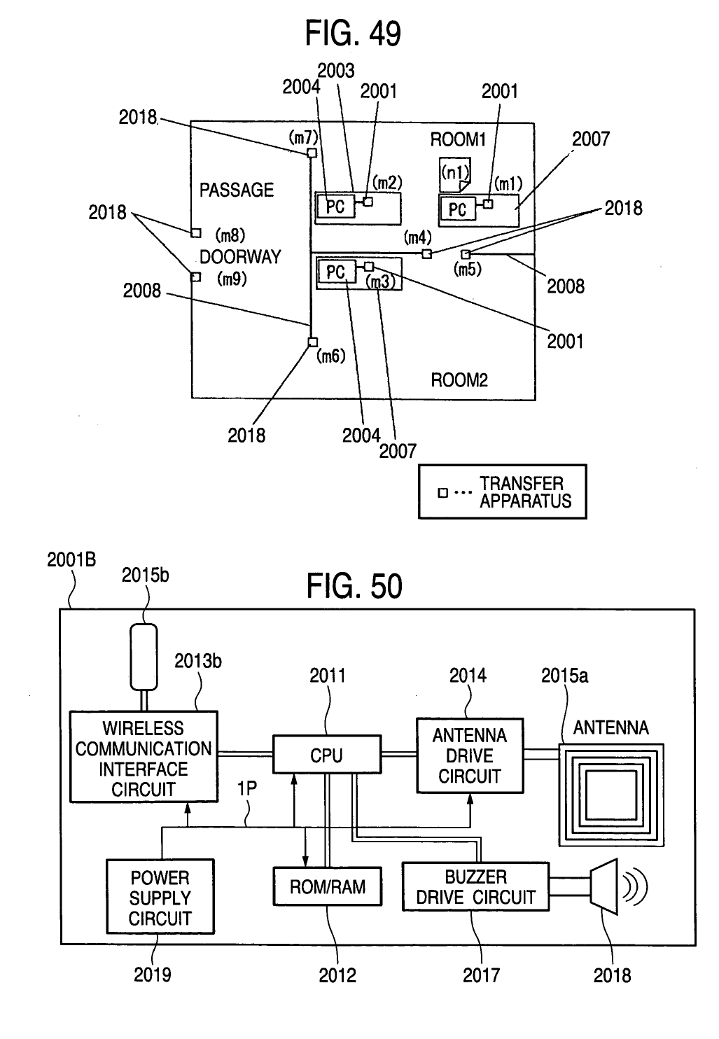

FIG. 49 is a block diagram of an electronic paper system in an embodiment 29 of the invention. In FIG. 49, the same reference numerals and signs are used as to the same constituent elements as those in FIG. 43 through FIG. 48, to omit explanations.

FIG. 49 shows a configuration of a complex system utilizing such an electronic paper system that a plurality of transfer apparatuses 2001 and PCs 2004 are placed in a room.

In FIG. 49, in this embodiment, a table 2007 for placing PC 2004 and the transfer apparatus 2001 thereon and a wall 2008 which partitions the room are provided, and a transfer apparatus 2001B with a connection apparatus, which has such a function that it can be connected to a network wirelessly, is disposed as another form of the transfer apparatus 2001, and thereby, an electronic paper system is configured.

In PC 2004 to which the transfer apparatus 2001 is connected, the information program 2003 is installed respectively.

In this regard, however, one information program 2003 becomes a master which manages and controls an entirety, and others are operated under its control, in cooperation with the information program 2003 which is set up as the master. These cooperation operations are carried out by an operation block S2030 for processing of FIG. 46(a).

FIG. 50 is a block diagram of the transfer apparatus in the embodiment 29 of the invention, and in FIG. 50, the same reference numerals and signs are used as to the same constituent elements as those of FIG. 43, to omit explanations. The transfer apparatus 2001B is of almost the same configuration as that of the transfer apparatus 2001, and a different point is that an interface circuit to communicate with PC is a wireless communication interface circuit 2013b which corresponds to wireless communication such as Bluetooth and wireless LAN which are known technologies, and an antenna 2015b and a power supply circuit 2019 for that purpose are provided.

The transfer apparatus 2001B is in such a state that it is always connected to a network, and management of them is carried out by the information program 2003 which is set up in the master which can manage an entire system.

On that account, in ROM/RAM 2012 which is a storage apparatus incorporated in the transfer apparatus 2001, individual ID information is set up. By this ID information, it becomes possible for the information problem 2003 to identify a plurality of transfer apparatuses.

Meanwhile, the power supply circuit 2019 can be also configured by means which does not utilize an AC power source, such as a dry batter and a solar battery.

According to the suchlike configuration, by communicating with display apparatus 2002 through the use of the transfer apparatus 2001 in a non-contact manner, and detecting the display apparatus 2002, and having the information program 2003 recognized it on the basis of solid object identification information on the display side, it is possible to carry out location management of the display apparatus 2002 and warning to taking-out to a user and control and management of its display information, in accordance with set/registered information and processing procedures.

For example, it is possible to display copy information, passing through a transfer apparatus which is present at another place, on a display apparatus which is disposed in its vicinity. In addition, at such a time point that a display apparatus, which is brought in with an attendant, is held up on the transfer apparatus, it is possible to draw information on that display apparatus.

Further, it is possible to realize such a matter that the display apparatus is taken out from a specified area, and an instruction for erasing information is sent to the display apparatus, and an image is erased. In addition, it becomes possible to realize such a matter that a warning sound is emitted from the transfer apparatus and PC on site, to warning proceeding which is set up in advance such as taking-out from a specified area and a case wherein a display apparatus is moved from a detection available area, and display information is automatically erased at time specified in the display apparatus, and information is updated.

Therefore, it is possible to establish a wide utilization environment in which it is possible to use an electronic paper and management of its display information by an electronic paper system in an organized way.

Meanwhile, although it is omitted and is not described, information for a user, an apparatus and control and management of display information is processed in cooperation with PC and managed uniformly.

### Embodiment 30

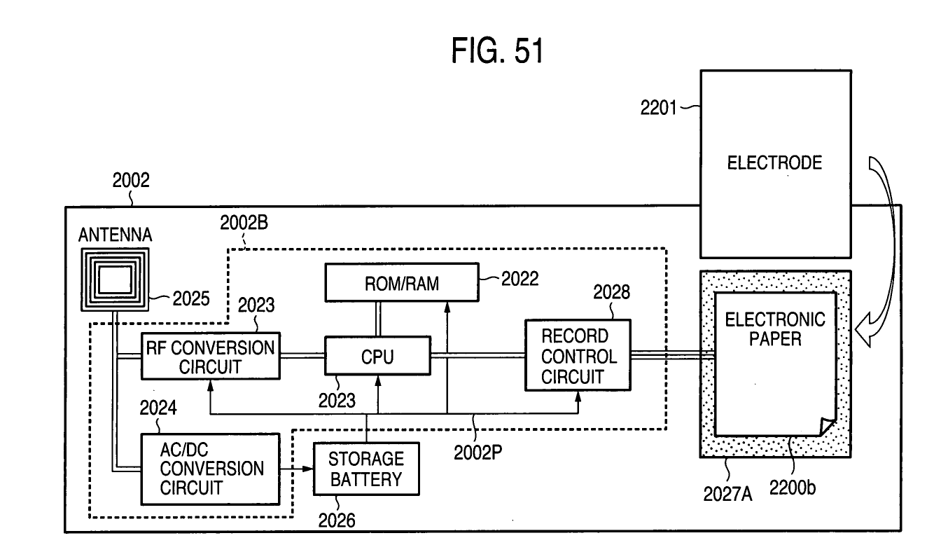

FIG. 51 is a block diagram of a display apparatus in an embodiment 30 of the invention. In FIG. 51, the same reference numerals and signs are used as to the same constituent elements as those in FIG. 44, to omit explanations. A display apparatus 2002 of FIG. 51 is such a thing that writing to an electronic paper is carried out by a surface, with it being sandwiched by two surfaces. In FIG. 50, it is configured in such a manner that a recording surface 2027A, which is connected to a recording control circuit 2028, has an electronic paper 2200b which is a recording section, and can be contacted closely to an electrode sheet 2201. Meanwhile, a 2002B portion, which is surrounded by a broken line, is a circuit other than a display section, and can be made as IC through the use of one chip.

Thus, it is utilized in such a state that the electronic paper 2200b is placed on the recording surface 2027A of the display apparatus 2002, and sandwiched by the optically transparent electrode sheets 2201, entire surfaces of which transparent electrodes were placed.

Here, the electronic paper 2200b is detachable from the display apparatus 2002, by controlling opening/closing of the electrode sheet 2201 to the recording surface 2027a, through the use of a mechanism which is not shown in the figure, and this control of attaching/detaching is managed by the information program 2003.

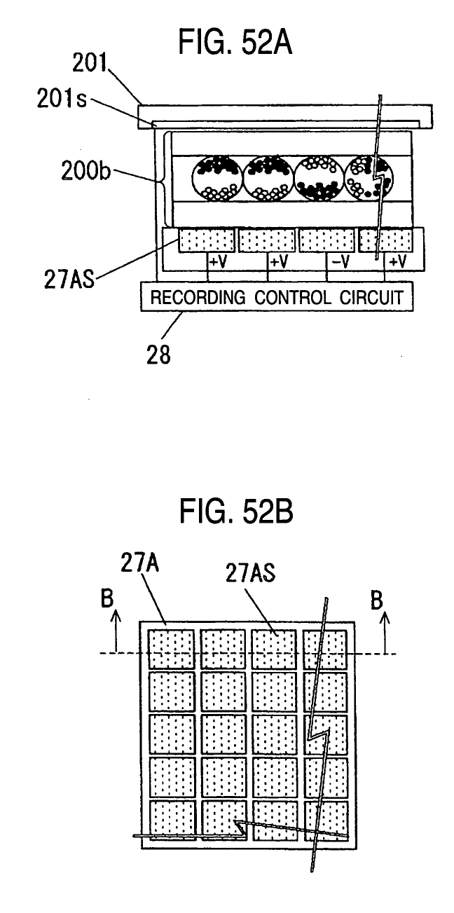

FIG. 52(a) is a cross sectional view of the electronic paper in the embodiment 30 of the invention, and (b) is a view which shows a cross section region of the electronic paper in the embodiment 30 of the invention, and FIG. 52(b) shows a cross section region B-B of FIG. 52(a).

On the recording surface 2027A, a plurality of pixel electrodes 2027AS are placed, and connected to a recording control circuit 2028 by wiring which is not shown in the figure. There is a transparent electrode 2201S, on a surface of the electrode sheet 2201, which is in contact with the electronic paper 2200b, and an electric field is generated by applying an arbitrary voltage between it and the above-described pixel electrode 2027AS, it is possible to carry out writing to the electronic paper 2200b.

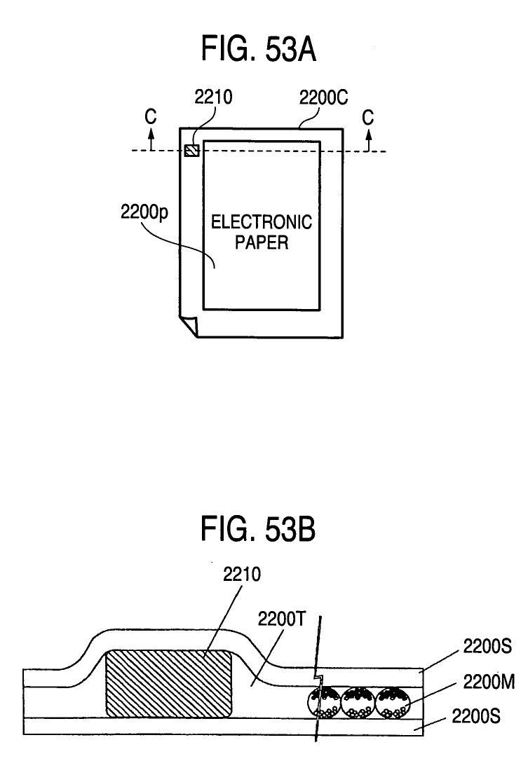

FIG. 53(a) is a block diagram of the electronic paper in the embodiment 30 of the invention, and (b) is a cross sectional view which explains a writing operation at the time of the electronic paper in the embodiment 30 of the invention, and FIG. 53(b) shows a cross section region C-C of FIG. 53(a). In the electronic paper 2200b, on an outside of a display area 200p including a micro capsule 2200M, a wireless tag 2210 is bonded by a non-conductive binder 2200T and sandwiched between it and the optically transparent sheet 2200S, in the same manner as the micro capsule 2200M.

The wireless tag apparatus 2210, which is known as RFID (Radio Frequency Identification), is configured by the same circuit block of CPU 2021, ROM/RAM 2022, a RF conversion circuit 2023, an AC/DC conversion circuit 2024, an antenna 2025, a storage battery 2026 as that shown in the display apparatus 2002, and a small-size one with a size of a sesame grain level is put to practical use.

This wireless tag 2210 can be configured so as to carry out wireless communication directly with the transfer apparatus 2001, or carry out wireless communication with the display apparatus 2002, or carry out wireless communication with a tag reader which is incorporated in the scanner 2006 and is not shown in the figure.

In the display apparatus 2002 of the electronic paper system of the suchlike configuration, it is possible to take a look at and carry on information in such a state that it is sandwiched by transparent electrode sheets 2201, and therefore, it is possible to realize improvement of convenience in such a manner that it is possible to use it in such a state that the electronic paper is not curled up. Similarly to this, such a form that a material is sandwiched in a clear file (name of commodity) as a stationary to be carried on is generally utilized well, but in addition to this conventional convenience, it is possible to rewrite display on the electronic paper, and therefore, it is possible to reduce an amount of papers to be carried on. Further, it is possible to take out and take a look at the recorded electronic paper, and therefore, it is possible to mitigate feeling of fatigue of a user, as compared to a case of holding up the display apparatus and taking a look at it, since it is of lighter weight when a user holds up it.

In addition, even in such a specification that the electronic paper is detachable from the display apparatus 2002, information management of the detached electronic paper becomes possible without a attaching/detaching mechanism which is mounted on the display apparatus 2002 for the purpose of monitoring. Further, if it is read out by the scanner 2006, it is possible to read out tag information which is attached to the paper, simultaneously with image data, and therefore, continuity of uniform management and copy limitation etc. of information is maintained.

For example, if the above-described image quality deterioration rate is set up, by applying image quality deterioration processing before image data, which is outputted from the scanner, is outputted to PC, it can be continued. Further, if it is in a copy inhibition state, it becomes possible to inhibit image reading and output such warning that there is copyright violation.

Meanwhile, in this embodiment, one wireless tag is mounted, but it is all right even if a plurality of wireless tags, and plural kinds of wireless tags which correspond to different wireless frequencies are mounted. Further, here, the wireless tag 2210, which is made by a semiconductor chip, is incorporated, but it is all right even if a circuit pattern by use of an organic semiconductor is formed as a pattern on the optically transparent sheet 2200S.

According to the suchlike configuration, it is possible to improve simultaneous detection ability of plural electronic papers, and an electronic paper with a uniform thickness becomes possible.

### Embodiment 31

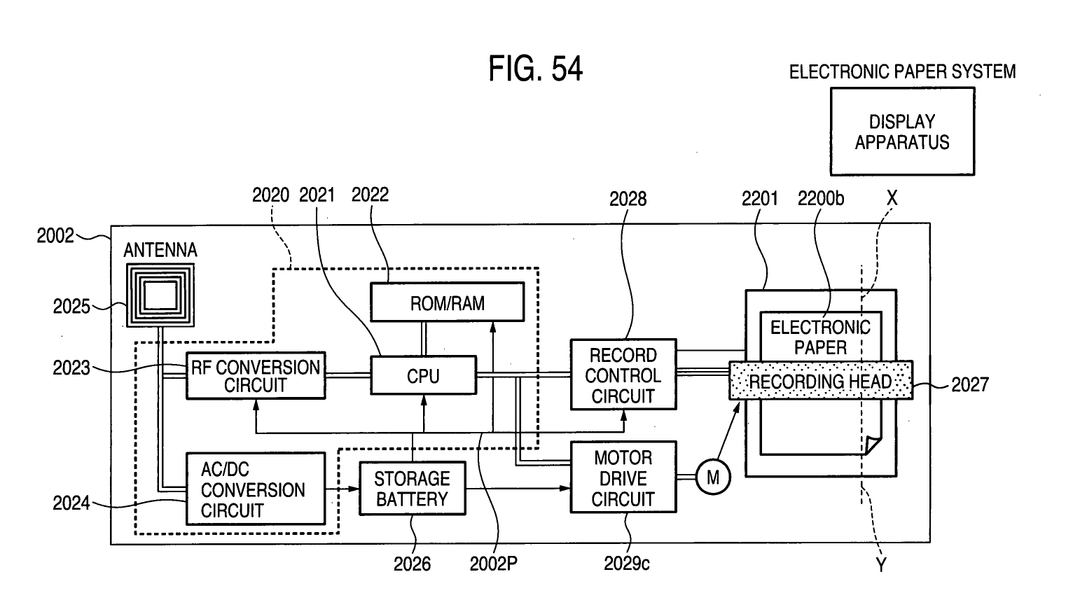

FIG. 54 is a block diagram of a display apparatus in an embodiment 31 of the invention. In FIG. 54, the same reference numerals and signs are used as to the same constituent elements as those of FIG. 44, to omit explanations. A display apparatus 2002 of FIG. 40 is a thing which is configured in such a manner that writing to an electronic paper 2200b can be realized by a line but not by a surface, and 2027 designates a line type recording head which has a plurality of pixel electrodes for applying an electric field to the electronic paper 2200b in such a state that it is in contact with the electronic paper 2200b and sandwiched by it and the common electrode (electrode sheet) 2201, and 2028 designates a recording control circuit for applying a voltage to pixel electrodes of the recording head 2027, and 2029 designates a drive motor for moving the recording head 2027 in an X-Y direction, to the electronic paper 2200b by use of a conveying mechanism which is not shown in the figure, and 2029C is a motor drive circuit for controlling an operation of the drive motor 2029.

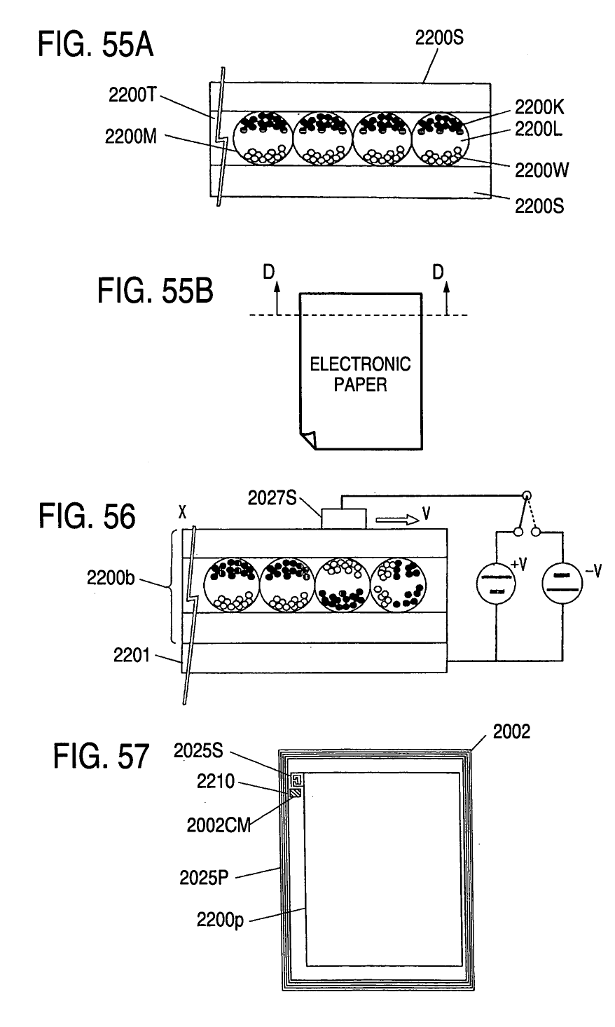

FIG. 55(a) is a cross sectional view of the electronic paper in the embodiment 31 of the invention, and (b) is a view which shows a cross section region of the electronic paper in the embodiment 31 of the invention, and FIG. 55(a) shows a cross section region D-D of FIG. 55(b), and it is of an extremely simple example configured by a micro capsule 2200M having an electronic ink function and a non-conductive binder 2200T for sandwiching this and for bonding to an optically transparent sheet 2200S in which there is optical transparency.

Meanwhile, both surfaces of the electronic paper were configured by the transparent sheets 2200S, but one side may be configured by a non-transparent sheet, and a sheet to which metal is deposited. In addition, it is also possible to utilize the electronic paper 2200b in which a wireless tag is incorporated, as an electronic paper.

FIG. 46 is a schematic view which shows a writing operation to the electronic paper in the embodiment 31 of the invention. By switching a voltage which is applied between one pixel electrode 2027S of the recording head 2027 in which pixel electrodes were disposed in a line shape, and the common electrode (electrode sheet) 2201 and its polarity through the use of the recording control circuit 2028, the electrified particles 2200K and 2200W in the micro capsule 2200M are electrophoresed, to write a display image on a lower side of the recording head 2027, in a line shape, and further, by moving the recording head 2027 in a Y direction, a next line is recorded, and thereby, it is possible to write on an entire surface of the electronic paper 2200b.

Meanwhile, the recording head 2027 is moved by a conveying mechanism, but it is also possible to fix a position of the recording head 2027, and to move the electronic paper 2200b by a conveying mechanism which is not shown in the figure.

In the display apparatus 2002 of the electronic paper system of the suchlike configuration, it is possible to simplify a writing section of an electronic paper and to manufacture it inexpensively.

### Embodiment 32

In the above-described embodiments shown in FIG. 51 and FIG. 54, the electronic paper 2200b, which is a display device of the display apparatus 2002, is of such a configuration that it is detachable from the display apparatus and only one piece is set therein, but it is also possible to configure in such a manner that a plurality of electronic papers can be detached individually. Further, it is also possible to configure in such a manner that a plurality of different size electronic papers can be detached individually. In addition, it is possible to realize such a configuration that an electronic paper is fixed to the display apparatus 2002 and is not detachable and to have information storage means incorporated in the display apparatus 2002.

By the display apparatus 2002 of the electronic paper system of the suchlike configuration, it is possible to display much more information at one time, and it is possible to take along only necessary information readily. Further, if storage means is incorporated, it is possible to receive and store display information together with management information, and to carry out writing and erasing of information and information management only by the display apparatus 2002, and therefore, it becomes possible to display much more information by itself.

### Embodiment 33

In the above-described display apparatus 2002 of FIG. 54, the recording head 2027 is moved to the electronic paper 2200b to carry out writing, but t is also possible to configure in such a manner that the recording head 2027 is fixed like a thermal printer, and the electronic paper 2200b is conveyed.

According to the suchlike configuration, it is possible to more miniaturize the display apparatus 2002 of the electronic paper system.

### Embodiment 34

Although it is not described in the above-described transfer apparatus 2001 shown in FIG. 43 and FIG. 50, it is possible to provide display function means such as a liquid crystal display on the transfer apparatuses 2001, 2001B.

According to the suchlike configuration, in the transfer apparatus of the electronic paper system, much more information provision and instructions become possible to warning and attention to users, and it is possible to improve convenience.

### Embodiment 35

In the above-described FIG. 43 and FIG. 50, the buzzer 2018 is disposed, but besides the buzzer 2018, it is also possible to mount means such as vibration and blinking by light which are acknowledged by users. Further, it is also possible to provide warning means by a warning sound through the use of the buzzer 2018 which PC 2004 has and display on a display screen. In addition, it is also possible to provide warning means on the occasion of writing to the electronic paper section 200a, the electronic paper 2200b from the display apparatus 2002.

According to the suchlike configuration, user acknowledgment as to warning etc. can be further improved.

### Embodiment 36

As to the recording section to the electronic paper of the display apparatus 2002 shown in FIG. 44, FIG. 51, and FIG. 54, it is possible to configure its circuit by use of an organic semiconductor. In particular, it is desirable to use an organic series field effect transistor as the switching device 2027BT shown in FIG. 45 (b).

For example, PEDOT (poly-ethylene dioxythiophene), which is conductive polymer, is drawn by means of an ink jet method, to form a source, a drain and a gate, and, on the source and the drain, a semiconductor layer of conjugated type polymer, a film thickness of which is set to 30 nm or less, is formed by means of a spin coat method, and a high polymer insulating layer with film thickness 500 nm is formed thereon by means of a spin coat method, and a gate is formed thereon, and thereby, it is possible to realize TFT (thing film transistor) with a top gate structure.

According to the suchlike configuration, it becomes possible to make the display apparatus 2002 or electric paper section thinner to save weight.

### Embodiment 37

It is possible to configure an antenna, which is mounted on the above-described transfer apparatus 2001, display apparatus 2002 and scanner 2006, by an organic material.

For example, the antenna is configured by a metal plate, a magnetic material and a conductor pattern. In order to prevent radiation of a unnecessary electromagnetic field from a surface which is opposite to a table in the transfer apparatus 2001, a metal sheet such as aluminum is used for one surface of an antenna section, and on it, a magnetic material, or a hybrid material made by mixing an inorganic material such as a magnetic material and a dielectric material and a high polymer organic material, is laminated by press etc., and further on it, an antenna pattern is formed by an organic material with an extremely low resistance value and high conductivity is formed by an ink jet method, to manufacture a sheet-shaped antenna. In this sheet-shaped antenna, an IC chip, in which a peripheral circuit is incorporated, is mounted thereon, so as to be in contact with an end portion of an antenna pattern, so that an apparatus is configured.

Meanwhile, in the antenna of the display apparatus 2002, the above-described metal plate for shield may be eliminated.

In case of carrying out electric power transmission between the transfer apparatus and the display apparatus in a non-contact manner, it is possible to utilize electromagnetic induction, but generally, in an antenna by use of a coil which is used in a PHS terminal and an electric razor, its electric power transmission efficiency is as lois approximately 20 through 30%, and coils, the number of turns of which is increased for the purpose of heightening a voltage to be taken out, are wound around a ferrite core, and therefore, an antenna itself is enlarged.

In this embodiment, by carrying out electric power transmission/reception through the use of high frequency of 100 kHz or more, use of an organic material becomes possible so that efficiency can be also improved.

Thus, according to the suchlike configuration, weight saving becomes possible, by making the transfer apparatus 2001 and the display apparatus 2002 smaller/thinner.

### Embodiment 38

The above-described antenna and wireless tag, which are mounted on the transfer apparatus 2001 and the display apparatus 2002, are configured by one type, but it is possible to configure it by a plurality of different antennas and wireless tags, in order to utilize different wireless systems.

FIG. 57 is a block diagram of an electronic paper in an embodiment 38 of the invention. In FIG. 57, 2002CM designates IC (Integrated Circuit) of the circuit block shown in FIG. 54, and 2025S designates an antenna for carrying out communication with the transfer apparatus 1, and 2025P designates an antenna for receiving electric power supply from the transfer apparatus 2001. The electric power antenna 2025P can be placed around a display section to enable its enlargement.

Here, these antennas can be configured in such a manner that a metal material or an organic material is formed on a sheet as a pattern and it is formed on the same layer as a display medium such as micro capsules etc. to be used in a display section, by deposition or painting.

Further, as to the storage battery 2016, it is possible to dispose a sheet-shaped capacitor on a lower surface of a sheet.

Meanwhile, in FIG. 57, the antenna is placed at a peripheral portion, but in particular, in case that the electronic paper section 2200a is of a system for thermally recording like a leuko paper, it is also possible to dispose an antenna on an entire rear surface.

According to the suchlike configuration, it becomes possible to improve electric power transmission efficiency of the transfer apparatus 2001 and the display apparatus 2002 and to make the apparatus thinner. In addition, it becomes possible to realize shortening of communication time.

### Embodiment 39

In the above-described display apparatus 2002, it is possible to have remaining quantity detection means of the storage battery 2016 incorporated. Further, it is possible to display status information, such as a result of the remaining quantity detection, a communication connection state with the transfer apparatus and electric power receiving sensitivity, on a part of a display section of an electronic paper, or on a dedicated display section which is disposed separately.

According to the suchlike configuration, it is possible to get hold of the number of pages for display rewriting and speed estimation, further a communication status with a transfer apparatus, in utilization of the display apparatus 2002, and it becomes possible to realize confirmation of a use position of a display apparatus 2002 and improvement of convenience at the time of taking along.

### Embodiment 40

It is possible to mount a function which is equivalent to the transfer apparatus, or a reader function of a wireless tag on the above-described scanner 2006, and further, it is possible to dispose such a function by which it is possible to process an image which is read out, and a function by which it is possible to connect to a network.

According to the suchlike configuration, it is possible to process image information directly, by taking over restriction such as copy limitation from a tag, even if it is tried to optically read and copy an image which is recorded on a paper to which a wireless tag is attached and a detachable electronic paper, by the scanner. Further, by sending the tag information which is read out, to the information program of PC, it becomes possible to realize cooperation with database information which is incorporated in PC, and it becomes possible to significantly expand a scope of copyright preservation and security management, and thereby, it is possible to establish a scheme which can correspond to various solutions.

### Embodiment 41

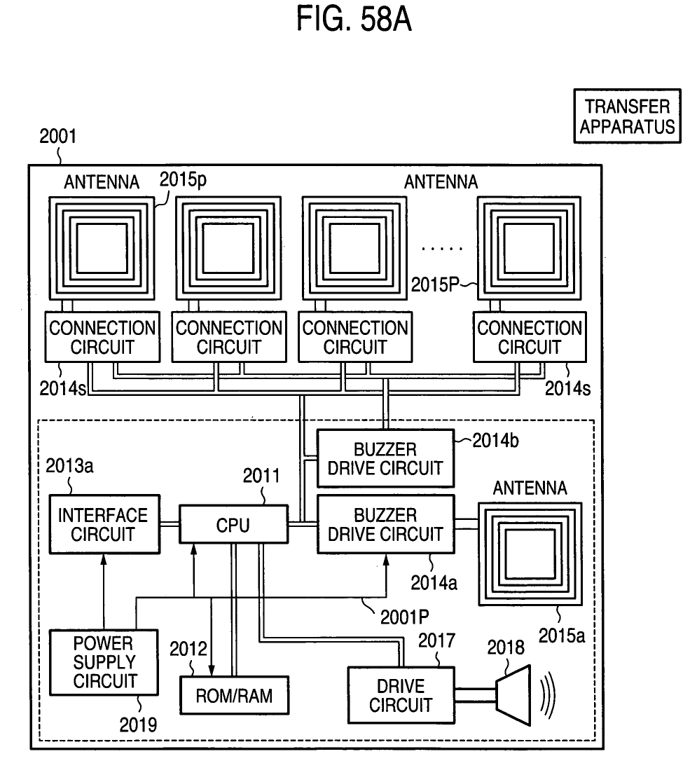

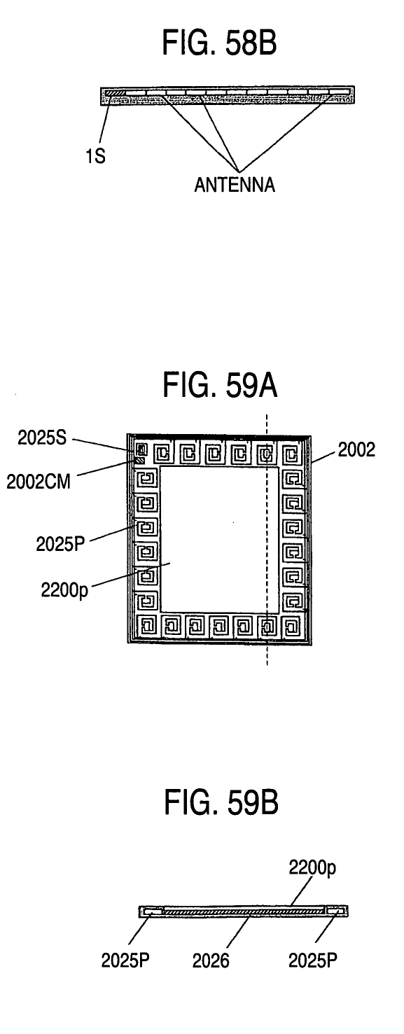

FIG. 58(a) is an internal block diagram of a transfer apparatus in an electronic paper system of an embodiment 41 of the invention, and (b) is a cross sectional view of the transfer apparatus in the electronic paper system of the embodiment 41 of the invention. In FIG. 58, the same reference numerals and signs are used as to the same constituent elements as those of FIG. 43, to omit explanations. A transfer apparatus 2001 of FIG. 58 is of such an example that a plurality of antennas 2015p for electric power supply and connection circuits 2014s and antenna drive circuits 2014b were further added to the antenna 2015a for wireless communication and its antenna drive circuit 2014a. An output of the antenna drive circuit 2014b is connected to the antenna 2015p for electric power supply by the connection circuit 2014s which is disposed with respect to each antenna. In addition, each connection circuit 2014s is also connected to CPU 2011, and its connection operation is controlled from CPU 2011. In addition, the transfer apparatus 2001 is equipped with a power supply circuit 2019, as a power supply function of this apparatus.

Here, it is desirable that, as to the antenna drive circuit 2014b, its drive circuit operation is controlled depending on the number of connections, in such a manner that predetermined energy is radiated from each antenna, even if the number of antennas 2015b, which were connected by the connection circuits 2014s, is changed.

The antenna 2015P is a thing which is configured in such a manner that it is possible to output an electric field, a magnetic field and electromagnetic waves, in a vertical direction to a plate shaped surface of the transfer apparatus 2001, such as a thing to which a line is wound around a ferrite core, and a thing in which reactance is formed by a pattern. In addition, a plurality of the antennas 2015p are placed so as to cover an entire surface of the transfer apparatus 2001.

Meanwhile, in order to prevent energy radiation to a back surface which becomes a back surface direction to a surface of the transfer apparatus, it is desirable to apply a magnetic material (e.g., ferrite) by which a loss is reduced, on a back surface side of the antenna, and further, a metal shield on an outside thereof.

FIG. 59(a) is a block diagram of a display apparatus in the embodiment 41 of the invention, and (b) is a cross sectional view of the display apparatus in the embodiment 41 of the invention. In FIGS. 59(a),(b), the same reference numerals and signs are used as to the same constituent elements as those of FIG. 57, to omit explanations. On the display apparatus 2002, a plurality of antennas 2025P for electric power reception are placed at a periphery of a display area. Each antenna 2025P is connected to a pattern in a parallel manner, and connected to an IC circuit section 2002CM which is made as a chip. Electric power, which is received by the antenna 2025P, is converted into an arbitrary constant voltage in the IC circuit section 202CM, and supplied to a storage battery 2026 which is placed on the back side of the display area 2200P.

By FIG. 58 and FIG. 59, an operation of a mode for carrying out wireless electric power supply between a display apparatus and a transfer apparatus will be described. A display apparatus 2002 is placed at an arbitrary position on a sheet-shaped transfer apparatus 2001, and in case that the transfer apparatus 2001 detected existence of the display apparatus 2002 by wireless communication, the transfer apparatus 2001 carries out a detection operation of a position of the display apparatus 2002 on the transfer apparatus 2001 periodically.

Here, the position detection operation will be hereinafter described. The connection circuit 2014s is controlled by CPU 2011, so as to have only one piece among a plurality of connection circuits 2014s which exist in the transfer apparatus 2001, connected to the antenna 2015p. Then, energy is radiated from the connected antenna 2015p. The display apparatus 2002, when this energy is received by the antenna 2025P, can detects that a predetermined electromotive force is received by the IC circuit section 2002CM.

Then, if there is the detected electromotive force, that electromotive force information is sent to the transfer apparatus 2001 by wireless communication. The connection apparatuses are sequentially controlled by the transfer apparatus 2001, and energy is outputted from the antenna one by one, and a communication response from the display apparatus 2002 is recorded therein.

The transfer apparatus 2001 can estimate and get hold of a position of the display apparatus 2002 on the transfer 2001 from the received electromotive force. Therefore, energy supply is realized by wireless, only from an antenna of the transfer apparatus 2001 which is located below the display apparatus 2002, except an underneath of the display area 2200p, and is linked to effective electric power supply.

Meanwhile, here, as to a size of an antenna, it is preferable that the antenna 2015p is smaller than the antenna 2025P.

The electronic paper system of the suchlike configuration, if the display apparatus 2002 is placed on the transfer apparatus 2001, can detect the display apparatus 2002 by communicating with the same in a non-contact manner, and suppress radiation of unnecessary electromagnetic waves, and carry out electric power supply by wireless. Thus, in this use form, it is easy to carry out sufficient electric power supply to the storage battery of the display apparatus 2002, and a user recognizes solid object identification information on the display side by the information program 2003, immediately when writing display is desired, and thereby, it is possible to carry out a huge variety of data processing on the basis of the solid object identification information, from preliminary set/registered information and processing procedures, and to control/manage display to a desired display apparatus which is located at a place where it is possible to communicate with the transfer apparatus, by sending image information and an operation instruction from the transfer apparatus.

Further, even in case that a foreign material such as metal, metal shield and magnetic material, which shield or absorb electromagnetic waves, is sandwiched between the display apparatus 2002 and the transfer apparatus 2002, an antenna, which could not obtain predetermined electromotive force information, is not connected in the transfer apparatus 2001 and is left as not in use, and thereby, it is possible to prevent occurrence of non-safety and energy loss, in wireless electric power supply.

### Embodiment 42

In the above-described transfer apparatus 2001, a number of antennas 2015p were disposed so as to cover a surface, and also in the display apparatus 2002, many antennas 2025P were disposed, but it is also possible to configure in such a manner that the antennas 2025P are disposed only four corners of the display apparatus 2002, and further, in the transfer apparatus 2001, a mark is disposed on a surface of the transfer apparatus 2001 so as to catch on a position of the antenna 2015p, and the number of respective antennas is thinned out.

At this time, on the occasion of use by a user, it is all right if it is placed, or held up in such a manner that one of the antennas 2015p of the transfer apparatus 2001 and one of the antennas 2025P of the display apparatus are matched respectively.

According to the suchlike configuration, an apparatus is simplified, and therefore, it can be made inexpensively.

### Embodiment 43

The above-described transfer apparatus 2001 may be of a small-sized shape like a mouse pad, but it is also possible to incorporate a larger one in a top surface of an office desk and a conference table.

According to the suchlike configuration, a user does not recognize the transfer apparatus so that it is possible to use it simply.

In the above-described electronic paper, its operation is described as to an electrophoresis method in which display is carried out by an electric field, but it is a matter of course that it is possible to use other method in which display can be controlled by an electric field, and display can be maintained with no electric power, such as liquid crystals, as a display medium of an electronic paper.

Further, even if a rewritable thermal paper line a leuco paper is used, and pixel electrodes of a recording surface are configured by heating elements, it is possible to accomplish the same function.

An electronic paper system, which relates to the invention, can display information on a display apparatus with high portability, and further, can manage an image input, images and information to be displayed, a display apparatus or an electronic paper. Thus, the invention is applicable as an electronic paper system which can carry out copying and distribution of information readily, and can realize reduction of a useless paper output, and security management of output information which is impossible by papers.

### Embodiment 44

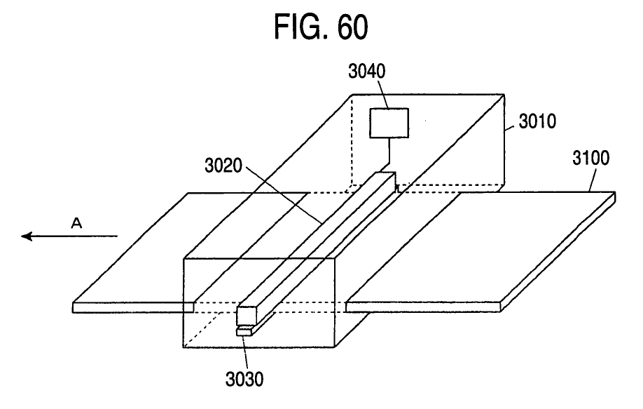

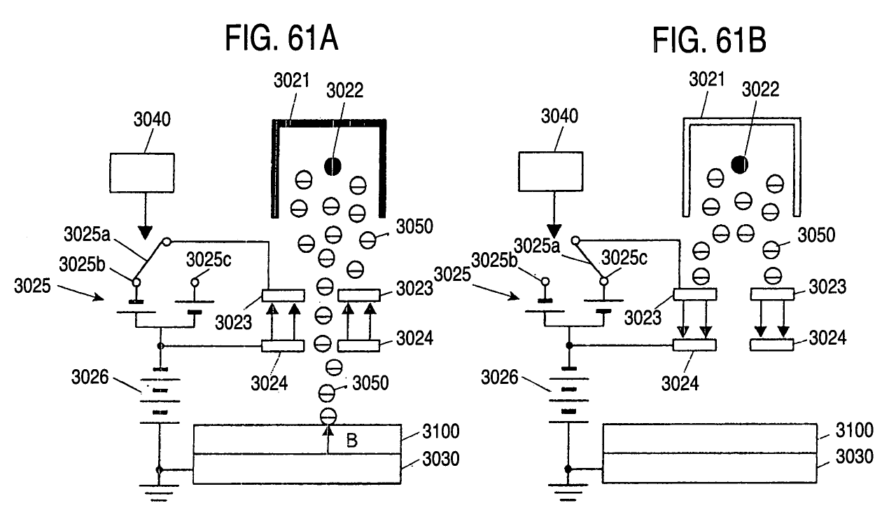

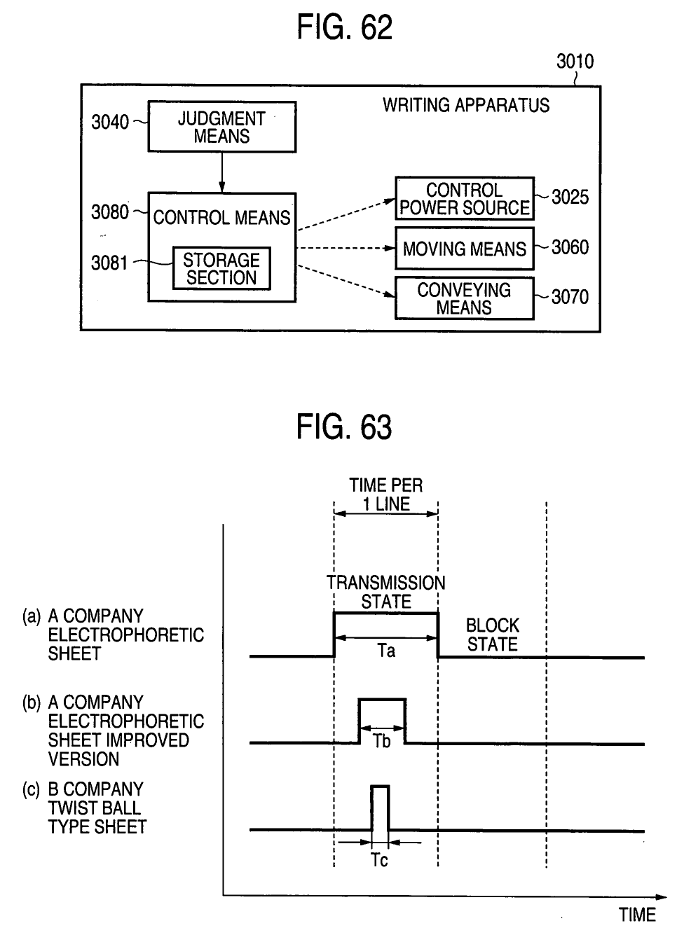

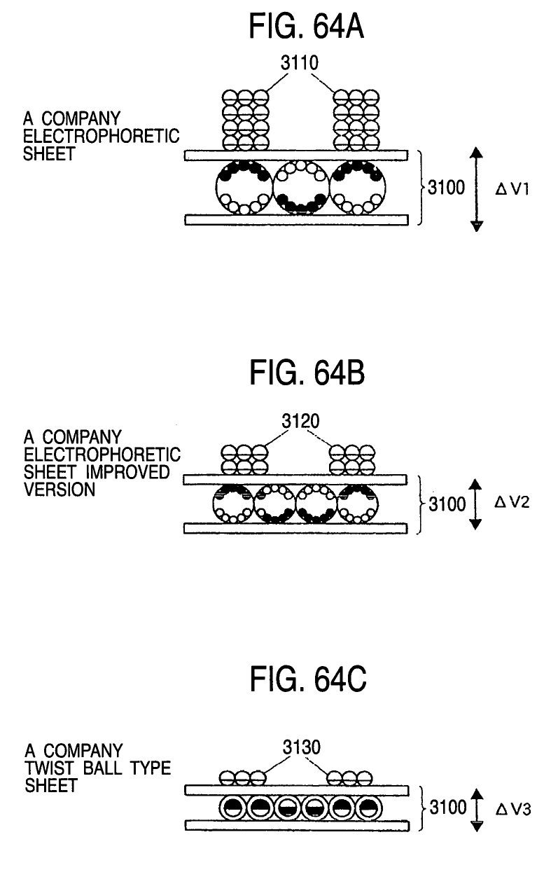

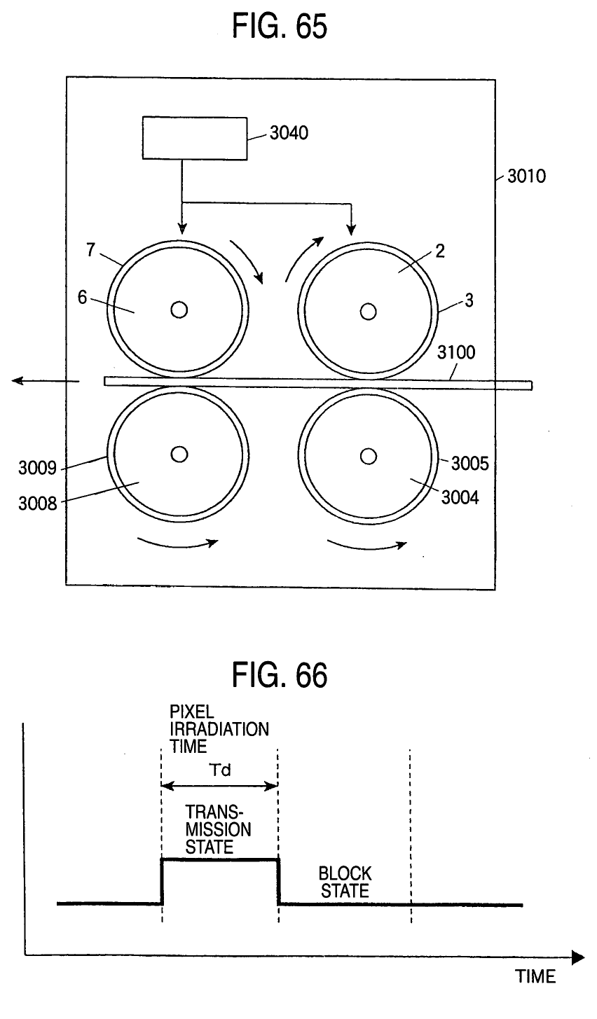

FIG. 60 is a perspective view which shows a configuration of a writing apparatus in an embodiment 44 of the invention, and FIG. 61 is a view which shows a line type head in the writing apparatus shown in FIG. 60, and FIG. 62 is a view which shows a control system of the writing apparatus shown in FIG. 60, and FIG. 63 is a view which explains ion irradiation time to time per one line to various sheet media in the embodiment 44, and FIG. 64 is a view which shows an appearance of an electrostatic image which is formed on the each sheet medium when ion is irradiated to the each sheet medium, during a period of the ion irradiation time shown in FIG. 63, and FIG. 65 is a view which shows an application example of the writing apparatus in the embodiment 44.

In FIG. 60, a writing apparatus (processing apparatus) 3010 is a thing which carries out writing and erasing of visible information to a sheet medium 3100, an optical characteristic of which is changed reversibly by an operation of an electric field, and is equipped with a line type head 3020 which selectively irradiates a surface of the sheet medium 3100 with a corona ion flow, a reference electrode 3030, and judgment means 3040 which judges a type of the sheet medium 3100.

The sheet medium 3100 is configured in such a manner that it is inserted into the writing apparatus 3010 at the time of writing or erasing, and it is passed through (carried) between the line type head 3020 and the reference electrode 3030.

The line type head (electric field generation means) 3020 generates a predetermined electric field for carrying out writing of visible information on the sheet medium 3100, and generates a predetermined electric field for carrying out erasing of visible information written on the sheet medium 3100. This predetermined electric field becomes a different value depending on a type of the sheet medium 3100, and becomes a value based on a result of judgment by the judgment means 3040.

The line type head 3020 is, as shown in FIG. 61(a), equipped with an ion source 3021 which generates corona ions, a corona wire 3022, control electrodes 3023, 3024 which control corona ions generated from the ion source 3021, a control power source 3025, and a bias power source 3026.

The ion source 3021 generates corona ions by applying a high voltage to the corona wire 3022.

The control electrode 3023 and the control electrode 3024 are disposed with leaving a predetermined interval between them, and it is configured in such a manner that corona ions 3050 can be transmitted through (passed through) a hole 3027 which is disposed at center of these control electrodes. In addition, in such a state that the control electrode 3023 and the control electrode 3024 are disposed with leaving a predetermined interval between them, they are disposed so as to be movable in an up/down (vertical) direction. A plurality of he suchlike control electrodes 3023, 3024 are disposed, for example, at predetermined intervals, so that the line type head 3020 is configured.

The control power source 3025 is configured in such a manner that, by changing over a switch 3025a to a contact 3025b, a minus (−) of a direct-current power source is set up to the control electrode 3023, whereas a plus (+) of the direct-current power source is set up to the control electrode 3025, and by changing over the switch 3025a to a contact 3025c, the plus (+) of the direct-current power source is set up to the control electrode 3023, whereas the minus (−) of the direct-current power source is set up to the control electrode 3024.

The bias power source 3026 is one which applies a bias voltage of a minus (−) to the control electrode 24. The reference electrode 3030 is grounded, and set up to an electric potential of 0 V.

Next, a control system of the writing apparatus will be described with reference to FIG. 46.

In FIG. 46, the control power source 3025 is configured in such a manner that it controls so as to change over the switch 3025a to the contact 3025b or the contact 3025c, as described above.

Moving means 3060 controls so as to move the control electrode 3023 and the control electrode 3024 in an up/down (vertical) direction, in such a state that they are disposed with leaving a predetermined interval between them. Conveying means 3070 is a thing which conveys the sheet medium 3100, which is inserted into the writing apparatus 3010, in a direction of an arrow A in FIG. 60, and is configured in such a manner that it is possible to change conveying speed to the sheet medium 3100.

Control means 3080 is equipped with a storage section 3081 which stores controls with respect to each type information of the sheet medium 3100, for example in a table form, and controls the control power source 3025, the moving means 3060 and the conveying means 3070.

In the meantime, in this embodiment 44, as to a type of the sheet medium 3100 which can be used for the writing apparatus 3010, there are types which depend on a difference of display methods, a difference of manufacturers, and a difference of versions. For example, in case that there exist the sheet medium 3100 with a fist display method relating to a first manufacturer, an improved version of the sheet medium 3100 with the first display method relating to the first manufacturer, the sheet medium 3100 with a second display method relating to the first manufacturer, the sheet medium 3100 with the first display method relating to a second manufacturer, and the sheet medium 3100 with a second display method relating to the second manufacturer, types of the sheet medium 3100 are to be 5 types.

In this case, as type information of the sheet medium 3100 which is stored in the storage section 3081, it is information which shows the first display method relating to the first manufacturer, information which shows the improved version of the first display method relating to the first manufacturer, information which shows the second display method relating to the first manufacturer, and information which shows the second display method relating to the second manufacturer.

On one hand, as control information which is stored in the storage section 3081, any one information is set up, among ion irradiation time information, writing speed information and erasing speed information, and distance information between the sheet medium 3100 and the control electrode, which will be described later. As a matter of course, it is also possible to set up these all information, and in this case, only information, which depends on a mode specified in advance, is to be applied.

In addition, a stored content of the storage section 3081 is, in case that the sheet medium 3100 of a new type is provided, updated on the basis of information relating to a type of that sheet medium 3100. In sum, type information and control information of that sheet medium 3100 are registered in the storage section in an associated manner. Registration of the suchlike information can be realized by operating a terminal device as a writing information source, which is connected to the writing apparatus 3010.

According to the control system of the writing apparatus 3010 as described above, the judgment means 3040 judges a type of the sheet medium 3100, and notifies a result of this judgment to the control means 3080. The control means 3080 controls any one of the control power source 3025, the moving means 3060, and the conveying means 3070, on the basis of a judgment result from the judgment means 3040 and a stored content of the storage section 3080.

Next, a basis writing operation of the writing apparatus 3010 will be described with reference to FIG. 45.

When the control power source 3025 changes over the switch 3025a to the contact 3025b, as shown in FIG. 45(a) and sets up so as to apply a minus (−) to the control electrode 3023 and a plus (+) to the control electrode 3024, an electric field direction between the control electrode 3023 and the control electrode 3024 becomes a direction from the control electrode 3024 to the control electrode 3023, and therefore, corona ions (in this case, negative corona ions) 3050 are transmitted through (passed through) the hole 3027.

Then, since a bias voltage of a minus (−) is applied to the control electrode 3024 by the bias power source 3026, corona ions 3050, which are transmitted through the hole 3027, are accelerated, and reach to a surface of the sheet medium 3100.

In contrast to this, when the control power source 3025 changes over the switch 3025a to the contact 3025c as shown in FIG. 61(b) and sets up so as to apply the plus (+) to the control electrode 3023 and the minus (−) to the control electrode 3024, an electric field direction between the control electrode 3023 and the control electrode 3024 becomes a direction from the control electrode 3023 to the control electrode 3024, and therefore, corona ions (in this case, negative corona ions) 3050 can not be transmitted through (passed through) the hole 3027.

On the basis of a principle as described above, an electrostatic image due to corona ions depending on information is formed on the sheet medium 3100, and therefore, an electric field in a direction shown by an arrow B in FIG. 61(a) is to act on this electrostatic image and the reference electrode 3030, and by this means, it is possible to write desired information on the sheet medium 3100. By conveying the sheet medium 3100 in a direction of the arrow A in FIG. 60 through the use of the conveying means 3070, it is possible to carry out writing of desired information as to one sheet medium.

In case of erasing information which is written on the sheet medium 3100 in this manner, an electric potential with polarity, which is opposite to that in case of a writing operation, is applied to the corona wire 3022 and the control power source 3025 changes over the switch 3025a to a predetermined contact, to realize such a state that corona ions (in this case, positive corona ions), which are generated from the corona wire 3022, can be passed through the hole 3027 which is disposed at center of the control electrode 3023 and the control electrode 3024.

By this means, since corona ions with polarity opposite to that at the time of writing (in this case positive corona ions) are attached to a surface of the sheet medium 3100, information is erased. By conveying the sheet medium 3100 in a direction of the arrow A in FIG. 60 through the use of the conveying means 3070, it is possible to carry out erasing of desired information, as to one sheet medium.

Next, writing and erasing operations of information to the sheet medium 3100 of a different type through the use of the writing apparatus will be described with reference to FIG. 63 and FIG. 64.

FIG. 63 shows ion irradiation time (which is comparable to time for having ions passed through between the control electrodes) to time per one line to each sheet medium 3100. Here, the time per one line is time which is decided on the basis of writing speed and writing resolution of the sheet medium 3100, and the ion irradiation time is comparable to time for having ions passed through.

Meanwhile, in FIG. 63, (a) shows ion irradiation time to an electrophoretic sheet using micro capsules which is made by A company (hereinafter, referred to as “electrophoretic sheet”.), and (b) shows ion irradiation time to an improved version of the electrophoretic sheet made by A company (hereinafter, referred to as “electrophoretic sheet (improved version).)”, and (c) shows ion irradiation time to a twist ball type sheet made by B company (hereinafter, referred to as “twist ball type sheet”.).

FIG. 64 shows an appearance of an electrostatic image which is formed on each sheet medium 3100 when ions are irradiated to the each sheet medium 3100 for only ion irradiation time shown in FIG. 63.

Meanwhile, in FIG. 64 (a) shows an electrostatic image which is formed on the electrophoretic sheet, and (b) shows an electrostatic image which is formed on the electrophoretic sheet (improved version), and (c) shows an electrostatic image which is formed on the twist ball type sheet.

Here, in this embodiment 44, it is assumed that, as the sheet medium 3100, there are the electrophoretic sheet (made by A company), the improved version of the electrophoretic sheet (made by A company), and the twist ball type sheet (made by B company).

In addition, it is assumed that, the storage section 3081 stores type information of the sheet medium 3100 and ion irradiation time information in an associated manner. That is, it is assumed that the storage section 3081 stores information showing an electrophoresis method made by A company and ion irradiation time information Time Ta in an associated manner, and in addition, stores information showing an improved version of the electrophoresis method made by A company and ion irradiation time information Tb in an associated manner, and further, stores information showing a twist ball type method made by B company and ion irradiation time information Tc in an associated manner.

Next, an operation of the writing apparatus 3010 in case of carrying out writing to an electrophoretic sheet as the sheet medium 3100 will be described.

In the writing apparatus 3010, the judgment means 3040 judges a type of the sheet medium 3100 which is inserted, on the basis of a writing instruction to the inserted sheet medium (electrophoretic sheet) 3100, and notifies this judged result to the control means 3080.

Meanwhile, with regard to judgment of a type of the sheet medium 3100, it is all right to use a setting from a terminal (not shown in the figure) which is an information source of writing information, and in addition, it is also all right to use a setting from a menu (not shown in the figure) by operating an operation panel (not shown in the figure) which is provided on the writing apparatus 3010, and further, it is also all right to use automatic judgment by use of various sensors.

The control means 3080 controls the control power source 3025, on the basis of a judgment result from the judgment means 3040 and a stored content of the storage section 3081.

That is, a notification content from the judgment means 3040 is such a judgment result that a type of the sheet medium 3100 is “information which shows the electrophoresis method made by A company”, and therefore, the control means 3080 searches and obtains from the storage section 3081, control information which corresponds to “information which shows the electrophoresis method made by A company” as type information of this sheet medium 3100. In this example, the ion irradiation time information TA, which corresponds to the “information which shows the electrophoresis method made by A company” as type information of the sheet medium 3100, is to be obtained.

The control means 3080 instructs the control power source 3025 in such a manner that ion irradiation time becomes “Ta” among time per one line, on the basis of “ion irradiation time information Ta” as control information which is obtained from the storage section 3081.

Then, the control power source 3025 changes over the switch 3025a to the contact 3025b (see, FIG. 61(a)), and at such a time point that the ion irradiation time Ta passed over from this changeover time point, changes over the switch 3025a to the contact 3025c (see, FIG. 45(b)), and thereby, sets up in such a manner that a transmission state of corona ions (see, FIG. 47(a)) is realized during only a period of the ion irradiation time Ta, among time per one line.

In consequence, as shown in FIG. 48(a), an electrostatic image 3110 is formed on a surface of an electrophretic sheet as the sheet medium 3100, and there occurs an electric potential difference of ΔV1, between an electric potential of the reference electrode 3030 and a surface electric potential of the sheet medium 3100. On this account, desired information is written in a position (region) which corresponds to the electrostatic image 3110 on the sheet medium 3100.

In addition, in case of carrying out writing to the above-described electrophoretic sheet (improved version) and the twist ball type sheet, in the same manner as in the case of the above-described electrophoretic sheet, the control means 3080 controls the control power source 3025, on the basis of a judgment result from the judgment means 3040 and a stored content of the storage section 3081.

That is, with regard to the electrophoretic sheet (improved version), the control power source 3025 sets up in such a manner that a transmission state of corona ions (see, FIG. 63(b)) is realized during only a period of the ion irradiation time Tb, among time per one line, on the basis of ion irradiation time information Tb which corresponds to “information which shows the improved version of the electrophoresis method made by A company” as type information of the sheet medium 3100, in accordance with control of the control means 3080.

In consequence, as shown in FIG. 64(b), an electrostatic image 3120 is formed on a surface of an electrophretic sheet as the sheet medium 3100, and there occurs an electric potential difference of ΔV2 between an electric potential of the reference electrode 3030 and a surface electric potential of the sheet medium 3100, and therefore, desired information is written in a position (region) which corresponds to the electrostatic image 3120 on the sheet medium 3100.

On one hand, with regard to the twist ball type sheet, the control power source 3025 sets up in such a manner that a transmission state of corona ions (see, FIG. 63(c)) is realized during only a period of the ion irradiation time Tc, among time per one line, on the basis of ion irradiation time information Tc which corresponds to “information which shows the twist ball type method made by B company” as type information of the sheet medium 3100, in accordance with control of the control means 3080.

In consequence, as shown in FIG. 64(c), an electrostatic image 3130 is formed on a surface of the twist ball type sheet as the sheet medium 3100, and there occurs an electric potential difference of ΔV3 between an electric potential of the reference electrode 3030 and a surface electric potential of the sheet medium 3100, and therefore, desired information is written in a position (region) which corresponds to the electrostatic image 3130 on the sheet medium 3100.

In case of erasing information which is written on respective sheet media 3100, an electric potential with polarity, which is opposite to that in case of a writing operation, is applied to the corona wire 3022, and the control power source 3025, which is controlled by the control means 3080 on the basis of a result of judgment by the judgment means 3040, sets up so as to realize such a state that corona ions (in this case, positive corona ions) can be transmitted through (passed through) during only a period of ion irradiation time which depends on a type of each sheet medium 3100.

By this means, since corona ions with polarity (in this case positive) opposite to that at the time of writing are attached to a surface of the sheet medium 3100, information, which is written on the sheet medium 3100, is erased. As a matter of course, in the suchlike operation of erasing information, by conveying the sheet medium 3100 in a direction of the arrow A in FIG. 60 through the use of the conveying means 3070, it is possible to erase all information as to one sheet medium.

Meanwhile, this embodiment 44 showed, as the line type head 3020 of the writing apparatus 3010, a non-contact method one which carries out writing and erasing in a state of non-contact with the sheet medium 3100, but the invention is not limited to this, and it is all right to carry out writing and erasing by a contact method as shown in FIG. 65.

The writing apparatus 3010 shown in FIG. 65 is of such a configuration that the judgment means 3040 is added, in the configuration of the conventional apparatus shown in FIG. 74. In FIG. 65, it is configured in such a manner that the sheet medium 3100 comes in contact with writing drums 3006, 3007 and erasing drums 3002, 3004, and is conveyed in a direction of the arrow A in FIG. 49.

In the suchlike writing apparatus 3010, the line type head 3020 controls application time for applying a voltage to each pixel electrode of the circuit substrate 3007 on the writing drum 3006 and each pixel electrode of the circuit substrate 3003 on the erasing drum 3002, on the basis of a result of judgment by the judgment means 3040. By this means, writing or erasing of desired information is carried out. In this regard, however, from the viewpoint of life of the sheet medium 3100, a non-contact method is more desirable than a contact method.

In addition, this embodiment 44 showed, as the line type head 3020 which carries out writing of information by a non-contact method, one with a method of uniformly generating corona ions and selecting ions by use of the control electrodes 3023, 3024, but the invention is not limited to this, and it is also all right to use a method of selectively generating ions by heating a metal electrode to which a high voltage is applied.

Further, this embodiment 44 showed, in case of erasing information written on the sheet medium 3100, one with a method of adding an electric potential with polarity opposite to that in case of a writing operation to the corona wire 3022 to realize such a state that corona ions can be passed through and of scanning, but the invention is not limited to this, and it is also all right to use a method in which a line type head for writing and a line type head for erasing are provided respectively and by use of these line type heads, erasing or writing is carried out as a series of operations. In this case, the line type head for erasing may use any method of a simple electrode or a device which generates corona ions.

Further, in this embodiment 44, as the sheet medium 3100, it is possible to use the sheet medium 3100 having memory ability of various electric field driving methods, such as an electrophoretic sheet using micro capsules, a sheet of a twist ball method which is reported by Zerox Corporation as Gyricon™, and a liquid crystal having memory ability.

In the meantime, a solution for reducing an environmental load by cutting down printing to papers is essential to human beings from now. On that account, by writing or erasing information on the sheet medium 3100, an optical characteristic of which is changed reversibly by an operation of an electric field through the use of the writing apparatus of the embodiment 44, it is possible to reutilize the sheet medium 3100, and therefore, from the viewpoint of reducing an environmental load, it can be said that the writing apparatus of the embodiment 3001 is an extremely useful apparatus which can reduce an environmental load.

As described above, according to the embodiment 44, it is configured to be equipped with the judgment means which judges a type of the sheet medium 3100, and therefore, even in case that the sheet medium 3100 with a different type is used, it is possible to secure optimum writing quality. On that account, if a user possesses a writing apparatus which relates to the invention, even in case that inexpensive and high quality sheet media 3100 were improved one after another, it becomes possible to apply a writing operation which is suitable for that sheet medium 3100, and therefore, it is possible to dramatically improve convenience of a user.

For example, since it is possible to secure optimum writing quality even if a different type sheet medium 3100 is used, it is possible to use, as the sheet medium, the sheet medium 3100 having memory ability of various electric field driving methods, such as an electrophoretic sheet using micro capsules, a sheet of a twist ball method which is reported by Zerox Corporation as Gyricon™, and a liquid crystal having memory ability, and therefore, it is possible to dramatically improve convenience of a user.

In addition, according to the embodiment 44, since writing and erasing are carried out in such a state that the line type head 3020 and various sheet media 3100 are not in contact with each other, there is also such an advantage that there is no damage to the sheet medium 3100 and it is possible to realize a longer operating life of the sheet medium 3100.

Further, according to the embodiment 44, by writing information on or erasing information from the sheet medium 3100 an optical characteristic of which is changed reversibly by an operation of an electric field, it is possible to reutilize the sheet medium 3100, and therefore, there is such an advantage that it is possible to provide an extremely useful writing apparatus which can reduce an environmental load.

Further, according to this embodiment 44, to provide a writing apparatus which can be compatible with various sheet media 3100 means that this writing apparatus (system) becomes a platform and it enables for a manufacturing company of the sheet media 100 to tackle the development of unique and improved sheet media 3100 one after another and by this means, price-reduction of the sheet media 3100 is advanced and promulgation of the writing apparatuses is accelerated. In consequence, it becomes possible to dramatically reduce an environmental load on a scale of Japan or on a scale of world.

In contrast to this, in an apparatus which is compatible with only a specific type sheet medium 3100 as in the above-described conventional apparatus, promulgation of that apparatus is not accelerated, and as a result, it is not possible to expect reduction of an environmental load.

### Embodiment 45

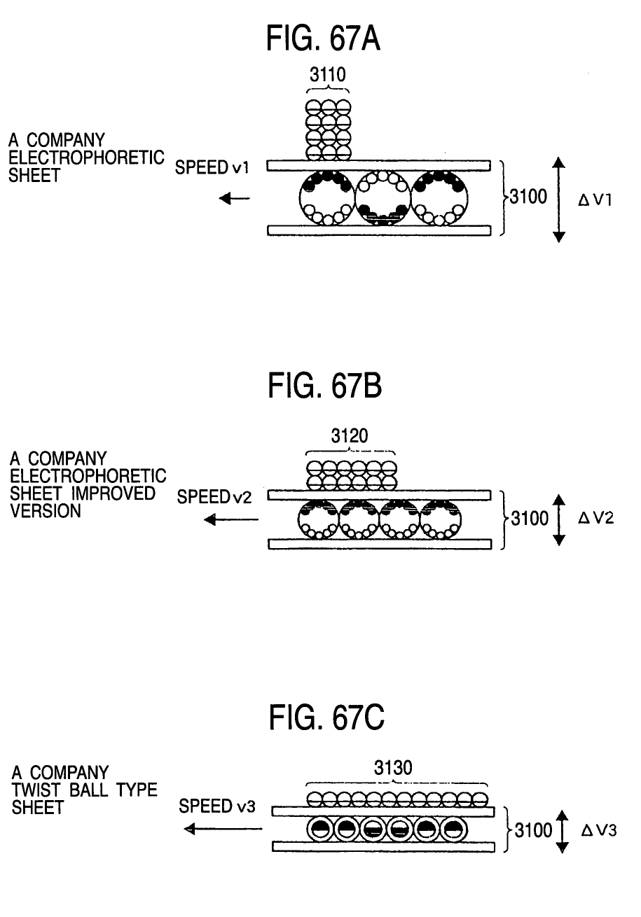

FIG. 66 is a view which explains pixel irradiation time in a writing apparatus in an embodiment 45 of the invention, and FIG. 67 is a view which shows an appearance of elestrostatic latent images which are formed on various sheet media in case that writing speed of writing to various sheet media in the embodiment 45.

The writing apparatus of this embodiment 45 is the same in its basic configuration and functions as those of the writing apparatus of the above-described embodiment 45 (see, FIG. 60 through FIG. 62), but is different in its condition of writing or erasing to the sheet medium 3100. Next, its different point will be described.

Also in this embodiment 45, as the sheet medium 3100, in the same manner as in the case of the embodiment 3001, it is assumed that 3003 types of the electrophoretic sheet, the electrophoretic sheet (improved version) and the twist ball type sheet are used.

In addition, it is assumed that the storage section 3081 stores type information of the sheet medium 3100 and speed information in an associated matter. That is, it is assumed that information showing the electrophoresis method made by A company and speed information V1 are stored in an associated manner, and in addition, information showing the improved version of the electrophoresis method made by A company and speed information V2 are stored in an associated manner, and further, information showing the twist ball type method made by B company and speed information V3 are stored in an associated manner. Here, the speed information is writing speed information and erasing speed information.

Next, an operation of the writing apparatus 3010 in case of carrying out writing to the electrophoretic sheet as the sheet medium will be described.

In the writing apparatus 3010, the judgment means 3040 judges a type of the sheet medium 3100 which is inserted, on the basis of a writing instruction to the inserted sheet medium (electrophoretic sheet) 3100, and notifies this judged result to the control means 3080.

The control means 3080 controls the conveying means 3070, on the basis of a judgment result from the judgment means 3040 and a stored content of the storage section 3081.

That is, a notification content from the judgment means 3040 is such a judgment result that a type of the sheet medium 3100 is “information which shows the electrophoresis method made by A company”, and therefore, the control means 3080 searches and obtains from the storage section 3081, control information which corresponds to “information which shows the electrophoresis method made by A company” as type information of this sheet medium 3100. In this example, as type information of the sheet medium 3100, the speed information V1, which corresponds to the “information which shows the electrophoresis method made by A company” as type information of the sheet medium 3100, is to be obtained.

The control means 3080 instructs the conveying means 3070 in such a manner that writing speed becomes “v1”, on the basis of the “speed information v1” as control information which is obtained from the storage section 3081.

Then, the conveying means 3070 conveys the sheet medium 3100 at speed v1 in a direction of the arrow A in FIG. 60 in accordance with control of the control means 3080, and at the same time, in the line type head 3020, it is set up in such a state that negative corona ions, which were generated, is transmitted through (passed through) the hole 3027 which is disposed in the control electrodes 3023, 3024 during only a period of pixel irradiation time Td shown in FIG. 66. In sum, the control power source 3025 sets up in such a manner that the switch 3025a is connected to the contact 3025b during only a period of the pixel irradiation time Td.

In consequence, as shown in FIG. 67(a), an electrostatic image 3110 is formed on a surface of an electrophretic sheet as the sheet medium 3100, and there occurs an electric potential difference of ΔV1, between an electric potential of the reference electrode 3030 and a surface electric potential of the sheet medium 3100. On this account, desired information is written in a position (region) which corresponds to the electrostatic image 3110 on the sheet medium 3100.

In addition, in case of carrying out writing to the above-described electrophoretic sheet (improved version) and the twist ball type sheet, in the same manner as in the case of the above-described electrophoretic sheet, the control means 3080 controls the conveying means 3070, on the basis of a judgment result from the judgment means 3040 and a stored content of the storage section 3081.

That is, with regard to the electrophoretic sheet (improved version), the conveying means 3070 conveys the electrophhoretic sheet (improved version) at writing speed (conveying speed) based upon the speed information v2 which corresponds to “information which shows the improved version of the electrophoresis method made by A company” as type information of the sheet medium 3100.

On one hand, with regard to the twist ball type sheet, the conveying means 3070 conveys the twist ball type sheet at writing speed (conveying speed) based on the speed information v3 which corresponds to the “information which shows the twist ball type method made by B company” as type information of the sheet medium 3100.

With regard to the sheet medium 3100 which is conveyed at writing speed which corresponds to a type of each sheet medium 3100 in this manner, the line type head 3020 is set up in such a manner that negative corona ions, which were generated, are transmitted through (passed through) the hole 3027 which is disposed in the control electrodes 3023, 3024.

In consequence, with regard to the electrophoretic sheet (improved version), as shown in FIG. 51(b), an electrostatic image 3120 is formed on a surface of the electrophretic sheet (improved version) as the sheet medium 3100, and there occurs an electric potential difference of ΔV2 between an electric potential of the reference electrode 3030 and a surface electric potential of the sheet medium 3100, and therefore, desired information is written in a position (region) which corresponds to the electrostatic image 3120 on the sheet medium 3100.

On one hand, with regard to the twist ball type sheet, as shown in FIG. 67(c), an electrostatic image 3130 is formed on a surface of the twist ball type sheet as the sheet medium 3100, and there occurs an electric potential difference of ΔV3 between an electric potential of the reference electrode 3030 and a surface electric potential of the sheet medium 3100, and therefore, desired information is written in a position (region) which corresponds to the electrostatic image 3130 on the sheet medium 3100.

As described above, even if pixel irradiation time is Td and constant, writing speed to respective sheet media 3100 differs, and therefore, the number of lines to be written on the sheet medium 3100 differs.

That is, in case of the electrophoretic sheet using micro capsules which is made by A company, information, which is comparable to 1 line (see, FIG. 67(a)), is written, and in case of the electrophoretic sheet improved version made by A company, information, which is comparable to 2 lines (see, FIG. 67(b), is written, and in case of the twist ball type sheet made by B company (see, FIG. 67(c)), information, which is comparable to 4 lines, is written, respectively.

Next, in case of erasing information which is written on the respective sheet media 3100, an electric potential with polarity, which is opposite to that in case of a writing operation, is applied to the corona wire 3022, and the conveying means 3070, which is controlled by the control means 3080 on the basis of a result of judgment by the judgment means 3040, conveys the sheet medium 3100 at specified erasing speed (any of v1, v2, v3).

In addition, the line type head 3020 is set up in such a state that corona ions (in this case, positive corona ions) can be transmitted through (passed through) during only a period of the pixel irradiation time Td. As a result, it becomes possible to erase all information as to one sheet.

As described above, according to the embodiment 45, it is possible to expect the same operation and advantages as those in case of the above-described embodiment 44.

In addition, according to the embodiment 45, in case that the sheet medium 3100 is improved so as to react with small electric field strength, as compared with such a case that the non-improved sheet medium 3100 is used, it is possible to increase writing speed, and therefore, it means that writing time per one sheet medium is shortened for a user, and convenience is improved much more.

### Embodiment 46

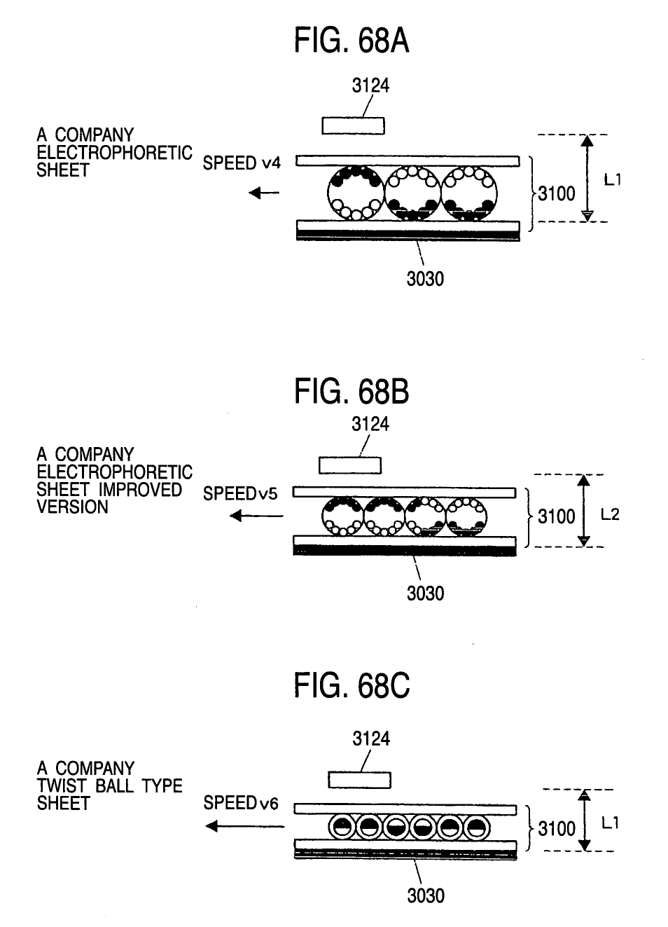

FIG. 68 is a view which shows an appearance of electrostatic images which are formed on various sheet media in case that a distance between a control electrode in a writing apparatus of an embodiment 46 of the invention and a sheet medium 3100 is changed.

The writing apparatus of this embodiment 46 is the same in its basic configuration and functions as those of the writing apparatus of the above-described embodiment 44 (see, FIG. 60 through FIG. 62), but is different in its condition of writing or erasing to the sheet medium 3100. Next, its different point will be described.

Also in this embodiment 46, as the sheet medium 3100, in the same manner as in the case of the embodiment 44, it is assumed that 3 types of the electrophoretic sheet, the electrophoretic sheet (improved version) and the twist ball type sheet are used.

In addition, it is assumed that the storage section 3081 stores type information of the sheet medium 3100 and speed information in an associated matter. That is, it is assumed that information showing the electrophoresis method made by A company and distance information L1 are stored in an associated manner, and in addition, information showing the improved version of the electrophoresis method made by A company and distance information L2 are stored in an associated manner, and further, information showing the twist ball type method made by B company and distance information L3 are stored in an associated manner.

Here, the distance information is information which shows a distance between 2 surfaces which are opposite to each other on the reference electrode 3030 and the control electrode 3024.

Next, an operation of the writing apparatus 3010 in case of carrying out writing to the electrophoretic sheet as the sheet medium will be described.

In the writing apparatus 3010, the judgment means 3040 judges a type of the sheet medium 3100 which is inserted, on the basis of a writing instruction to the inserted sheet medium (electrophoretic sheet) 3100, and notifies this judged result to the control means 3080.

The control means 3080 controls the moving means 3060, on the basis of a judgment result from the judgment means 3040 and a stored content of the storage section 3081.

That is, a notification content from the judgment means 3040 is such a judgment result that a type of the sheet medium 3100 is “information which shows the electrophoresis method made by A company”, and therefore, the control means 3080 searches and obtains from the storage section 3081, control information which corresponds to “information which shows the electrophoresis method made by A company” as type information of this sheet medium 3100. In this example, as type information of the sheet medium 3100, the distance information L1, which corresponds to the “information which shows the electrophoresis method made by A company” as type information of the sheet medium 3100, is to be obtained.

The control means 3080 instructs the moving means 3070 in such a manner that a distance between 2 surfaces which are opposite to each other on the reference electrode 3030 and the control electrode 3024 becomes “L1”, on the basis of the “distance information L1” as control information which is obtained from the storage section 3081.

Then, the moving means 3060 moves the control electrode 3023 and the control electrode 3024 in an up/down (vertical) direction, in such a manner that a distance between 2 surfaces which are opposite to each other on the reference electrode 3030 and the control electrode 3024 becomes “L1”, in accordance with control of the control means 3080.

At the same time as this, in the line type head 3020, it is set up in such a state (transmission state) that negative corona ions, which were generated, is transmitted through (passed through) the hole 3027 which is disposed in the control electrodes 3023, 3024 during only a period of the pixel irradiation time Td, in the same manner as the above-described case of the embodiment 45.

In consequence, in the same manner as the above-described case of the embodiment 44 or the embodiment 45, an electrostatic image is formed on a surface of an electrophretic sheet as the sheet medium 3100, and there occurs a predetermined electric potential difference, between an electric potential of the reference electrode 3030 and a surface electric potential of the sheet medium 3100. On this account, desired information is written in a position (region) which corresponds to the electrostatic image 3110 on the sheet medium 3100.

In addition, in case of carrying out writing to the above-described electrophoretic sheet (improved version) and the twist ball type sheet, in the same manner as in the above-described case of the electrophoretic sheet, the control means 3080 controls the moving means 3060, on the basis of a judgment result from the judgment means 3040 and a stored content of the storage section 3081.

That is, in case of the electrophoretic sheet (improved version), the moving means 3060 moves the control electrode 3023 and the control electrode 3024 in an up/down (vertical) direction, in such a manner that a distance between a surface of the reference electrode 3030 and a surface of the control electrode 3024 on the side of the reference electrode 3030 becomes “L2” (see, FIG. 52(b)), on the basis of the distance information L2 which corresponds to “information which shows the improved version of the electrophoresis method made by A company” as type information of the sheet medium 3100.

On one hand, in case of the twist ball type sheet, the moving means 3060 moves the control electrode 3023 and the control electrode 3024 in an up/down (vertical) direction, in such a manner that a distance between a surface of the reference electrode 3030 and a surface of the control electrode 3024 on the side of the reference electrode 3030 becomes “L2” (see, FIG. 52(c)), on the basis of the distance information L3 which corresponds to “information which shows the twist ball type method made by B company” as type information of the sheet medium 3100, in accordance with control of the control means 3080.

At the same time as the suchlike movement of the control electrodes 3023, 3024, the line type head 3020 sets up in such a state (transmission state) that negative corona ions, which were generated, are transmitted through (passed through) the hole 3027 which is disposed in the control electrodes 3023, 3024, during only a period of the pixel irradiation time Td, in the same manner as in the above-described case of the embodiment 45.

In consequence, in the same manner as the above-described case of the embodiment 44 or the embodiment 45, an electrostatic image is formed on a surface of the electrophretic sheet (improved version) or a surface of the twist ball type sheet as the sheet medium 3100, and there occurs an electric potential difference between an electric potential of the reference electrode 3030 and a surface electric potential of the sheet medium 3100. On this account, desired information is written in a position (region) which corresponds to the electrostatic image on the sheet medium 3100.

As described above, according to the embodiment 46, it is possible to expect the same operation and advantage as those in the above-described case of the embodiment 44.

In addition, according to the embodiment 46, in case that the sheet medium 3100 is improved thinner so as to react with small electric field strength, the sheet medium 3100 becomes light so that handling ability is improved and furthermore, since acceleration of corona ions by the bias power source 3026 is strengthened, a passing amount of ions, which pass through the hole 3027 disposed at center of the control electrodes 3023, 3024 (ion passing amount) increases, even in case of the same ion irradiation time, and on this account, in the same manner as speed v4, v5, v6 shown in FIG. 68, as compared to such a case that the non-improved sheet medium 3100 is used, it is possible to increase writing speed, and therefore, it means that writing time per one sheet medium is shortened for a user, and convenience is improved much more.

### Embodiment 47

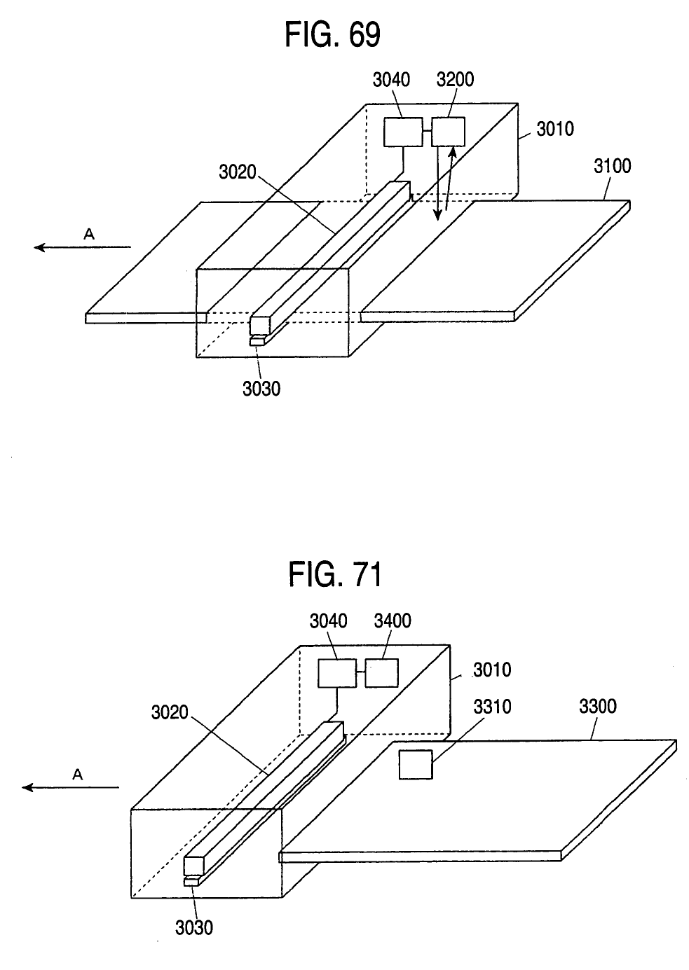

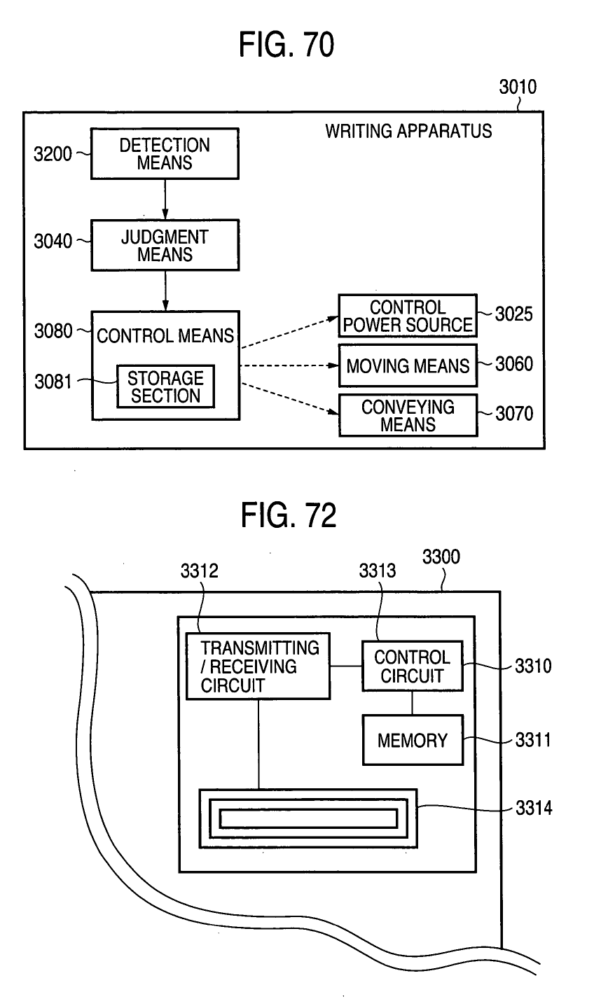

FIG. 69 is a perspective view which shows a configuration of a writing apparatus in an embodiment 47 of the invention, and FIG. 11 is a view which shows a control system of the writing apparatus shown in FIG. 69.

This writing apparatus 3010 of the embodiment 63 is of such a configuration that detection means 3200 is added in the configuration of the writing apparatus 3010 of the embodiment 44 shown in FIG. 60. Meanwhile, in FIG. 69, identical reference numerals and signs are given to portions which perform the same functions as those of constituent elements shown in FIG. 60.

The detection means detects an optical characteristic of the sheet medium 3100 which is inserted into the writing apparatus 3010, and notifies this detection result to the judgment means 3040. The detection means 3200 detects, for example, reflectivity of the sheet medium 3100. In case of detecting reflectivity, the detection means 3200 is composed of a sensor which has a light emission section and a light reception section.

In this embodiment 47, the storage section in the control means 3080 stores information showing reflectivity, type information of the sheet medium 3100, and control information in a corresponding manner. Therefore, if it is possible to know reflectivity of the sheet medium 3100, it is possible to know a type of the sheet medium 3100.

In the writing apparatus 3010 which is configured in this manner, when the sheet medium 3100 of a predetermined type is inserted into the writing apparatus 3010, the detection means 3200 detects (measures) reflectivity of this sheet medium 3100, and as shown in FIG. 54, sends out this detected result to the judgment means 3040.

The judgment means notifies the detection result from the detection means, to the control means 3080, as a judgment result after a type of the sheet medium 3100 is judged. The control means 3080 obtains at least control information which corresponds to information showing this reflectively, from the storage section 3081, on the basis of the judgment result (information which shows reflectivity) from the judgment means 3040, and on the basis of this obtained control information, controls of any of the control power source 3025, the moving means 3060, and the conveying means 3070.

Since operations after this are the same as those in the above-described cases of the embodiments 44 through 46, their explanations will be omitted here.

Meanwhile, in the embodiment 47, even in case that a characteristic of the sheet medium 3100 is changed by an external environment such as temperature and humidity, writing is applied to a predetermined partial region of the sheet medium 3100 and the detection means 3200 detects (measures) reflectivity as a result of that writing, and further, feedback is given on the basis of this detection result, and thereby, it is possible to generate an electrostatic image which generates an optimum electric field.

As described above, according to the embodiment 47, since it is configured to be equipped with the judgment means 3040 which judges a type of the sheet medium 3100 and the detection means 3200 which detects an optical characteristic of the sheet medium 3100, it is possible to automatically secure optimum writing quality even by use of a different type sheet medium 3100, and further, it is possible to secure writing quality in every environments, and therefore, convenience of a user is dramatically improved.

### Embodiment 48

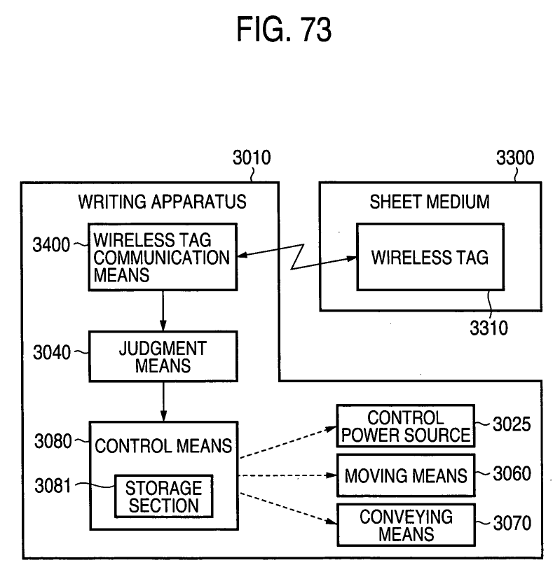

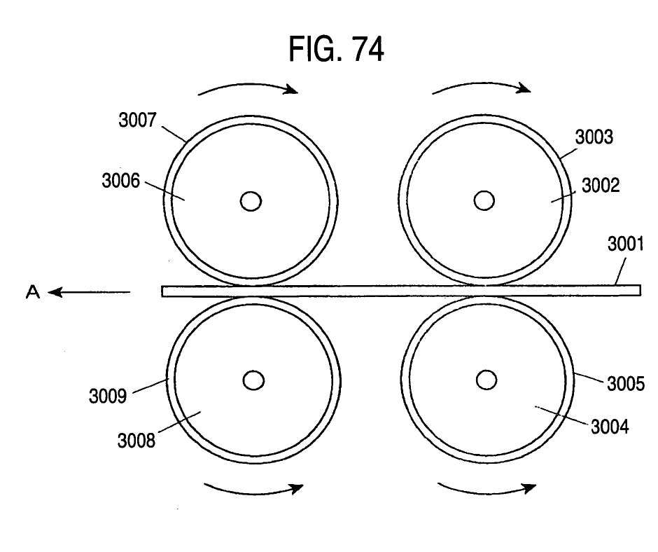

FIG. 71 is a perspective view which shows a configuration of a writing system in an embodiment 48 of the invention, and FIG. 72 is a view which shows a configuration of a sheet medium in the writing system shown in FIG. 71, and FIG. 73 is a view which shows a control system of the writing system shown in FIG. 71.

In FIG. 71, a writing system (processing system) is equipped with a writing apparatus (processing apparatus) 3010 and a sheet medium 3300. Meanwhile, in FIG. 71, identical reference numerals and signs are given to portions which perform the same functions as those of constituent elements shown in FIG. 60.

The writing apparatus 3010 shown in FIG. 71 is of such a configuration that wireless tag communication means 3400 is added, in the configuration of the writing apparatus 3010 of the embodiment 44 shown in FIG. 60.

The sheet medium 3300 is, as shown in FIG. 56, equipped with a wireless tag 3310, and this wireless tag (first communication means) 3310 is equipped with a memory 3311 which stores information which is specific to a sheet medium, a transmitting/receiving circuit 3312 which carries out transmission/reception of signals, a control circuit 3313 which accesses to the memory 3311, and an antenna section 3314 for transmitting signals to and receiving signals from wireless tag communication means (second communication means) 3400 which is disposed in the writing apparatus 3010.

Next, an operation of the writing system which is configured in this manner will be described with reference to FIG. 72 and FIG. 73.

Here, it is assumed that sheet medium specific information, which is stored in the memory 3311, is, for example, type information of a sheet medium which is stored in the storage section 3081 in the control means 3080 shown in FIG. 62.

Now, when the predetermined type sheet medium 3300 is inserted into the writing apparatus 3010, the wireless tag communication means, which is disposed in the writing apparatus 3010, transmits electromagnetic waves with predetermined frequency.

The electromagnetic waves from this wireless tag communication means 3400 are received by the antenna section 3314 of the wireless tag 3310 which is disposed on the sheet medium 3300.

In the wireless tag 3310, when the transmitting/receiving circuit 3312 receives electromagnetic waves from the wireless tag communication means 3400 through the antenna section 3314 as shown in FIG. 56, it notifies to the control circuit 3313 that the sheet medium is inserted.

Then, the control circuit 3313 reads out sheet medium specific information which is stored in the memory 3311, and requests the transmitting/receiving circuit 3312 to transmit this readout information toward the writing apparatus 3010.

The sheet medium specific information, which is read out by the control circuit 3134 in this manner, is transmitted to the wireless tag communication means 3400 of the writing apparatus 3010, through the transmitting/receiving circuit 3312 and the antenna section 3314.

In the writing apparatus 3010, the wireless tag communication means 3400 sends out the sheet medium specific information from the wireless tag 3310 of the sheet medium 3300, to the judgment means 3040. This judgment means 3040 notifies the received sheet medium specific information to the control means 3080 as a result of judging a type of a sheet medium.

The control means 3080 controls, as shown in FIG. 63, any of the control power source 3025, the moving means 3060, and the conveying means 3070, on the basis of a judgment result from the judgment means 3040, i.e., the sheet medium specific information, and a stored content of the storage section 3081.

Since operations after this are the same as those in the above-described cases of the embodiments 44 through 46, their explanations will be omitted here.

Meanwhile, sheet medium specific information may be used as control information which is stored in the storage section 3081 in the control means 3080 shown in FIG. 62. In this case, there is no need for the control means 3080 to be equipped with the storage section 3081, and it is all right if any of the control power source 3025, the moving means 3060, and the conveying means 3070 is controlled on the basis of a judgment result from the judgment means 3040, i.e., control information.

At this time, in case that two or more information among ion irradiation time information, speed information and distance information are included as control information, it is configured so as to adopt control information which corresponds to a mode specified in advance.

As described above, in the writing apparatus 3010, since the judgment means 3040 can obtain sheet medium specific information, which is stored in the memory 3311 of the wireless tag 3310 which corresponds to various sheet media, through the wireless tag communication means 3400, it becomes possible for the line type head 3020 to generate an optimum electrostatic image on the basis of this sheet medium specific information, and thus, it is possible to secure writing quality.

Meanwhile, in the embodiment 48, it is desirable that the wireless tag 3310 is operated on the basis of an induced voltage which is generated at the antenna section 3314, in an electromagnetic field (alternating-current magnetic field) with predetermined frequency which is radiated from the wireless tag communication means 3400.

As this reason, it is that, since a power source such as a battery for use in the wireless tag 3310 is not necessary, restriction of life of the wireless tag 3310 is substantially eliminated so that it is possible to realize reduction in size and weight of the wireless tag 3310 itself, and further, a battery replacing work becomes unnecessary so that it is possible to realize maintenance-free. Further, since the wireless tag itself is provided at a low price, it is possible to realize a sheet medium at a much lower price, since a power source such as a battery is not necessary.

As described above, according to the embodiment 48, the wireless tag communication means 3400, which is disposed in the writing apparatus 3010, obtains sheet medium specific information by wireless communication with the wireless tag 3310 as tag information which is given to the sheet medium 3300, and in the writing apparatus 3010, since it is configured in such a manner that writing or erasing is carried out on the basis of that obtained sheet medium specific information, it is possible to automatically secure optimum writing quality even by use of a different type sheet medium, and it is possible to dramatically improve convenience of a user.

The invention is a processing apparatus and a processing system which realizes writing or erasing to a sheet medium which can be utilized repeatedly, unlike printing to papers, and further, it is a processing apparatus and a processing system which do not produce consumable supplies and materials, and therefore, it is useful as an image forming apparatus such as a printer, which can contribute to reduction of an environmental load.

Each of embodiments can be combined to each other at the same time.

1. An electronic paper display system comprising:
a display apparatus, having;
an electronic paper unit for holding a display state in a power-free state and displaying an image information by an application of magnetism or an electric field,
a display-side communication unit for wirelessly transmitting and receiving information with a transfer apparatus, and
a recording unit for generating an image based on received information and recording the image to the electronic paper unit; and
a transfer apparatus, having;
a transfer-side communication unit for wirelessly transmitting and receiving information with the display apparatus; and
an interface circuit for connection to an information processing apparatus;
wherein an image information produced at the information processing apparatus is transmitted in non-contact to the display apparatus through the transfer apparatus.

2. The electronic paper display system according to claim 1, wherein the transfer apparatus and the information processing apparatus are configured in one body.

3. The electronic paper display system according to claim 1, wherein the information processing apparatus has an information processing program for producing and managing information to be outputted to the display apparatus;
the display apparatus has a discrete ID; and
the information processing apparatus executes the information processing program so as to recognize ID information about the display device from the transfer apparatus and produce and manage image information according to the ID recognized.

4. The electronic paper display system according to claim 3, wherein a wireless tag is used for mounting the discrete ID on the display apparatus.

5. The electronic paper display system according to claim 4, wherein the wireless tag is provided on at least one of the electronic paper unit and a display unit main body.

6. The electronic paper display system according to claim 1, wherein the transfer apparatus has a power feed function to feed power by an electromagnetic wave;
the display apparatus has a storage battery for generating power from an electromagnetic wave received from the transfer apparatus and storing the power.

7. The electronic paper display system according to claim 6, wherein the display apparatus has a detection unit for detecting a remaining capacity of the storage battery, to display a result of the detection.

8. The electronic paper display system according to claim 1, wherein the electronic paper unit is removable from the display apparatus.

9. The electronic paper display system according to claim 8, wherein the attachment/detachment mechanism for the electronic paper unit and the display apparatus is controlled according to the information processing program of the information processing apparatus.

10. The electronic paper display system according to claim 1, wherein the electronic paper unit has a display device in a structure sandwiching a developer by a sheet free of an electrode;
the display apparatus having:
a surface arranging an electrode in an entire surface thereof for resting the electronic paper unit thereon;
a line-type application recording head for writing image information to the electronic paper unit; and
a drive mechanism for the line-type application recording head;
wherein an electric field is applied to between the electrode and the application recording head, so as to move the application recording head relative to the electronic paper unit or to move the electronic paper unit relative to the application recording head.

11. The electronic paper display system according to claim 1, wherein the electronic paper unit has a display device in a structure sandwiching a developer by a sheet free of an electrode;
the display apparatus has:
a lid, having a surface arranging an electrode in an entire surface thereof so as to sandwich the electronic paper unit;
a multiplicity of pixel electrodes arranged to write image information to the electronic paper unit, and a drive circuit for applying electric field to between the entire-surface electrode and the pixel electrodes.

12. The electronic paper display system according to claim 1, wherein the electronic paper unit has a display device in a structure sandwiching a developer by a sheet free of an electrode and a transparent sheet having an electrode only on one surface thereof, the display apparatus arranging a multiplicity of pixel electrodes for recording on an entire surface for resting the electronic paper unit thereon and having a drive circuit for driving the electrode.

13. The electronic paper display system according to claim 1, wherein the transfer apparatus has a discrete identification symbol and an interface-circuit for connection to a communication network, the information processing apparatus being to exclusively manage a plurality of transfer apparatuses.

14. The electronic paper display system according to claim 1, wherein at least one of the transfer apparatus and the display apparatus has an alert unit for giving an alert to a user.

15. The electronic paper display system according to claim 1, wherein the transfer apparatus has a display unit.

16. The electronic paper display system according to claim 3, further including a plurality of information processing apparatuses each having the information processing program, the information processing programs on the apparatuses being to associatively operate thereby producing and managing image information.

17. The electronic paper display system according to claim 1, wherein the recording unit has a circuit structured of an organic semiconductor.

18. The electronic paper display system according to claim 1, wherein an antenna used on a communication unit in the display apparatus and transfer apparatus is formed of an organic material.

19. An information processing system, comprising:
a display device including an electronic display device which keeps up a display content in a state of no power supply and which is operable to rewrite the display content; and
a processing device, which outputs display information to the display device;
wherein the display device and the processing device carry out transmission/reception of information by wireless communication;
the display device transmits specific identification information which is given to itself in advance, to the processing device;
the processing device determines display information and instruction information based on the specific identification information transmitted from the display device and processing procedures which are set up in advance, and transmits the determined display information and instruction information, to the display device; and
the display device carries out display control to the electronic display device based on the display information and instruction information from the processing device.

20. An information processing system, comprising:
a display device including an electronic display device which keeps up a display content in a state of no power supply and which is operable to rewrite the display content; and
a processing device, which outputs display information to the display device; and
a transfer device, which is connected to the display device through a wireless communication line and is connected to the processing device through a communication line;
wherein the display device transmits specific identification information which is given to itself in advance, to the processing device through the transfer device; and
the processing device determines display information and instruction information based on specific identification information from the display device and processing procedures which are set up in advance, and transmits the determined display information and instruction information, to the display device through the transfer device; and
the display device carries out display control to the electronic display device based on the display information and instruction information from the processing device.

21. A information processing system, comprising:
a plurality of display devices, each of which includes an electronic display device to which specific identification information is given in advance and which keeps up a display content in a state of no power supply and which is operable to rewrite the display content;
a processing device, which outputs display information to an appointed display device;
a processing device, which outputs display information to the display device; and
a transfer device, which is connected to the plurality of display devices through a wireless communication line and is connected to the processing device through a communication line and carries out an inquiry of specific identification information to the plurality of display devices periodically through the wireless communication line;
wherein an arbitrary display device, which responded the inquiry from the transfer device, transmits specific identification information which is given to itself in advance, to the processing device through the transfer device; and
the processing device determines display information and instruction information based on the specific identification information from the arbitrary display device and processing procedures which are set up in advance, and transmits this determined display information and instruction information, to the display device through the transfer device; and
the arbitrary display device carries out display control to the electronic display device based on the display information and instruction information from the processing device.

22. The information processing system according to claim 21, wherein in case such that the arbitrary display device received display information from the processing device, and instruction information including copy condition information which shows a condition relating to a copy through the transfer device, the arbitrary display device processes the display information based on image quality information which is included in the copy condition information, and displays the processed display information on the electronic display device.

23. The information processing system according to claim 21, wherein in case of having display information of a copy source, which is displayed on a display device at the copy source, displayed on a display device at a copy destination,
the display device at the copy source transmits display information of the copy source to the processing device through the transfer device; and
the processing device transmits display information of the copy source from the display device at the copy source, and instruction information including copy condition information which shows a condition relating to a copy, to the display device at the copy destination through the transfer device; and
the display device at the copy destination, in case that it received information from the processing device, processes display information of the copy source on the basis of image quality information which is included in the copy condition information, and displays the processed display information on the electronic display device.

24. The information processing system according to claim 21, wherein in case that the arbitrary display device received display information from the processing device, and instruction information including copy condition information which shows a condition relating to a copy, through the transfer device,
the arbitrary display device does not display on the electronic display device with regard to the received display information, when a value showing the number of copies, which is included in the copy condition information, gets up to a threshold value which is set up in advance.

25. The information processing system according to claim 21, wherein, in case of having display information of the copy source, which is displayed on a display device at the copy source, displayed on a display device at the copy destination,
the display device at the copy source transmits display information of the copy source to the processing device through the transfer device, and
the processing device transmits display information of the copy source from the display device at the copy source, and instruction information including copy condition information which shows a condition relating to a copy, to the display device at the copy destination through the transfer device, and
the display device at the copy destination, in case that it received information from the processing device, carries out addition or subtraction of a value which is set up in advance to a value showing the number of copies which is included in the copy condition information, and does not display on the electronic display device with regard to the received display information, when this calculated value of the number of copies gets up to a threshold value which is set up in advance.

26. The information processing system according to claim 19,
wherein the transfer device is equipped with a transmission circuit which transmits an electromagnetic wave; and
each of the plurality of display devices is equipped with:
a reception circuit which receives an electromagnetic wave from the transmission circuit;
a conversion circuit which converts the electromagnetic wave received by the reception circuit into electric power; and
a storage unit which stores the electric power converted by the conversion circuit; and
the plurality of display devices operate on the basis of the electric power stored in the storage unit.

27. The information processing system according to claims 19, wherein
the display device is equipped with an electronic display device which is detachable and in which a wireless tag is disposed and which keeps up a display content in a state of no power supply and can update the display content, and
a device main body having a control circuit which carries out output control to the loaded electronic display device.

28. The information processing system according to claim 27, being equipped with an image reading device which reads out a predetermined image;
wherein the image reading device is equipped with a wireless tag communication circuit which carries out communication with a wireless tag, and
the circuit communicates with a wireless tag which is disposed in the electronic display device and thereby, it obtains the tag information, and applies image processing to image data which is read out, on the basis of the obtained tag information.

29. The information processing system according to claim 27, wherein the processing device controls a attaching/detaching mechanism for the device main body to which the electronic display device is attached and detached, by carrying out a processing procedure which is set up in advance.

30. The information processing system according to claim 27, wherein a wireless tag, which possesses specific identification information to the electronic display device as tag information, is disposed on the electronic display device, or a wireless tag, which possesses specific identification information to the electronic display device and the device main body respectively as tag information, is disposed on the electronic display device and the device main body.

31. The information processing system according to claim 21, wherein the transfer device is configured by a plurality of transfer devices to which specific identification information is given; and
the processing device manages uniformly the plurality of transfer devices on the basis of a plurality of specific identification information corresponding to the plurality of transfer devices.

32. The information processing system according to claim 21, wherein the transfer device or the display device is equipped with a warning unit which provides warning to a user.

33. The information processing system according to claim 21, wherein the processing device is configured by a plurality of processing devices which carries out information processing and management relating to display to the display device, by executing a program which corresponds to a processing procedure which is set up in advance, and each of the plurality of processing devices carries out the program, and thereby, the plurality of processing devices work together to carry out information processing and management relating to display to the display device.

34. The information processing system according to claim 28, wherein the image reading device is connected to the processing device through a communication line.

35. The information processing system according to claim 20, wherein the processing device and the transfer device are integrated.

36. The information processing system according to claim 28, wherein the processing device and the image reading device are integrated.

37. A electronic paper system, comprising:
a display device which is equipped with an electronic paper unit which keeps up a display state in a state of no power supply and displays an image by application of magnetism or an electric field;
a wireless circuit which receives an electromagnetic wave signal coming from an outside; and
a recording control circuit which generates an image based on reception information which is received by this wireless circuit and records the image on the electronic paper unit;
a transfer device which is connected to an information processing device and transfers information coming from the information processing device to the wireless circuit of the display device by use of a wireless signal such as magnetism and an electric field; and
an image reading device which is connected to the information processing device and reads out an image.

38. The electronic paper system according to claim 37, wherein individual identification information is disposed on the display device, and the information processing device has an information program for carrying out preparation and management of information which is outputted to the display device, and identification information of the display device is recognized by the information program through the transfer device, and preparation and management of information are carried out in accordance with the recognized identification information and a preliminary processing procedure.

39. The electronic paper system according to claim 37, wherein in the information processing device, a copy setup condition, which decides quality of an image to be copied (hereinafter, referred to as “image quality deterioration rate”), is set up, and on the occasion of transfer of a display image to the display device, image quality deterioration rate information is attached, and the display device processes display image data in accordance with the image quality deterioration rate information to have it displayed.

40. The electronic paper system according to claim 37, wherein in the information processing device, a copy setup condition, which decides copiable number, is set up, and on the occasion of transfer of a display image to the display device, display image data of the display device and the copy setup condition are attached, and the display device adds or subtracts the copy number of the copy setup condition, and when it becomes a predetermined value, the display image data is all cleared, so as not to have it displayed.

41. The electronic paper system according to claim 37, wherein the transfer device has an electric power supply function, to carry out electric power supply to the display device by use of an electromagnetic wave, and the display device generates electric power by the received electromagnetic wave and is equipped with a storage battery which stores this.

42. The electronic paper system according to claim 37, wherein the electronic paper unit is detachable from the display device.

43. The electronic paper system according to claim 42, wherein by communicating with a wireless circuit which is mounted on the electronic paper unit, on the occasion of reading out a display image of the electronic paper unit by the image reading device which is connected to the information processing device, the read image data is image-processed on the basis of description information of the wireless circuit.

44. The electronic paper system according to claim 42, wherein means for controlling an attaching/detaching mechanism of the electronic paper unit and the display device, from the information program, is disposed.

45. The electronic paper system according to claim 42, characterized to be incorporated into any one or both of the electronic paper unit on which the individual identification information is mounted by the wireless tag and from which the wireless tag is detachable, and the display device.

46. The electronic paper system according to claim 37, wherein the transfer device has the individual identification information, and an interface circuit for connecting to a network is incorporated therein.

47. The electronic paper system according to claim 37, wherein a warning circuit to a user is disposed in at least one of the transfer device and the display device.

48. The electronic paper system according to claim 37, wherein when the information program is installed in a plurality of individual information processing device, information program on each information processing device operates in a cooperated manner, to carry out information management and processing.

49. The electronic paper system according to claim 47, wherein a wireless tag of the display device or the electronic paper unit has a function for carrying out data reading and writing.

50. The electronic paper system according to claim 37, wherein the image reading device can be connected to a network.

51. The electronic paper system according to claim 1, wherein a plurality of different kind antennas are incorporated in the transfer device.

52. The electronic paper system according to claim 37, wherein a plurality of antennas are incorporated in the display device.

53. The electronic paper system according to claim 16, wherein, in the transfer device having the plurality of antennas, electric power supply is carried out by driving only a part of the antennas which can supply electric power to the display device.

54. The electronic paper system according to claim 37, wherein, in the transfer device having the antennas, a magnetic material and metal shield are applied to one side of the antenna, to restrict an output direction of an electromagnetic wave.

55. The electronic paper system according to claim 37, wherein an antenna, which is used for a device of the electronic paper system, is formed by an organic material.

56. The electronic paper system according to claim 37, wherein the transfer device of the electronic paper system is incorporated in a table.

57. A processing apparatus, having:
an electric field generation unit, which generates a predetermined electric field for carrying out writing of visible information on a sheet medium;
an optical characteristic of which changes reversibly by an operation of an electric field and being equipped with a processor which judges a type of the sheet medium;
wherein that the electric field generation unit generates the predetermined electric field which corresponds to the type of the sheet medium which is judged by the processor.

58. A processing apparatus having:
an electric field generation unit which generates a predetermined electric field for carrying out erasing of visible information written on a sheet medium an optical characteristic of which changes reversibly by an operation of an electric field; being equipped with a processor which judges a type of the sheet medium;
wherein the electric field generation unit generates the predetermined electric field which corresponds to the type of the sheet medium which is judged by the processor.

59. The processing apparatus according to claim 57, wherein the electric field generation unit generates an electric field which is dependent on an electrostatic image by controlling to irradiate corona ions.

60. The processing apparatus according to claim 59, wherein the electric field generation unit generates the predetermined electric field which corresponds to a type of a sheet medium based on a result of judgment by the processor, by controlling a distance with an irradiation reference position so as to irradiate the sheet medium with corona ions on the basis of a result of judgment by the processor.

61. The processing apparatus according to claim 57, wherein the electric field generation unit generates the predetermined electric field which corresponds to a type of a sheet medium based on a result of judgment by the processor, by controlling electric field application time to the sheet medium on the basis of a result of judgment by the processor.

62. The processing apparatus according to claim 57, wherein the electric field generation unit generates the predetermined electric field which corresponds to a type of a sheet medium based on a result of judgment by the processor, by controlling writing speed of visible information to the sheet medium on the basis of a result of judgment by the processor.

63. The processing apparatus according to claim 58, wherein the electric field generation unit generates the predetermined electric field which corresponds to a type of a sheet medium based on a result of judgment by the processor, by controlling erasing speed of visible information to the sheet medium on the basis of a result of judgment by the processor.

64. The processing apparatus according to claim 57, being equipped with a detection unit which detects an optical characteristic of the sheet medium, wherein the processor judges a type of the sheet medium on the basis of a result of detection by the detection unit.

65. A processing system characterized by being equipped with a sheet medium, an optical characteristic of which changes reversibly by an operation of an electric field, and the processing apparatus according to claim 57.

66. A processing system which is equipped with a sheet medium, an optical characteristic of which changes reversibly by an operation of an electric field, and the processing apparatus according to claim 57,
wherein the sheet medium stores specific information of its own sheet medium, and it is equipped with a first communication unit which carries out wireless communication of the specific information with an outside, and
the processing apparatus is equipped with a second communication unit which carries out wireless communication of the specific information with the first communication unit, and
the processor judges a type of the sheet medium, on the basis of specific information which is obtained by the second communication unit through wireless communication.
